(19) United States
(12) Patent Application Publication
(10) Pub. No.: US 2023/0324739 A1
(43) Pub. Date: Oct. 12, 2023

(54) COMPOSITION FOR COLOR CONVERSION FILM, COLOR CONVERSION FILM, METHOD FOR MANUFACTURING COLOR CONVERSION FILM, BACKLIGHT UNIT, AND LIQUID CRYSTAL DISPLAY DEVICE

(71) Applicant: FUJIFILM CORPORATION, Tokyo (JP)

(72) Inventor: Shinichi KANNA, Shizuoka (JP)

(21) Appl. No.: 18/334,405

(22) Filed: Jun. 14, 2023

Related U.S. Application Data
(63) Continuation of application No. PCT/JP2021/039168, filed on Oct. 22, 2021.

(30) Foreign Application Priority Data
Dec. 18, 2020 (JP) 2020-210833

(51) Int. Cl. G02F 1/13357; C09K 11/06

(52) U.S. Cl. CPC G02F 1/133617; C09K 11/06; C09K 2211/1018; C09K 2211/1007

(57) ABSTRACT

Provided are a composition for a color conversion film, containing an organic light-emitting material which emits, by an excitation light, light having a longer wavelength than the excitation light, and at least one of a thermocurable compound or a photocurable compound; a color conversion film; a method for manufacturing a color conversion film; a backlight unit including the color conversion film; and a liquid crystal display device including the backlight unit.

### CROSS-REFERENCE TO RELATED APPLICATIONS

This application is a continuation application of International Application No. PCT/JP2021/039168, filed Oct. 22, 2021, the disclosure of which is incorporated herein by reference in its entirety. Further, this application claims priority from Japanese Patent Application No. 2020-210833, filed Dec. 18, 2020, the disclosure of which is incorporated herein by reference in its entirety.

### BACKGROUND OF THE INVENTION

### 1. Field of the Invention

The present disclosure relates to a composition for a color conversion film, a color conversion film, a method for manufacturing a color conversion film, a backlight unit, and a liquid crystal display device.

### 2. DESCRIPTION OF THE RELATED ART

A flat panel display such as a liquid crystal display device (LCD) has low power consumption, and its use has been expanded year by year as a space-saving display device.

Since a color conversion film of a backlight unit included in the LCD contains a light-emitting material which emits green light and red light by blue light, white light in which the blue light, the green light, and the red light are mixed can be extracted from the color conversion film.

As the color conversion film, for example, a color conversion film including a support, a layer (A) that contains an organic light-emitting material which emits green light having a peak wavelength of 500 nm or more and less than 580 nm by blue light having a wavelength of 400 nm or more and less than 500 nm, and a layer (B) that contains an organic light-emitting material which emits red light having a peak wavelength of 580 nm or more and 750 nm or less by the blue light or the green light, in which SP values of binder resins contained in the layer (A) the layer (B) have a specific relationship, has been known (for example, see WO2018/221216A and the like).

### SUMMARY OF THE INVENTION

In recent years, it is required for the color conversion film to have excellent solvent resistance and light resistance, and there is a demand for development of a composition for a color conversion film, with which a color conversion film having excellent solvent resistance and light resistance can be manufactured.

The present disclosure has been made based on the above-described findings, and an object to be achieved is to provide a composition for a color conversion film, with which a color conversion film having excellent solvent resistance and light resistance can be manufactured, a color conversion film, a method for manufacturing a color conversion film, and a liquid crystal display device including the color conversion film and a backlight unit.

<1> A composition for a color conversion film, comprising:

an organic light-emitting material which emits, by an excitation light, light having a longer wavelength than the excitation light; and

at least one of a thermocurable compound or a photocurable compound.

<2> The composition for a color conversion film according to <1>,

in which a peak wavelength of the light emitted from the organic light-emitting material by the excitation light is 500 nm or more and less than 580 nm.

<3> The composition for a color conversion film according to <1>,

in which a peak wavelength of the light emitted from the organic light-emitting material by the excitation light is 580 nm or more and 750 nm or less.

<4> The composition for a color conversion film according to any one of <1> to <3>, further comprising:

a polymerization initiator.

<5> The composition for a color conversion film according to any one of <1> to <4>,

in which the organic light-emitting material is represented by General Formula (1),

in General Formula (1), X is C-R⁷ or N, and R¹ to R⁹ are each independently selected from a hydrogen atom, an alkyl group, a cycloalkyl group, a heterocyclic group, an alkenyl group, a cycloalkenyl group, an alkynyl group, a hydroxyl group, a thiol group, an alkoxy group, an alkylthio group, an arylether group, an arylthioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, or a phosphine oxide group, where adjacent groups of R¹ to R⁹ may form a fused ring

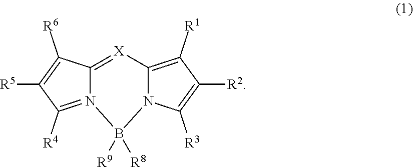

<6> A color conversion film comprising:

a support; and

a color conversion layer containing an organic light-emitting material which emits, by an excitation light, light having a longer wavelength than the excitation light, and at least one of a thermocured compound or a photocured compound.

<7> The color conversion film according to <6>,

in which a peak wavelength of the light emitted from the organic light-emitting material by the excitation light is 500 nm or more and less than 580 nm.

<8> The color conversion film according to <6>, in which a peak wavelength of the light emitted from the organic light-emitting material by the excitation light is 580 nm or more and 750 nm or less.

<9> The color conversion film according to <6>,

in which the color conversion layer includes a first color conversion layer and a second color conversion layer in this order from a side of the support,

a peak wavelength of light emitted from an organic light-emitting material contained in the first color conversion layer by an excitation light is 500 nm or more and less than 580 nm, and

a peak wavelength of light emitted from an organic light-emitting material contained in the second color conversion layer by an excitation light is 580 nm or more and 780 nm or less.

<10> The color conversion film according to <6>,

in which the color conversion layer includes a first color conversion layer and a second color conversion layer in this order from a side of the support,

a peak wavelength of light emitted from an organic light-emitting material contained in the first color conversion layer by an excitation light is 580 nm or more and 780 nm or less, and

a peak wavelength of light emitted from an organic light-emitting material contained in the second color conversion layer by an excitation light is 500 nm or more and less than 580 nm.

<11> A method for manufacturing a color conversion film, comprising:

forming a color conversion layer on a support by curing a composition for a color conversion film, that contains an organic light-emitting material which emits, by an excitation light, light having a longer wavelength than the excitation light, and at least one of a thermocurable compound or a photocurable compound.

<12> The method for manufacturing a color conversion film according to <11>,

in which the forming of the color conversion layer includes
forming a first color conversion layer on the support by curing a composition for a color conversion film, that contains an organic light-emitting material which emits light having a peak wavelength of 500 nm or more and less than 580 nm by an excitation light, and at least one of a thermocurable compound or a photocurable compound, and
forming a second color conversion layer on the first color conversion layer by curing a composition for a color conversion film, that contains an organic light-emitting material which emits light having a peak wavelength of 580 nm or more and 780 nm or less by an excitation light, and at least one of a thermocurable compound or a photocurable compound.

<13> The method for manufacturing a color conversion film according to <11>,

in which the forming of the color conversion layer includes
forming a first color conversion layer on the support by curing a composition for a color conversion film, that contains an organic light-emitting material which emits light having a peak wavelength of 580 nm or more and 780 nm or less by an excitation light, and at least one of a thermocurable compound or a photocurable compound, and
forming a second color conversion layer on the first color conversion layer by curing a composition for a color conversion film, that contains an organic light-emitting material which emits light having a peak wavelength of 500 nm or more and less than 580 nm by an excitation light, and at least one of a thermocurable compound or a photocurable compound.

<14> A backlight unit comprising:
a light source; and
the color conversion film according to any one of <6> to <10>.

<15> A liquid crystal display device comprising:
the backlight unit according to <14>; and
a liquid crystal cell unit.

According to the present disclosure, it is possible to provide a composition for a color conversion film, with which a color conversion film having excellent solvent resistance and light resistance can be manufactured, a color conversion film, a method for manufacturing a color conversion film, a backlight unit, and a liquid crystal display device.

### BRIEF DESCRIPTION OF THE DRAWINGS

FIG. 1 is a schematic cross-sectional diagram showing one embodiment of a color conversion film.

FIG. 2 is a schematic cross-sectional diagram showing another embodiment of the color conversion film.

FIG. 3 is a schematic configuration cross-sectional diagram showing an embodiment of a backlight unit according to the present disclosure.

FIG. 4 is a schematic configuration cross-sectional diagram showing an embodiment of a liquid crystal display device according to the present disclosure.

### DESCRIPTION OF THE PREFERRED EMBODIMENTS

Hereinafter, the contents of the present disclosure will be described in detail. The description of configuration requirements below is made based on representative embodiments of the present disclosure in some cases, but the present disclosure is not limited to such embodiments.

In the present disclosure, the numerical ranges shown using “to” include the numerical values described before and after “to” as the minimum value and the maximum value.

In a numerical range described in a stepwise manner in the present disclosure, an upper limit or a lower limit described in one numerical range may be replaced with an upper limit or a lower limit in another numerical range described in a stepwise manner. Further, in a numerical range described in the present disclosure, an upper limit or a lower limit described in the numerical range may be replaced with a value described in an example.

In the present disclosure, each component may contain a plurality of types of corresponding substances. In a case where a plurality of types of substances corresponding to each component are present in the composition, a content rate or a content of each component is the total content rate or the total content of the plurality of types of substances present in the composition, unless otherwise specified.

In the present disclosure, “(meth)acrylic” is a term used in a concept which includes both acrylic and methacrylic.

In the present disclosure, “(meth)acrylate” is a term used in a concept which includes both acrylate and methacrylate.

In the present disclosure, “(meth)acryloxy” is a term used in a concept which includes both acryloxy and methacryloxy.

In the present disclosure, a term “layer” includes not only a case where the layer is formed over the entire region but also a case where the layer is formed only in part of the region.

In the present disclosure, “light-emitting material” refers to a material which, when irradiated with light, emits light having a wavelength different from that of the light.

In the present disclosure, “thermocurable compound” means a compound which is polymerized and cured by heating, and “thermocured compound” means a cured product of the thermocurable compound.

In the present disclosure, “photocurable compound” means a compound which is polymerized and cured by light irradiation, and “photocured compound” means a cured product of the photocurable compound.

In the present disclosure, a peak wavelength of light emitted from the organic light-emitting material is measured as follows.

First, a peak wavelength of an organic light-emitting material contained in a composition for a color conversion film can be confirmed by adding the composition for a color conversion film to a solvent to form a solution and measuring emission spectrum of the solution.

As the solvent, toluene, dichloromethane, tetrahydrofuran, or the like can be used, and toluene is preferable.

A peak wavelength of light emitted from an organic light-emitting material contained in a color conversion layer included in a color conversion film is measured as follows. Here, a color conversion film including a support, a first color conversion layer, and a second color conversion layer in this order in which a peak wavelength of light emitted from an organic light-emitting material contained in the first color conversion layer by an excitation light is 500 nm or more and less than 580 nm, and a peak wavelength of light emitted from an organic light-emitting material contained in the second color conversion layer by an excitation light is 580 nm or more and 780 nm or less, will be described.

First, the color conversion film is disposed on a planar light-emitting device capable of emitting excitation light having a wavelength of 400 nm or more and less than 500 nm such that the support is on a light-emitting device side, and a prism sheet is placed on the color conversion film.

Since white light including blue light, green light, and red light is observed in a case where a current is passed through the planar light-emitting device and the above-described color conversion film is irradiated with the above-described excitation light, emission spectrum of the white light is obtained using a spectral emission brightness meter (for example, CS-1000 manufactured by Konica Minolta Inc.), and from the emission spectrum, light emission observed in a region with a peak wavelength of 500 nm or more and less than 580 nm and light emission observed in a region with a peak wavelength of 580 nm or more and 750 nm or less are confirmed.

In the present disclosure, a thickness of each layer can be controlled by adjusting a coating amount of a coating liquid and a concentration (% by mass) of solid contents of a liquid so as to obtain a desired thickness. In addition, the thickness can be determined from a cross-sectional image of the color conversion film, which is obtained by a scanning electron microscopy (SEM) or a transmission electron microscopy (TEM).

In the drawings, constituent components substantially the same are designated by the same reference numerals, and the description thereof will be omitted.

Hereinafter, the present disclosure will be described in detail.

(Composition for Color Conversion Film)

The composition for a color conversion film according to the embodiment of the present disclosure contains an organic light-emitting material which emits, by excitation light, light having a longer wavelength than the excitation light and at least one of a thermocurable compound or a photocurable compound.

With the above-described composition for a color conversion film, a color conversion film having excellent solvent resistance and light resistance can be manufactured.

The reason why the above-described effect is obtained is presumed as follows, but is not limited thereto.

The composition for a color conversion film according to the embodiment of the present disclosure contains at least one of a thermocurable compound or a photocurable compound. In a color conversion layer formed by curing the composition for a color conversion film on a support, it is presumed that the thermocurable compound and the photocurable compound form a crosslinking structure, and the color conversion layer has excellent solvent resistance and light resistance.

(Organic Light-Emitting Material)

Examples of the organic light-emitting material include a compound having a fused aryl ring and a derivative thereof. Examples of the fused aryl ring include naphthalene, anthracene, phenanthrene, pyrene, chrycene, naphthacene, triphenylene, perylene, fluorantene, fluorene, and indene.

In addition, examples of the organic light-emitting material include a compound having a heteroaryl ring, a derivative thereof, and a borane compound. Examples of the heteroaryl ring include furan, pyrrole, thiophene, silole, 9-silafluorene, 9,9′-spirobisilafluorene, benzothiophene, benzofuran, indole, dibenzothiophene, dibenzofuran, imidazopyridine, phenanthroline, pyridine, pyrazine, naphthyridine, quinoxaline, and pyrrolopyridine.

In addition, examples of the organic light-emitting material include a stillbene compound, an aromatic acetylene compound, a tetraphenylbutadiene compound, an aldazine compound, a pyrromethene compound, and a diketopyrrolo[3,4-c]pyrrole compound. Examples of the stillbene compound include 1,4-distyrylbenzene, 4,4′-bis(2-(4-diphenylaminophenyl)ethenyl)biphenyl, and 4,4′-bis(N-(stillben-4-yl)-N-phenylamino)stillbene.

In addition, examples of the organic light-emitting material include coumarin compounds such as coumarin 6, coumarin 7, and coumarin 153; azole compounds such as imidazole, thiazole, thiadiazole, carbazole, oxazole, oxadiazole, and triazole and metal complexes thereof; cyanine-based compounds such as indocyanine green; xanthene-based compounds such as fluorescein, eosin, and rhodamine; and thioxanthene-based compounds.

In addition, examples of the organic light-emitting material include polyphenylene-based compounds, naphthalimide compounds, phthalocyanine compounds and metal complexes thereof, porphyrin compounds and metal complexes thereof, oxazine-based compounds such as Nile red and Nile blue, helicene-based compounds, and aromatic amine compounds such as N,N′-diphenyl-N,N′-di(3-methylphenyl)-4,4′-diphenyl-1,1′-diamine.

In addition, examples of the organic light-emitting material include organic metal complex compounds of iridium (Ir), ruthenium (Ru), rhodium (Rh), palladium (Pd), platinum (Pt), osmium (Os), renium (Re), and the like.

However, in the present disclosure, the organic light-emitting material is not limited to those described above.

The organic light-emitting material may be a fluorescent light-emitting material or a phosphorus light-emitting material, but in order to achieve excellent color purity, a fluorescent light-emitting material is preferable.

Among the above, from the viewpoint of excellent thermal stability and photostability, a compound having a fused aryl ring or a derivative thereof is preferable.

In addition, from the viewpoint of solubility and diversity of a molecular structure, the organic light-emitting material is preferably a compound having a coordinate bond. From the viewpoint that a half-width is small and highly efficient light emission is possible, a boron-containing compound such as a boron fluoride complex is also preferable.

As the organic light-emitting material contained in the composition for a color conversion film, it is also possible to use an organic light-emitting material in which a peak wavelength of light emitted by the excitation light is 500 nm or more and less than 580 nm (hereinafter, also referred to as a specific organic light-emitting material A).

As the specific organic light-emitting material A, coumarin compounds such as coumarin 6, coumarin 7, and coumarin 153; cyanine compounds such as indocyanine green; fluorescein compounds such as fluorescein, fluorescein isothiocyanate, and carboxyfluorescein diacetate; phthalocyanine compounds such as phthalocyanine green; perylene compounds such as diisobutyl-4,10-dicyanoperylene-3,9-dicarboxylate; pyrromethene compounds; stillbene compounds; oxazine compounds; naphthalimide compounds; pyrazine compounds; benzoimidazole compounds; benzoxazole compounds; benzothiazole compounds; imidazole pyridine compounds; azole compounds; compounds having a fused aryl ring, such as anthracene; derivatives thereof; aromatic amine compounds; organic metal complex compounds; or the like is preferable. However, the organic light-emitting material is not particularly limited thereto.

In a case where the organic light-emitting material is the specific organic light-emitting material A, a wavelength of the above-described excitation light is preferably 400 nm or more and less than 500 nm.

As the organic light-emitting material contained in the composition for a color conversion film, it is also possible to use an organic light-emitting material in which a peak wavelength of light emitted by the excitation light is 580 nm or more and less than 780 nm (hereinafter, also referred to as a specific organic light-emitting material B).

Suitable examples of the specific organic light-emitting material B include cyanine compounds such as 4-dicyanomethylene-2-methyl-6-(p-dimethylaminostyryl)-4H-pyran; rhodamine compounds such as rhodamine B, rhodamine 6G, rhodamine 101, and sulforhodamine 101; pyridine compounds such as 1-ethyl-2-(4-(p-dimethylaminophenyl)-1,3-butadienyl)-pyridinium-perchlorate; perylene compounds such as N,N′-bis(2,6-diisopropylphenyl)-1,6,7,12-tetraphenoxyperylene-3,4:9,10-bisdicarboimide; porphyrin compounds; pyrromethene compounds; oxazine compounds; pyrazine compounds; compounds having a fused aryl ring, such as naphthacene and dibenzodiindenoperylene; derivatives thereof; and organic metal complex compounds. However, the specific organic light-emitting material B is not particularly limited thereto.

In a case where the organic light-emitting material is the specific organic light-emitting material B, a wavelength of the above-described excitation light is preferably 400 nm or more and less than 580 nm.

Among the above-described compounds, a pyrromethene compound is preferable because it provides an excellent emission quantum yield and has good durability. As the pyrromethene compound, for example, a compound represented by General Formula (1) is preferable because it exhibits light emission with excellent color purity.

For the above-described reasons, it is preferable that at least one of the specific organic light-emitting material A or the specific organic light-emitting material B is the pyrromethene compound.

As the pyrromethene compound, for example, a compound represented by General Formula (1) described below is preferable because it exhibits light emission with excellent color purity.

(Compound Represented by General Formula (1))

The organic light-emitting material is preferably represented by General Formula (1). Even in a case where the organic light-emitting material is represented by General Formula (1), the composition for a color conversion film can contain an organic light-emitting material other than the organic light-emitting material represented by General Formula (1).

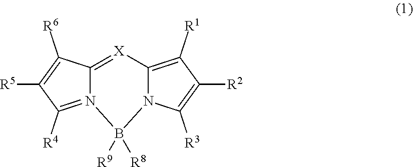

In General Formula (1), X represents C-R⁷ or N. R¹ to R⁹ are each independently selected from a hydrogen atom, an alkyl group, a cycloalkyl group, a heterocyclic group, an alkenyl group, a cycloalkenyl group, an alkynyl group, a hydroxyl group, a thiol group, an alkoxy group, an alkylthio group, an arylether group, an arylthioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, or a phosphine oxide group, in which adjacent groups of R¹ to R⁹ may form a fused ring.

In all the above-described groups, the hydrogen atom may be a deuterium atom.

This also applies to the compound described below or a partial structure thereof. In addition, in the following description, for example, a substituted or unsubstituted aryl group having 6 to 40 carbon atoms is an aryl group in which the number of carbon atoms including the substituent substituted on the aryl group is 6 to 40 carbon atoms. The same applies to other substituents which specify the number of carbon atoms.

In addition, in all the above-described groups, as a substituent in a case of being substituted, an alkyl group, a cycloalkyl group, a heterocyclic group, an alkenyl group, a cycloalkenyl group, an alkynyl group, a hydroxyl group, a thiol group, an alkoxy group, an alkylthio group, an arylether group, an arylthioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, or a phosphine oxide group is preferable, and furthermore, a specific substituent that is preferred in the description of each substituent is preferable. In addition, these substituents may be further substituted with the above-described substituent.

The term “unsubstituted” in the case of “substituted or unsubstituted” means that a hydrogen atom or a deuterium atom has been substituted. The same applies to a case where the compound described below or a partial structure thereof is “substituted or unsubstituted”.

In all the above-described groups, the alkyl group represents, for example, a saturated aliphatic hydrocarbon group such as a methyl group, an ethyl group, an n-propyl group, an isopropyl group, an n-butyl group, an sec-butyl group, and a tert-butyl group, and the alkyl group may or may not have a substituent. The additional substituent in a case of being substituted is not particularly limited, and examples thereof an alkyl group, halogen, an aryl group, and a heteroaryl group. This point is also common to the following description. In addition, the number of carbon atoms in the alkyl group is not particularly limited, but from the viewpoint of availability and cost, it is preferably in a range of 1 or more and 20 or less, and more preferably in a range of 1 or more and 8 or less.

The cycloalkyl group represents, for example, a saturated alicyclic hydrocarbon group such as a cyclopropyl group, a cyclohexyl group, a norbornyl group, and an adamantyl group, and the cycloalkyl group may or may not have a substituent. The number of carbon atoms in an alkyl group moiety is not particularly limited, but is preferably in a range of 3 or more and 20 or less.

The heterocyclic group represents, for example, an aliphatic ring having a non-carbon atom in the ring, such as a pyran ring, a piperidine ring, and a cyclic amide, and the heterocyclic group may or may not have a substituent.

The number of carbon atoms in the heterocyclic group is not particularly limited, but is preferably in a range of 2 or more and 20 or less.

The alkenyl group represents, for example, an unsaturated aliphatic hydrocarbon group containing a double bond, such as a vinyl group, an allyl group, and a butadienyl group, and the alkenyl group may or may not have a substituent. The number of carbon atoms in the alkenyl group is not particularly limited, but is preferably in a range of 2 or more and 20 or less.

The cycloalkenyl group represents, for example, an unsaturated alicyclic hydrocarbon group containing a double bond, such as a cyclopentenyl group, a cyclopentadienyl group, and a cyclohexenyl group, and the cycloalkenyl group may or may not have a substituent.

The alkynyl group represents, for example, an unsaturated aliphatic hydrocarbon group containing a triple bond, such as an ethynyl group, and the alkynyl group may or may not have a substituent. The number of carbon atoms in the alkynyl group is not particularly limited, but is preferably in a range of 2 or more and 20 or less.

The alkoxy group represents, for example, a functional group in which an aliphatic hydrocarbon group is bonded through an ether bond, such as a methoxy group, an ethoxy group, and a propoxy group, and the aliphatic hydrocarbon group may or may not have a substituent. The number of carbon atoms in the alkoxy group is not particularly limited, but is preferably in a range of 1 or more and 20 or less.

The alkylthio group is a group in which an oxygen atom of the ether bond of the alkoxy group is replaced with a sulfur atom. A hydrocarbon group of the alkylthio group may or may not have a substituent. The number of carbon atoms in the alkylthio group is not particularly limited, but is preferably in a range of 1 or more and 20 or less.

The arylether group represents, for example, a functional group in which an aromatic hydrocarbon group is bonded through an ether bond, such as a phenoxy group, and the aromatic hydrocarbon group may or may not have a substituent. The number of carbon atoms in the arylether group is not particularly limited, but is preferably in a range of 6 or more and 40 or less.

The arylthioether group is a group in which an oxygen atom of the ether bond of the arylether group is replaced with a sulfur atom. The aromatic hydrocarbon group in the arylthioether group may or may not have a substituent. The number of carbon atoms in the arylthioether group is not particularly limited, but is preferably in a range of 6 or more and 40 or less.

The aryl group represents, for example, an aromatic hydrocarbon group such as a phenyl group, a biphenyl group, a terphenyl group, a naphthyl group, a fluorenyl group, a benzofluorenyl group, a dibenzofluorenyl group, a phenanthryl group, an anthracenyl group, a benzophenanthryl group, a benzoanthracenyl group, a chrysenyl group, a pyrenyl group, a fluoranthenyl group, a triphenylenyl group, a benzofluoranthenyl group, a dibenzoanthracenyl group, a perylenyl group, and a helicenyl group. Among the above, a phenyl group, a biphenyl group, a terphenyl group, a naphthyl group, a fluorenyl group, a phenanthryl group, an anthracenyl group, a pyrenyl group, a fluoranthenyl group, or a triphenylenyl group is preferable. The aryl group may or may not have a substituent. The number of carbon atoms in the aryl group is not particularly limited, but is preferably in a range of 6 or more and 40 or less and more preferably in a range of 6 or more and 30 or less.

In a case where R¹ to R⁹ represent a substituted or unsubstituted aryl group, as the aryl group, a phenyl group, a biphenyl group, a terphenyl group, a naphthyl group, a fluorenyl group, a phenanthryl group, or an anthracenyl group is preferable, a phenyl group, a biphenyl group, a terphenyl group, or a naphthyl group is more preferable. A phenyl group, a biphenyl group, or a terphenyl group is still more preferable, and a phenyl group is particularly preferable.

In a case where each substituent is further substituted with an aryl group, as the aryl group, a phenyl group, a biphenyl group, a terphenyl group, a naphthyl group, a fluorenyl group, a phenanthryl group, or an anthracenyl group is preferable, a phenyl group, a biphenyl group, a terphenyl group, or a naphthyl group is more preferable. A phenyl group is particularly preferable.

The heteroaryl group represents, for example, a cyclic aromatic group having one or more atoms other than carbon in the ring, such as a pyridyl group, a furanyl group, a thienyl group, a quinolinyl group, an isoquinolinyl group, a pyrazinyl group, a pyrimidyl group, a pyridazinyl group, a triazinyl group, a naphthyridinyl group, a cinnolinyl group, a phthalazinyl group, a quinoxalinyl group, a quinazolinyl group, a benzofuranyl group, a benzothienyl group, an indolyl group, a dibenzofuranyl group, a dibenzothienyl group, a carbazolyl group, a benzocarbazolyl group, a carbolinyl group, an indolocarbazolyl group, a benzofurocarbazolyl group, a benzothienocarbazolyl group, a dihydroindenocarbazolyl group, a benzoquinolinyl group, acridinyl group, a dibenzoacridinyl group, a benzimidazolyl group, an imidazopyridyl group, a benzoxazolyl group, a benzothiazolyl group, and a phenanthrolinyl group.

The naphthyridinyl group represents any of a 1,5-naphthyridinyl group, a 1,6-naphthyridinyl group, a 1,7-naphthyridinyl group, a 1,8-naphthyridinyl group, a 2,6-naphthyridinyl group, or a 2,7-naphthyridinyl group. The heteroaryl group may or may not have a substituent. The number of carbon atoms in the heteroaryl group is not particularly limited, but is preferably in a range of 2 or more and 40 or less and more preferably in a range of 2 or more and 30 or less.

In a case where R¹ to R⁹ represent a substituted or unsubstituted heteroaryl group, as the heteroaryl group, a pyridyl group, a furanyl group, a thienyl group, a quinolinyl group, a pyrimidyl group, a triazinyl group, a benzofuranyl group, a benzothienyl group, an indolyl group, a dibenzofuranyl group, a dibenzothienyl group, a carbazolyl group, a benzimidazolyl group, an imidazopyridyl group, a benzoxazolyl group, a benzothiazolyl group, or a phenanthrolinyl group is preferable, and a pyridyl group, a furanyl group, a thienyl group, or a quinolinyl group is more preferable. A pyridyl group is particularly preferable.

In a case where each substituent is further substituted with a heteroaryl group, as the heteroaryl group, a pyridyl group, a furanyl group, a thienyl group, a quinolinyl group, a pyrimidyl group, a triazinyl group, a benzofuranyl group, a benzothienyl group, an indolyl group, a dibenzofuranyl group, a dibenzothienyl group, a carbazolyl group, a benzimidazolyl group, an imidazopyridyl group, a benzoxazolyl group, a benzothiazolyl group, or a phenanthrolinyl group is preferable, and a pyridyl group, a furanyl group, a thienyl group, or a quinolinyl group is more preferable. A pyridyl group is particularly preferable.

The halogen represents an atom selected from fluorine, chlorine, bromine, or iodine. In addition, the carbonyl group, the carboxyl group, the oxycarbonyl group, and the carbamoyl group may or may not have a substituent. Here, examples of the substituent include an alkyl group, a cycloalkyl group, an aryl group, and a heteroaryl group, and these substituents may be further substituted.

The amino group is a substituted or unsubstituted amino group. Examples of the substituent in a case of being substituted include an aryl group, a heteroaryl group, a linear alkyl group, and a branched alkyl group. As the aryl group and the heteroaryl group, a phenyl group, a naphthyl group, a pyridyl group, or a quinolinyl group is preferable. These substituents may be further substituted. The number of carbon atoms is not particularly limited, but is preferably in a range of 2 or more and 50 or less, more preferably in a range of 6 or more and 40 or less, and particularly preferably in a range of 6 or more and 30 or less.

The silyl group represents, for example, an alkylsilyl group such as a trimethylsilyl group, a triethylsilyl group, a tert-butyldimethylsilyl group, a propyldimethylsilyl group, and a vinyldimethylsilyl group; or an arylsilyl group such as a phenyldimethylsilyl group, a tert-butyldiphenylsilyl group, a triphenylsilyl group, and a trinaphthylsilyl group. A substituent on silicon may be further substituted. The number of carbon atoms in the silyl group is not particularly limited, but is preferably in a range of 1 or more and 30 or less.

The siloxanyl group represents, for example, a silicon compound group through an ether bond, such as a trimethylsiloxanyl group. A substituent on silicon may be further substituted.

In addition, the boryl group is a substituted or unsubstituted boryl group. Examples of the substituent in a case of being substituted include an aryl group, a heteroaryl group, a linear alkyl group, a branched alkyl group, an arylether group, an alkoxy group, and a hydroxyl group. Among the above, an aryl group or an arylether group is preferable. In addition, the phosphine oxide group is a group represented by —P(═O)R¹⁰R¹¹.R¹⁰ and R¹¹ are selected from the same groups as R¹ to R⁹.

The fused ring and the aliphatic ring formed between the adjacent substituents means that any two adjacent substituents (for example, R¹ and R² in General Formula (1)) are bonded to each other to form a conjugated or non-conjugated cyclic skeleton. Examples of a constituent element of such a fused ring and an aliphatic ring include carbon, nitrogen, oxygen, sulfur, phosphorus, and silicon. In addition, the fused ring and the aliphatic ring may be fused with another ring.

Since the compound represented by General Formula (1) exhibits excellent emission quantum yield and has a small half-width of the emission spectrum, it is possible to achieve both efficient color conversion and excellent color purity. Furthermore, in the compound represented by General Formula (1), by introducing an appropriate substituent at an appropriate position, various characteristics and physical properties such as light emission efficiency, color purity, thermal stability, photostability, and dispersibility can be adjusted.

For example, as compared with a case where R¹, R³, R⁴, and R⁶ all represent hydrogen atoms, a case where at least one of R¹, R³, R⁴, or R⁶ represents a group selected from the group including a substituted or unsubstituted alkyl group, a substituted or unsubstituted aryl group, and a substituted or unsubstituted heteroaryl group exhibits more excellent thermal stability and photostability.

In a case where at least one of R¹, R³, R⁴, or R⁶ represents a substituted or unsubstituted alkyl group, as the alkyl group, an alkyl group having 1 to 6 carbon atoms, such as a methyl group, an ethyl group, an n-propyl group, an isopropyl group, an n-butyl group, a sec-butyl group, a tert-butyl group, a pentyl group, and a hexyl group, is preferable.

Further, from the viewpoint of excellent thermal stability, the above-described alkyl group is preferably a methyl group, an ethyl group, an n-propyl group, an isopropyl group, an n-butyl group, an sec-butyl group, or a tert-butyl group. In addition, from the viewpoint of preventing concentration quenching and improving the emission quantum yield, the above-described alkyl group is more preferably a sterically bulky tert-butyl group. In addition, from the viewpoint of ease of synthesis and availability of raw materials, a methyl group is also preferably used as the above-described alkyl group.

In a case where at least one of R¹, R³, R⁴, or R⁶ represents a substituted or unsubstituted aryl group, as the aryl group, a phenyl group, a biphenyl group, a terphenyl group, or a naphthyl group is preferable, a phenyl group or a biphenyl group is more preferable. A phenyl group is particularly preferable.

In a case where at least one of R¹, R³, R⁴, or R⁶ represents a substituted or unsubstituted heteroaryl group, as the heteroaryl group, a pyridyl group, a quinolinyl group, or a thienyl group is preferable, and a pyridyl group or a quinolinyl group is more preferable. A pyridyl group is particularly preferable.

A case where all of R¹, R³, R⁴, and R⁶ each independently represent a substituted or unsubstituted alkyl group is preferable because of its good solubility in a binder resin or a solvent. In this case, from the viewpoint of ease of synthesis and availability of raw materials, the alkyl group is preferably a methyl group.

A case where all of R¹, R³, R⁴, and R⁶ each independently represent a substituted or unsubstituted aryl group or a substituted or unsubstituted heteroaryl group is preferable because it exhibits better thermal stability and photostability. In this case, it is more preferable that all of R¹, R³, R⁴, and R⁶ each independently represent a substituted or unsubstituted aryl group.

Although there are a plurality of substituents which improve properties, the substituents which exhibit sufficient performance in all of them are limited. In particular, it is difficult to achieve both high light emission efficiency and high color purity. Therefore, by introducing a plurality of types of substituents into the compound represented by General Formula (1), it is possible to obtain a compound having balanced emission characteristics, color purity, and the like.

In particular, in a case where all of R¹, R³, R⁴, and R⁶ each independently represent a substituted or unsubstituted aryl group, for example, it is preferable to introduce a plurality of types of substituents, such as R¹≠R⁴, R³≠R⁶, R¹≠R³, or R⁴≠R⁶.

Here, “≠” indicates that the groups have different structures. For example, R¹≠R⁴ indicates that R¹ and R⁴ are groups having different structures. By introducing a plurality of types of substituents as described above, an aryl group which affects the color purity and an aryl group which affects the light emission efficiency can be simultaneously introduced, so that fine adjustment is possible.

A case where R¹≠R³ or R⁴≠R⁶ is preferable because the light emission efficiency and the color purity can be improved in a balanced manner. In this case, with respect to the compound represented by General Formula (1), since one or more aryl groups which affect the color purity are introduced to each of pyrrole rings on both side and aryl groups which affect the light emission efficiency are introduced at other positions, both of these properties can be improved. In addition, in the case where R¹≠R³ or R⁴≠R⁶, from the viewpoint of improving both the heat resistance and the color purity, it is more preferable that R¹=R⁴ and R³=R⁶.

As the aryl group which affects the color purity, an aryl group substituted with an electron-donating group is preferable. The electron-donating group is an atomic group which donates an electron to the substituted atomic group by an inductive effect or a resonance effect in organic electron theory. Examples of the electron-donating group include groups having a negative value as the substituent constant (σp (para)) of Hammett's law. The substituent constant (σp (para)) of Hammett's law can be quoted from the 5th edition of the Basics of Chemistry Handbook (page 380 of II).

Specific examples of the electron-donating group include an alkyl group (σp of methyl group: −0.17), an alkoxy group (σp of methoxy group: −0.27), and an amino group (σp of —NH₂: −0.66).

In particular, an alkyl group having 1 to 8 carbon atoms or an alkoxy group having 1 to 8 carbon atoms is preferable, and a methyl group, an ethyl group, a tert-butyl group, or a methoxy group is more preferable. From the viewpoint of dispersibility, a tert-butyl group or a methoxy group is particularly preferable, and in a case where these are used as the above-described electron-donating group, in the compound represented by General Formula (1), quenching due to aggregation of molecules can be prevented.

The substitution position of the substituent is not particularly limited, but since it is necessary to suppress torsion of a bond in order to increase the photostability of the compound represented by General Formula (1), it is preferable that the substituent is bonded at a meta-position or para-position with respect to the bonding position with the pyrromethene skeleton. On the other hand, as the aryl group which mainly affects the light emission efficiency, an aryl group having a bulky substituent such as a tert-butyl group, an adamantyl group, or a methoxy group is preferable.

In a case where R¹, R³, R⁴, and R⁶ each independently represent a substituted or unsubstituted aryl group, it is preferable that R¹, R³, R⁴, and R⁶ each independently represent a substituted or unsubstituted phenyl group. In this case, it is more preferable that R¹, R³, R⁴, and R⁶ are each selected from the following Ar-1 to Ar-6. In this case, examples of a preferred combination of R¹, R³, R⁴, and R⁶ include combinations shown in Tables 1-1 to 1-11, but the preferred combination thereof is not limited thereto.

The black circle means a bonding portion with the main skeleton.

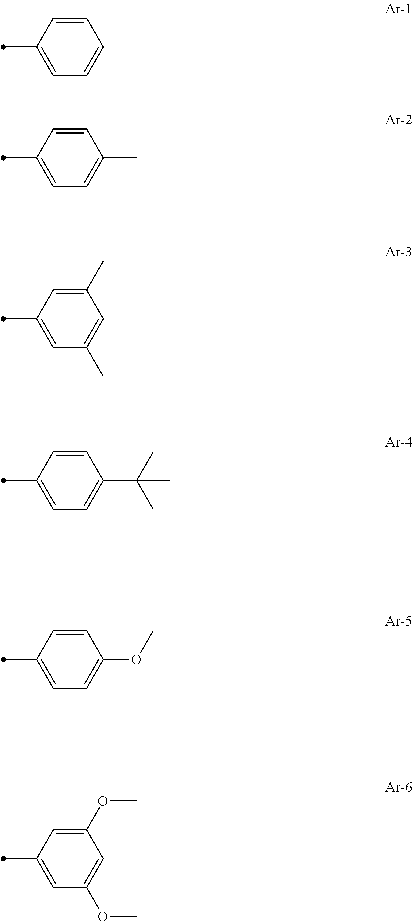

TABLE 1

| R1 | R3 | R4 | R6 |
|---|---|---|---|
| Ar-1 | Ar-1 | Ar-1 | Ar-1 |
| Ar-1 | Ar-1 | Ar-1 | Ar-2 |
| Ar-1 | Ar-1 | Ar-1 | Ar-3 |
| Ar-1 | Ar-1 | Ar-1 | Ar-4 |
| Ar-1 | Ar-1 | Ar-1 | Ar-5 |
| Ar-1 | Ar-1 | Ar-1 | Ar-6 |
| Ar-1 | Ar-1 | Ar-2 | Ar-1 |
| Ar-1 | Ar-1 | Ar-2 | Ar-2 |
| Ar-1 | Ar-1 | Ar-2 | Ar-3 |
| Ar-1 | Ar-1 | Ar-2 | Ar-4 |
| Ar-1 | Ar-1 | Ar-2 | Ar-5 |
| Ar-1 | Ar-1 | Ar-2 | Ar-6 |
| Ar-1 | Ar-1 | Ar-3 | Ar-1 |
| Ar-1 | Ar-1 | Ar-3 | Ar-2 |
| Ar-1 | Ar-1 | Ar-3 | Ar-3 |
| Ar-1 | Ar-1 | Ar-3 | Ar-4 |
| Ar-1 | Ar-1 | Ar-3 | Ar-5 |
| Ar-1 | Ar-1 | Ar-3 | Ar-6 |
| Ar-1 | Ar-1 | Ar-4 | Ar-1 |
| Ar-1 | Ar-1 | Ar-4 | Ar-2 |
| Ar-1 | Ar-1 | Ar-4 | Ar-3 |
| Ar-1 | Ar-1 | Ar-4 | Ar-4 |
| Ar-1 | Ar-1 | Ar-4 | Ar-5 |
| Ar-1 | Ar-1 | Ar-4 | Ar-6 |
| Ar-1 | Ar-1 | Ar-5 | Ar-1 |
| Ar-1 | Ar-1 | Ar-5 | Ar-2 |
| Ar-1 | Ar-1 | Ar-5 | Ar-3 |
| Ar-1 | Ar-1 | Ar-5 | Ar-4 |
| Ar-1 | Ar-1 | Ar-5 | Ar-5 |
| Ar-1 | Ar-1 | Ar-5 | Ar-6 |

TABLE 2

| R1 | R3 | R4 | R6 |
|---|---|---|---|
| Ar-1 | Ar-1 | Ar-6 | Ar-1 |
| Ar-1 | Ar-1 | Ar-6 | Ar-2 |
| Ar-1 | Ar-1 | Ar-6 | Ar-3 |
| Ar-1 | Ar-1 | Ar-6 | Ar-4 |
| Ar-1 | Ar-1 | Ar-6 | Ar-5 |
| Ar-1 | Ar-1 | Ar-6 | Ar-6 |
| Ar-1 | Ar-2 | Ar-1 | Ar-2 |
| Ar-1 | Ar-2 | Ar-1 | Ar-3 |
| Ar-1 | Ar-2 | Ar-1 | Ar-4 |
| Ar-1 | Ar-2 | Ar-1 | Ar-5 |
| Ar-1 | Ar-2 | Ar-1 | Ar-6 |
| Ar-1 | Ar-2 | Ar-2 | Ar-1 |
| Ar-1 | Ar-2 | Ar-2 | Ar-2 |
| Ar-1 | Ar-2 | Ar-2 | Ar-3 |
| Ar-1 | Ar-2 | Ar-2 | Ar-4 |
| Ar-1 | Ar-2 | Ar-2 | Ar-5 |
| Ar-1 | Ar-2 | Ar-2 | Ar-6 |
| Ar-1 | Ar-2 | Ar-3 | Ar-1 |
| Ar-1 | Ar-2 | Ar-3 | Ar-2 |
| Ar-1 | Ar-2 | Ar-3 | Ar-3 |
| Ar-1 | Ar-2 | Ar-3 | Ar-4 |
| Ar-1 | Ar-2 | Ar-3 | Ar-5 |
| Ar-1 | Ar-2 | Ar-3 | Ar-6 |
| Ar-1 | Ar-2 | Ar-4 | Ar-1 |
| Ar-1 | Ar-2 | Ar-4 | Ar-2 |
| Ar-1 | Ar-2 | Ar-4 | Ar-3 |
| Ar-1 | Ar-2 | Ar-4 | Ar-4 |
| Ar-1 | Ar-2 | Ar-4 | Ar-5 |
| Ar-1 | Ar-2 | Ar-4 | Ar-6 |

TABLE 3

| R1 | R3 | R4 | R6 |
|---|---|---|---|
| Ar-1 | Ar-2 | Ar-5 | Ar-1 |
| Ar-1 | Ar-2 | Ar-5 | Ar-2 |
| Ar-1 | Ar-2 | Ar-5 | Ar-3 |
| Ar-1 | Ar-2 | Ar-5 | Ar-4 |
| Ar-1 | Ar-2 | Ar-5 | Ar-5 |
| Ar-1 | Ar-2 | Ar-5 | Ar-6 |
| Ar-1 | Ar-2 | Ar-6 | Ar-1 |
| Ar-1 | Ar-2 | Ar-6 | Ar-2 |
| Ar-1 | Ar-2 | Ar-6 | Ar-3 |
| Ar-1 | Ar-2 | Ar-6 | Ar-4 |
| Ar-1 | Ar-2 | Ar-6 | Ar-5 |
| Ar-1 | Ar-2 | Ar-6 | Ar-6 |
| Ar-1 | Ar-3 | Ar-1 | Ar-2 |
| Ar-1 | Ar-3 | Ar-1 | Ar-3 |
| Ar-1 | Ar-3 | Ar-1 | Ar-4 |
| Ar-1 | Ar-3 | Ar-1 | Ar-5 |
| Ar-1 | Ar-3 | Ar-1 | Ar-6 |
| Ar-1 | Ar-3 | Ar-2 | Ar-2 |
| Ar-1 | Ar-3 | Ar-2 | Ar-3 |
| Ar-1 | Ar-3 | Ar-2 | Ar-4 |
| Ar-1 | Ar-3 | Ar-2 | Ar-5 |
| Ar-1 | Ar-3 | Ar-2 | Ar-6 |
| Ar-1 | Ar-3 | Ar-3 | Ar-1 |
| Ar-1 | Ar-3 | Ar-3 | Ar-2 |
| Ar-1 | Ar-3 | Ar-3 | Ar-3 |
| Ar-1 | Ar-3 | Ar-3 | Ar-4 |
| Ar-1 | Ar-3 | Ar-3 | Ar-5 |
| Ar-1 | Ar-3 | Ar-3 | Ar-6 |
| Ar-1 | Ar-3 | Ar-4 | Ar-1 |
| Ar-1 | Ar-3 | Ar-4 | Ar-2 |
| Ar-1 | Ar-3 | Ar-4 | Ar-3 |

TABLE 4

| R1 | R3 | R4 | R6 |
|---|---|---|---|
| Ar-1 | Ar-3 | Ar-4 | Ar-4 |
| Ar-1 | Ar-3 | Ar-4 | Ar-5 |
| Ar-1 | Ar-3 | Ar-4 | Ar-6 |
| Ar-1 | Ar-3 | Ar-5 | Ar-1 |
| Ar-1 | Ar-3 | Ar-5 | Ar-2 |
| Ar-1 | Ar-3 | Ar-5 | Ar-3 |
| Ar-1 | Ar-3 | Ar-5 | Ar-4 |
| Ar-1 | Ar-3 | Ar-5 | Ar-5 |
| Ar-1 | Ar-3 | Ar-5 | Ar-6 |
| Ar-1 | Ar-3 | Ar-6 | Ar-1 |
| Ar-1 | Ar-3 | Ar-6 | Ar-2 |
| Ar-1 | Ar-3 | Ar-6 | Ar-3 |
| Ar-1 | Ar-3 | Ar-6 | Ar-4 |
| Ar-1 | Ar-3 | Ar-6 | Ar-5 |
| Ar-1 | Ar-3 | Ar-6 | Ar-6 |
| Ar-1 | Ar-4 | Ar-1 | Ar-2 |
| Ar-1 | Ar-4 | Ar-1 | Ar-3 |
| Ar-1 | Ar-4 | Ar-1 | Ar-4 |
| Ar-1 | Ar-4 | Ar-1 | Ar-5 |
| Ar-1 | Ar-4 | Ar-1 | Ar-6 |
| Ar-1 | Ar-4 | Ar-2 | Ar-2 |
| Ar-1 | Ar-4 | Ar-2 | Ar-3 |
| Ar-1 | Ar-4 | Ar-2 | Ar-4 |
| Ar-1 | Ar-4 | Ar-2 | Ar-5 |
| Ar-1 | Ar-4 | Ar-2 | Ar-6 |
| Ar-1 | Ar-4 | Ar-3 | Ar-2 |
| Ar-1 | Ar-4 | Ar-3 | Ar-3 |
| Ar-1 | Ar-4 | Ar-3 | Ar-4 |
| Ar-1 | Ar-4 | Ar-3 | Ar-5 |
| Ar-1 | Ar-4 | Ar-3 | Ar-6 |

TABLE 5

| R1 | R3 | R4 | R6 |
|---|---|---|---|
| Ar-1 | Ar-4 | Ar-4 | Ar-1 |
| Ar-1 | Ar-4 | Ar-4 | Ar-2 |
| Ar-1 | Ar-4 | Ar-4 | Ar-3 |
| Ar-1 | Ar-4 | Ar-4 | Ar-4 |
| Ar-1 | Ar-4 | Ar-4 | Ar-5 |
| Ar-1 | Ar-4 | Ar-4 | Ar-6 |
| Ar-1 | Ar-4 | Ar-5 | Ar-1 |
| Ar-1 | Ar-4 | Ar-5 | Ar-2 |
| Ar-1 | Ar-4 | Ar-5 | Ar-3 |
| Ar-1 | Ar-4 | Ar-5 | Ar-4 |
| Ar-1 | Ar-4 | Ar-5 | Ar-5 |
| Ar-1 | Ar-4 | Ar-5 | Ar-6 |
| Ar-1 | Ar-4 | Ar-6 | Ar-1 |
| Ar-1 | Ar-4 | Ar-6 | Ar-2 |
| Ar-1 | Ar-4 | Ar-6 | Ar-3 |
| Ar-1 | Ar-4 | Ar-6 | Ar-4 |
| Ar-1 | Ar-4 | Ar-6 | Ar-5 |
| Ar-1 | Ar-4 | Ar-6 | Ar-6 |
| Ar-1 | Ar-5 | Ar-1 | Ar-2 |
| Ar-1 | Ar-5 | Ar-1 | Ar-3 |
| Ar-1 | Ar-5 | Ar-1 | Ar-4 |
| Ar-1 | Ar-5 | Ar-1 | Ar-5 |
| Ar-1 | Ar-5 | Ar-1 | Ar-6 |
| Ar-1 | Ar-5 | Ar-2 | Ar-2 |
| Ar-1 | Ar-5 | Ar-2 | Ar-3 |
| Ar-1 | Ar-5 | Ar-2 | Ar-4 |
| Ar-1 | Ar-5 | Ar-2 | Ar-5 |
| Ar-1 | Ar-5 | Ar-2 | Ar-6 |
| Ar-1 | Ar-5 | Ar-3 | Ar-2 |
| Ar-1 | Ar-5 | Ar-3 | Ar-3 |

TABLE 6

| R1 | R3 | R4 | R6 |
|---|---|---|---|
| Ar-1 | Ar-5 | Ar-3 | Ar-4 |
| Ar-1 | Ar-5 | Ar-3 | Ar-5 |
| Ar-1 | Ar-5 | Ar-3 | Ar-6 |
| Ar-1 | Ar-5 | Ar-4 | Ar-2 |
| Ar-1 | Ar-5 | Ar-4 | Ar-3 |
| Ar-1 | Ar-5 | Ar-4 | Ar-4 |
| Ar-1 | Ar-5 | Ar-4 | Ar-5 |
| Ar-1 | Ar-5 | Ar-4 | Ar-6 |
| Ar-1 | Ar-5 | Ar-5 | Ar-1 |
| Ar-1 | Ar-5 | Ar-5 | Ar-2 |
| Ar-1 | Ar-5 | Ar-5 | Ar-3 |
| Ar-1 | Ar-5 | Ar-5 | Ar-4 |
| Ar-1 | Ar-5 | Ar-5 | Ar-5 |
| Ar-1 | Ar-5 | Ar-5 | Ar-6 |
| Ar-1 | Ar-5 | Ar-6 | Ar-1 |
| Ar-1 | Ar-5 | Ar-6 | Ar-2 |
| Ar-1 | Ar-5 | Ar-6 | Ar-3 |
| Ar-1 | Ar-5 | Ar-6 | Ar-4 |
| Ar-1 | Ar-5 | Ar-6 | Ar-5 |
| Ar-1 | Ar-5 | Ar-6 | Ar-6 |
| Ar-1 | Ar-6 | Ar-1 | Ar-2 |
| Ar-1 | Ar-6 | Ar-1 | Ar-3 |
| Ar-1 | Ar-6 | Ar-1 | Ar-4 |
| Ar-1 | Ar-6 | Ar-1 | Ar-5 |
| Ar-1 | Ar-6 | Ar-1 | Ar-6 |
| Ar-1 | Ar-6 | Ar-2 | Ar-2 |
| Ar-1 | Ar-6 | Ar-2 | Ar-3 |
| Ar-1 | Ar-6 | Ar-2 | Ar-4 |
| Ar-1 | Ar-6 | Ar-2 | Ar-5 |
| Ar-1 | Ar-6 | Ar-2 | Ar-6 |

TABLE 7

| R1 | R3 | R4 | R6 |
|---|---|---|---|
| Ar-1 | Ar-6 | Ar-3 | Ar-2 |
| Ar-1 | Ar-6 | Ar-3 | Ar-3 |
| Ar-1 | Ar-6 | Ar-3 | Ar-4 |
| Ar-1 | Ar-6 | Ar-3 | Ar-5 |
| Ar-1 | Ar-6 | Ar-3 | Ar-6 |
| Ar-1 | Ar-6 | Ar-4 | Ar-2 |
| Ar-1 | Ar-6 | Ar-4 | Ar-3 |
| Ar-1 | Ar-6 | Ar-4 | Ar-4 |
| Ar-1 | Ar-6 | Ar-4 | Ar-5 |
| Ar-1 | Ar-6 | Ar-4 | Ar-6 |
| Ar-1 | Ar-6 | Ar-5 | Ar-2 |
| Ar-1 | Ar-6 | Ar-5 | Ar-3 |
| Ar-1 | Ar-6 | Ar-5 | Ar-4 |
| Ar-1 | Ar-6 | Ar-5 | Ar-5 |
| Ar-1 | Ar-6 | Ar-5 | Ar-6 |
| Ar-1 | Ar-6 | Ar-6 | Ar-1 |
| Ar-1 | Ar-6 | Ar 6 | Ar-2 |
| Ar-1 | Ar-6 | Ar-6 | Ar-3 |
| Ar-1 | Ar-6 | Ar-6 | Ar-4 |
| Ar-1 | Ar-6 | Ar-6 | Ar-5 |
| Ar-1 | Ar-6 | Ar-6 | Ar-6 |
| Ar-2 | Ar-1 | Ar-1 | Ar-2 |
| Ar-2 | Ar-1 | Ar-1 | Ar-3 |
| Ar-2 | Ar-1 | Ar-1 | Ar-4 |
| Ar-2 | Ar-1 | Ar-1 | Ar-5 |
| Ar-2 | Ar-1 | Ar-1 | Ar-6 |
| Ar-2 | Ar-1 | Ar-2 | Ar-2 |
| Ar-2 | Ar-1 | Ar-2 | Ar-3 |
| Ar-2 | Ar-1 | Ar-2 | Ar-4 |
| Ar-2 | Ar-1 | Ar-2 | Ar-5 |

TABLE 8

| R1 | R3 | R4 | R6 |
|---|---|---|---|
| Ar-2 | Ar-1 | Ar-2 | Ar-6 |
| Ar-2 | Ar-1 | Ar-3 | Ar-2 |
| Ar-2 | Ar-1 | Ar-3 | Ar-3 |
| Ar-2 | Ar-1 | Ar-3 | Ar-4 |
| Ar-2 | Ar-1 | Ar-3 | Ar-5 |
| Ar-2 | Ar-1 | Ar-3 | Ar-6 |
| Ar-2 | Ar-1 | Ar-4 | Ar-2 |
| Ar-2 | Ar-1 | Ar-4 | Ar-3 |
| Ar-2 | Ar-1 | Ar-4 | Ar-4 |
| Ar-2 | Ar-1 | Ar-4 | Ar-5 |
| Ar-2 | Ar-1 | Ar-4 | Ar-6 |
| Ar-2 | Ar-1 | Ar-5 | Ar-2 |
| Ar-2 | Ar-1 | Ar-5 | Ar-3 |
| Ar-2 | Ar-1 | Ar-5 | Ar-4 |
| Ar-2 | Ar-1 | Ar-5 | Ar-5 |
| Ar-2 | Ar-1 | Ar-5 | Ar-6 |
| Ar-2 | Ar-1 | Ar-6 | Ar-2 |
| Ar-2 | Ar-1 | Ar-6 | Ar-3 |
| Ar-2 | Ar-1 | Ar-6 | Ar-4 |
| Ar-2 | Ar-1 | Ar-6 | Ar-5 |
| Ar-2 | Ar-1 | Ar-6 | Ar-6 |
| Ar-2 | Ar-2 | Ar-1 | Ar-3 |
| Ar-2 | Ar-2 | Ar-1 | Ar-4 |
| Ar-2 | Ar-2 | Ar-1 | Ar-5 |
| Ar-2 | Ar-2 | Ar-1 | Ar-6 |
| Ar-2 | Ar-2 | Ar-2 | Ar-2 |
| Ar-2 | Ar-2 | Ar-2 | Ar-3 |
| Ar-2 | Ar-2 | Ar-2 | Ar-4 |
| Ar-2 | Ar-2 | Ar-2 | Ar-5 |
| Ar-2 | Ar-2 | Ar-2 | Ar-6 |

TABLE 9

| R1 | R3 | R4 | R6 |
|---|---|---|---|
| Ar-2 | Ar-2 | Ar-3 | Ar-2 |
| Ar-2 | Ar-2 | Ar-3 | Ar-3 |
| Ar-2 | Ar-2 | Ar-3 | Ar-4 |
| Ar-2 | Ar-2 | Ar-3 | Ar-5 |
| Ar-2 | Ar-2 | Ar-3 | Ar-6 |
| Ar-2 | Ar-2 | Ar-4 | Ar-2 |
| Ar-2 | Ar-2 | Ar-4 | Ar-3 |
| Ar-2 | Ar-2 | Ar-4 | Ar-4 |
| Ar-2 | Ar-2 | Ar-4 | Ar-5 |
| Ar-2 | Ar-2 | Ar-4 | Ar-6 |
| Ar-2 | Ar-2 | Ar-5 | Ar-2 |
| Ar-2 | Ar-2 | Ar-5 | Ar-3 |
| Ar-2 | Ar-2 | Ar-5 | Ar-4 |
| Ar-2 | Ar-2 | Ar-5 | Ar-5 |
| Ar-2 | Ar-2 | Ar-5 | Ar-6 |
| Ar-2 | Ar-2 | Ar-6 | Ar-2 |
| Ar-2 | Ar-2 | Ar-6 | Ar-3 |
| Ar-2 | Ar-2 | Ar-6 | Ar-4 |
| Ar-2 | Ar-2 | Ar-6 | Ar-5 |
| Ar-2 | Ar-2 | Ar-6 | Ar-6 |
| Ar-2 | Ar-3 | Ar-1 | Ar-3 |
| Ar-2 | Ar-3 | Ar-1 | Ar-4 |
| Ar-2 | Ar-3 | Ar-1 | Ar-5 |
| Ar-2 | Ar-3 | Ar-1 | Ar-6 |
| Ar-2 | Ar-3 | Ar-2 | Ar-3 |
| Ar-2 | Ar-3 | Ar-2 | Ar-4 |
| Ar-2 | Ar-3 | Ar-2 | Ar-5 |
| Ar-2 | Ar-3 | Ar-2 | Ar-6 |
| Ar-2 | Ar-3 | Ar-3 | Ar-2 |
| Ar-2 | Ar-3 | Ar-3 | Ar-3 |

TABLE 10

| R1 | R3 | R4 | R6 |
|---|---|---|---|
| Ar-2 | Ar-3 | Ar-3 | Ar-4 |
| Ar-2 | Ar-3 | Ar-3 | Ar-5 |
| Ar-2 | Ar-3 | Ar-3 | Ar-6 |
| Ar-2 | Ar-3 | Ar-4 | Ar-2 |
| Ar-2 | Ar-3 | Ar-4 | Ar-3 |
| Ar-2 | Ar-3 | Ar-4 | Ar-4 |
| Ar-2 | Ar-3 | Ar-4 | Ar-5 |
| Ar-2 | Ar-3 | Ar-4 | Ar-6 |
| Ar-2 | Ar-3 | Ar-5 | Ar-2 |
| Ar-2 | Ar-3 | Ar-5 | Ar-3 |
| Ar-2 | Ar-3 | Ar-5 | Ar-4 |
| Ar-2 | Ar-3 | Ar-5 | Ar-5 |
| Ar-2 | Ar-3 | Ar-5 | Ar-6 |
| Ar-2 | Ar-3 | Ar-6 | Ar-2 |
| Ar-2 | Ar-3 | Ar-6 | Ar-3 |
| Ar-2 | Ar-3 | Ar-6 | Ar-4 |
| Ar-2 | Ar-3 | Ar-6 | Ar-5 |
| Ar-2 | Ar-3 | Ar-6 | Ar-6 |
| Ar-2 | Ar-4 | Ar-1 | Ar-3 |
| Ar-2 | Ar-4 | Ar-1 | Ar-4 |
| Ar-2 | Ar-4 | Ar-1 | Ar-5 |
| Ar-2 | Ar-4 | Ar-1 | Ar-6 |
| Ar-2 | Ar-4 | Ar-2 | Ar-3 |
| Ar-2 | Ar-4 | Ar-2 | Ar-4 |
| Ar-2 | Ar-4 | Ar-2 | Ar-5 |
| Ar-2 | Ar-4 | Ar-2 | Ar-6 |
| Ar-2 | Ar-4 | Ar-3 | Ar-3 |
| Ar-2 | Ar-4 | Ar-3 | Ar-4 |
| Ar-2 | Ar-4 | Ar-3 | Ar-5 |
| Ar-2 | Ar-4 | Ar-3 | Ar-6 |

TABLE 11

| R1 | R3 | R4 | R6 |
|---|---|---|---|
| Ar-2 | Ar-4 | Ar-4 | Ar-2 |
| Ar-2 | Ar-4 | Ar-4 | Ar-3 |
| Ar-2 | Ar-4 | Ar-4 | Ar-4 |
| Ar-2 | Ar-4 | Ar-4 | Ar-5 |
| Ar-2 | Ar-4 | Ar-4 | Ar-6 |
| Ar-2 | Ar-4 | Ar-5 | Ar-2 |
| Ar-2 | Ar-4 | Ar-5 | Ar-3 |
| Ar-2 | Ar-4 | Ar-5 | Ar-4 |
| Ar-2 | Ar-4 | Ar-5 | Ar-5 |
| Ar-2 | Ar-4 | Ar-5 | Ar-6 |
| Ar-2 | Ar-4 | Ar-6 | Ar-2 |
| Ar-2 | Ar-4 | Ar-6 | Ar-3 |
| Ar-2 | Ar-4 | Ar-6 | Ar-4 |
| Ar-2 | Ar-4 | Ar-6 | Ar-5 |
| Ar-2 | Ar-4 | Ar-6 | Ar-6 |
| Ar-2 | Ar-5 | Ar-1 | Ar-3 |
| Ar-2 | Ar-5 | Ar-1 | Ar-4 |
| Ar-2 | Ar-5 | Ar-1 | Ar-5 |
| Ar-2 | Ar-5 | Ar-1 | Ar-6 |
| Ar-2 | Ar-5 | Ar-2 | Ar-3 |
| Ar-2 | Ar-5 | Ar-2 | Ar-4 |
| Ar-2 | Ar-5 | Ar-2 | Ar-5 |
| Ar-2 | Ar-5 | Ar-2 | Ar-6 |
| Ar-2 | Ar-5 | Ar-3 | Ar-3 |
| Ar-2 | Ar-5 | Ar-3 | Ar-4 |
| Ar-2 | Ar-5 | Ar-3 | Ar-5 |
| Ar-2 | Ar-5 | Ar-3 | Ar-6 |
| Ar-2 | Ar-5 | Ar-4 | Ar-3 |
| Ar-2 | Ar-5 | Ar-4 | Ar-4 |
| Ar-2 | Ar-5 | Ar-4 | Ar-5 |
| Ar-2 | Ar-5 | Ar-4 | Ar-6 |

TABLE 12

| R1 | R3 | R4 | R6 |
|---|---|---|---|
| Ar-2 | Ar-5 | Ar-5 | Ar-2 |
| Ar-2 | Ar-5 | Ar-5 | Ar-3 |
| Ar-2 | Ar-5 | Ar-5 | Ar-4 |
| Ar-2 | Ar-5 | Ar-5 | Ar-5 |
| Ar-2 | Ar-5 | Ar-5 | Ar-6 |
| Ar-2 | Ar-5 | Ar-6 | Ar-2 |
| Ar-2 | Ar-5 | Ar-6 | Ar-3 |
| Ar-2 | Ar-5 | Ar-6 | Ar-4 |
| Ar-2 | Ar-5 | Ar-6 | Ar-5 |
| Ar-2 | Ar-5 | Ar-6 | Ar-6 |
| Ar-2 | Ar-6 | Ar-1 | Ar-3 |
| Ar-2 | Ar-6 | Ar-1 | Ar-4 |
| Ar-2 | Ar-6 | Ar-1 | Ar-5 |
| Ar-2 | Ar-6 | Ar-1 | Ar-6 |
| Ar-2 | Ar-6 | Ar-2 | Ar-3 |
| Ar-2 | Ar-6 | Ar-2 | Ar-4 |
| Ar-2 | Ar-6 | Ar-2 | Ar-5 |
| Ar-2 | Ar-6 | Ar-2 | Ar-6 |
| Ar-2 | Ar-6 | Ar-3 | Ar-3 |
| Ar-2 | Ar-6 | Ar-3 | Ar-4 |
| Ar-2 | Ar-6 | Ar-3 | Ar-5 |
| Ar-2 | Ar-6 | Ar-3 | Ar-6 |
| Ar-2 | Ar-6 | Ar-4 | Ar-3 |
| Ar-2 | Ar-6 | Ar-4 | Ar-4 |
| Ar-2 | Ar-6 | Ar-4 | Ar-5 |
| Ar-2 | Ar-6 | Ar-4 | Ar-6 |
| Ar-2 | Ar-6 | Ar-5 | Ar-3 |
| Ar-2 | Ar-6 | Ar-5 | Ar-4 |
| Ar-2 | Ar-6 | Ar-5 | Ar-5 |
| Ar-2 | Ar-6 | Ar-5 | Ar-6 |

TABLE 13

| R1 | R3 | R4 | R6 |
|---|---|---|---|
| Ar-2 | Ar-6 | Ar-6 | Ar-2 |
| Ar-2 | Ar-6 | Ar-6 | Ar-3 |
| Ar-2 | Ar-6 | Ar-6 | Ar-4 |
| Ar-2 | Ar-6 | Ar-6 | Ar-5 |
| Ar-2 | Ar-6 | Ar-6 | Ar-6 |
| Ar-3 | Ar-1 | Ar-1 | Ar-3 |
| Ar-3 | Ar-1 | Ar-1 | Ar-4 |
| Ar-3 | Ar-1 | Ar-1 | Ar-5 |
| Ar-3 | Ar-1 | Ar-1 | Ar-6 |
| Ar-3 | Ar-1 | Ar-2 | Ar-3 |
| Ar-3 | Ar-1 | Ar-2 | Ar-4 |
| Ar-3 | Ar-1 | Ar-2 | Ar-5 |
| Ar-3 | Ar-1 | Ar-2 | Ar-6 |
| Ar-3 | Ar-1 | Ar-3 | Ar-3 |
| Ar-3 | Ar-1 | Ar-3 | Ar-4 |
| Ar-3 | Ar-1 | Ar-3 | Ar-5 |
| Ar-3 | Ar-1 | Ar-3 | Ar-6 |
| Ar-3 | Ar-1 | Ar-4 | Ar-3 |
| Ar-3 | Ar-1 | Ar-4 | Ar-4 |
| Ar-3 | Ar-1 | Ar-4 | Ar-5 |
| Ar-3 | Ar-1 | Ar-4 | Ar-6 |
| Ar-3 | Ar-1 | Ar-5 | Ar-3 |
| Ar-3 | Ar-1 | Ar-5 | Ar-4 |
| Ar-3 | Ar-1 | Ar-5 | Ar-5 |
| Ar-3 | Ar-1 | Ar-5 | Ar-6 |
| Ar-3 | Ar-1 | Ar-6 | Ar-3 |
| Ar-3 | Ar-1 | Ar-6 | Ar-4 |
| Ar-3 | Ar-1 | Ar-6 | Ar-5 |
| Ar-3 | Ar-1 | Ar-6 | Ar-6 |
| Ar-3 | Ar-2 | Ar-1 | Ar-4 |
| Ar-3 | Ar-2 | Ar-1 | Ar-5 |

TABLE 14

| R1 | R3 | R4 | R6 |
|---|---|---|---|
| Ar-3 | Ar-2 | Ar-1 | Ar-6 |
| Ar-3 | Ar-2 | Ar-2 | Ar-3 |
| Ar-3 | Ar-2 | Ar-2 | Ar-4 |
| Ar-3 | Ar-2 | Ar-2 | Ar-5 |
| Ar-3 | Ar-2 | Ar-2 | Ar-6 |
| Ar-3 | Ar-2 | Ar-3 | Ar-3 |
| Ar-3 | Ar-2 | Ar-3 | Ar-4 |
| Ar-3 | Ar-2 | Ar-3 | Ar-5 |
| Ar-3 | Ar-2 | Ar-3 | Ar-6 |
| Ar-3 | Ar-2 | Ar-4 | Ar-3 |
| Ar-3 | Ar-2 | Ar-4 | Ar-4 |
| Ar-3 | Ar-2 | Ar-4 | Ar-5 |
| Ar-3 | Ar-2 | Ar-4 | Ar-6 |
| Ar-3 | Ar-2 | Ar-5 | Ar-3 |
| Ar-3 | Ar-2 | Ar-5 | Ar-4 |
| Ar-3 | Ar-2 | Ar-5 | Ar-5 |
| Ar-3 | Ar-2 | Ar-5 | Ar-6 |
| Ar-3 | Ar-2 | Ar-6 | Ar-3 |
| Ar-3 | Ar-2 | Ar-6 | Ar-4 |
| Ar-3 | Ar-2 | Ar-6 | Ar-5 |
| Ar-3 | Ar-2 | Ar-6 | Ar-6 |
| Ar-3 | Ar-3 | Ar-1 | Ar-4 |
| Ar-3 | Ar-3 | Ar-1 | Ar-5 |
| Ar-3 | Ar-3 | Ar-1 | Ar-6 |
| Ar-3 | Ar-3 | Ar-2 | Ar-4 |
| Ar-3 | Ar-3 | Ar-2 | Ar-5 |
| Ar-3 | Ar-3 | Ar-2 | Ar-6 |
| Ar-3 | Ar-3 | Ar-3 | Ar-3 |
| Ar-3 | Ar-3 | Ar-3 | Ar-4 |
| Ar-3 | Ar-3 | Ar-3 | Ar-5 |

TABLE 15

| R1 | R3 | R4 | R6 |
|---|---|---|---|
| Ar-3 | Ar-3 | Ar-3 | Ar-6 |
| Ar-3 | Ar-3 | Ar-4 | Ar-3 |
| Ar-3 | Ar-3 | Ar-4 | Ar-4 |
| Ar-3 | Ar-3 | Ar-4 | Ar-5 |
| Ar-3 | Ar-3 | Ar-4 | Ar-6 |
| Ar-3 | Ar-3 | Ar-5 | Ar-3 |
| Ar-3 | Ar-3 | Ar-5 | Ar-4 |
| Ar-3 | Ar-3 | Ar-5 | Ar-5 |
| Ar-3 | Ar-3 | Ar-5 | Ar-6 |
| Ar-3 | Ar-3 | Ar-6 | Ar-3 |
| Ar-3 | Ar-3 | Ar-6 | Ar-4 |
| Ar-3 | Ar-3 | Ar-6 | Ar-5 |
| Ar-3 | Ar-3 | Ar-6 | Ar-6 |
| Ar-3 | Ar-4 | Ar-1 | Ar-4 |
| Ar-3 | Ar-4 | Ar-1 | Ar-5 |
| Ar-3 | Ar-4 | Ar-1 | Ar-6 |
| Ar-3 | Ar-4 | Ar-2 | Ar-4 |
| Ar-3 | Ar-4 | Ar-2 | Ar-5 |
| Ar-3 | Ar-4 | Ar-2 | Ar-6 |
| Ar-3 | Ar-4 | Ar-3 | Ar-4 |
| Ar-3 | Ar-4 | Ar-3 | Ar-5 |
| Ar-3 | Ar-4 | Ar-3 | Ar-6 |
| Ar-3 | Ar-4 | Ar-4 | Ar-3 |
| Ar-3 | Ar-4 | Ar-4 | Ar-4 |
| Ar-3 | Ar-4 | Ar-4 | Ar-5 |
| Ar-3 | Ar-4 | Ar-4 | Ar-6 |
| Ar-3 | Ar-4 | Ar-5 | Ar-3 |
| Ar-3 | Ar-4 | Ar-5 | Ar-4 |
| Ar-3 | Ar-4 | Ar-5 | Ar-5 |
| Ar-3 | Ar-4 | Ar-5 | Ar-6 |

TABLE 16

| R1 | R3 | R4 | R6 |
|---|---|---|---|
| Ar-3 | Ar-4 | Ar-6 | Ar-3 |
| Ar-3 | Ar-4 | Ar-6 | Ar-4 |
| Ar-3 | Ar-4 | Ar-6 | Ar-5 |
| Ar-3 | Ar-4 | Ar-6 | Ar-6 |
| Ar-3 | Ar-5 | Ar-1 | Ar-4 |
| Ar-3 | Ar-5 | Ar-1 | Ar-5 |
| Ar-3 | Ar-5 | Ar-1 | Ar-6 |
| Ar-3 | Ar-5 | Ar-2 | Ar-4 |
| Ar-3 | Ar-5 | Ar-2 | Ar-5 |
| Ar-3 | Ar-5 | Ar-2 | Ar-6 |
| Ar-3 | Ar-5 | Ar-3 | Ar-4 |
| Ar-3 | Ar-5 | Ar-3 | Ar-5 |
| Ar-3 | Ar-5 | Ar-3 | Ar-6 |
| Ar-3 | Ar-5 | Ar-4 | Ar-4 |
| Ar-3 | Ar-5 | Ar-4 | Ar-5 |
| Ar-3 | Ar-5 | Ar-4 | Ar-6 |
| Ar-3 | Ar-5 | Ar-5 | Ar-3 |
| Ar-3 | Ar-5 | Ar-5 | Ar-4 |
| Ar-3 | Ar-5 | Ar-5 | Ar-5 |
| Ar-3 | Ar-5 | Ar-5 | Ar-6 |
| Ar-3 | Ar-5 | Ar-6 | Ar-3 |
| Ar-3 | Ar-5 | Ar-6 | Ar-4 |
| Ar-3 | Ar-5 | Ar-6 | Ar-5 |
| Ar-3 | Ar-5 | Ar-6 | Ar-6 |
| Ar-3 | Ar-6 | Ar-1 | Ar-4 |
| Ar-3 | Ar-6 | Ar-1 | Ar-5 |
| Ar-3 | Ar-6 | Ar-1 | Ar-6 |
| Ar-3 | Ar-6 | Ar-2 | Ar-4 |
| Ar-3 | Ar-6 | Ar-2 | Ar-5 |
| Ar-3 | Ar-6 | Ar-2 | Ar-6 |

TABLE 17

| R1 | R3 | R4 | R6 |
|---|---|---|---|
| Ar-3 | Ar-6 | Ar-3 | Ar-4 |
| Ar-3 | Ar-6 | Ar-3 | Ar-5 |
| Ar-3 | Ar-6 | Ar-3 | Ar-6 |
| Ar-3 | Ar-6 | Ar-4 | Ar-4 |
| Ar-3 | Ar-6 | Ar-4 | Ar-5 |
| Ar-3 | Ar-6 | Ar-4 | Ar-6 |
| Ar-3 | Ar-6 | Ar-5 | Ar-4 |
| Ar-3 | Ar-6 | Ar-5 | Ar-5 |
| Ar-3 | Ar-6 | Ar-5 | Ar-6 |
| Ar-3 | Ar-6 | Ar-6 | Ar-3 |
| Ar-3 | Ar-6 | Ar-6 | Ar-4 |
| Ar-3 | Ar-6 | Ar-6 | Ar-5 |
| Ar-3 | Ar-6 | Ar-6 | Ar-6 |
| Ar-4 | Ar-1 | Ar-1 | Ar-4 |
| Ar-4 | Ar-1 | Ar-1 | Ar-5 |
| Ar-4 | Ar-1 | Ar-1 | Ar-6 |
| Ar-4 | Ar-1 | Ar-2 | Ar-4 |
| Ar-4 | Ar-1 | Ar-2 | Ar-5 |
| Ar-4 | Ar-1 | Ar-2 | Ar-6 |
| Ar-4 | Ar-1 | Ar-3 | Ar-4 |
| Ar-4 | Ar-1 | Ar-3 | Ar-5 |
| Ar-4 | Ar-1 | Ar-3 | Ar-6 |
| Ar-4 | Ar-1 | Ar-4 | Ar-4 |
| Ar-4 | Ar-1 | Ar-4 | Ar-5 |
| Ar-4 | Ar-1 | Ar-4 | Ar-6 |
| Ar-4 | Ar-1 | Ar-5 | Ar-4 |
| Ar-4 | Ar-1 | Ar-5 | Ar-5 |
| Ar-4 | Ar-1 | Ar-5 | Ar-6 |
| Ar-4 | Ar-1 | Ar-6 | Ar-4 |
| Ar-4 | Ar-1 | Ar-6 | Ar-5 |
| Ar-4 | Ar-1 | Ar-6 | Ar-6 |

TABLE 18

| R1 | R3 | R4 | R6 |
|---|---|---|---|
| Ar-4 | Ar-2 | Ar-1 | Ar-5 |
| Ar-4 | Ar-2 | Ar-1 | Ar-6 |
| Ar-4 | Ar-2 | Ar-2 | Ar-4 |
| Ar-4 | Ar-2 | Ar-2 | Ar-5 |
| Ar-4 | Ar-2 | Ar-2 | Ar-6 |
| Ar-4 | Ar-2 | Ar-3 | Ar-4 |
| Ar-4 | Ar-2 | Ar-3 | Ar-5 |
| Ar-4 | Ar-2 | Ar-3 | Ar-6 |
| Ar-4 | Ar-2 | Ar-4 | Ar-4 |
| Ar-4 | Ar-2 | Ar-4 | Ar-5 |
| Ar-4 | Ar-2 | Ar-4 | Ar-6 |
| Ar-4 | Ar-2 | Ar-5 | Ar-4 |
| Ar-4 | Ar-2 | Ar-5 | Ar-5 |
| Ar-4 | Ar-2 | Ar-5 | Ar-6 |
| Ar-4 | Ar-2 | Ar-6 | Ar-4 |
| Ar-4 | Ar-2 | Ar-6 | Ar-5 |
| Ar-4 | Ar-2 | Ar-6 | Ar-6 |
| Ar-4 | Ar-3 | Ar-1 | Ar-5 |
| Ar-4 | Ar-3 | Ar-1 | Ar-6 |
| Ar-4 | Ar-3 | Ar-2 | Ar-5 |
| Ar-4 | Ar-3 | Ar-2 | Ar-6 |
| Ar-4 | Ar-3 | Ar-3 | Ar-4 |
| Ar-4 | Ar-3 | Ar-3 | Ar-5 |
| Ar-4 | Ar-3 | Ar-3 | Ar-6 |
| Ar-4 | Ar-3 | Ar-4 | Ar-4 |
| Ar-4 | Ar-3 | Ar-4 | Ar-5 |
| Ar-4 | Ar-3 | Ar-4 | Ar-6 |
| Ar-4 | Ar-3 | Ar-5 | Ar-4 |
| Ar-4 | Ar-3 | Ar-5 | Ar-5 |
| Ar-4 | Ar-3 | Ar-5 | Ar-6 |

TABLE 19

| R1 | R3 | R4 | R6 |
|---|---|---|---|
| Ar-4 | Ar-3 | Ar-6 | Ar-4 |
| Ar-4 | Ar-3 | Ar-6 | Ar-5 |
| Ar-4 | Ar-3 | Ar-6 | Ar-6 |
| Ar-4 | Ar-4 | Ar-1 | Ar-5 |
| Ar-4 | Ar-4 | Ar-1 | Ar-6 |
| Ar-4 | Ar-4 | Ar-2 | Ar-5 |
| Ar-4 | Ar-4 | Ar-2 | Ar-6 |
| Ar-4 | Ar-4 | Ar-3 | Ar-5 |
| Ar-4 | Ar-4 | Ar-3 | Ar-6 |
| Ar-4 | Ar-4 | Ar-4 | Ar-4 |
| Ar-4 | Ar-4 | Ar-4 | Ar-5 |
| Ar-4 | Ar-4 | Ar-4 | Ar-6 |
| Ar-4 | Ar-4 | Ar-5 | Ar-4 |
| Ar-4 | Ar-4 | Ar-5 | Ar-5 |
| Ar-4 | Ar-4 | Ar-5 | Ar-6 |
| Ar-4 | Ar-4 | Ar-6 | Ar-4 |
| Ar-4 | Ar-4 | Ar-6 | Ar-5 |
| Ar-4 | Ar-4 | Ar-6 | Ar-6 |
| Ar-4 | Ar-5 | Ar-1 | Ar-5 |
| Ar-4 | Ar-5 | Ar-1 | Ar-6 |
| Ar-4 | Ar-5 | Ar-2 | Ar-5 |
| Ar-4 | Ar-5 | Ar-2 | Ar-6 |
| Ar-4 | Ar-5 | Ar-3 | Ar-5 |
| Ar-4 | Ar-5 | Ar-3 | Ar-6 |
| Ar-4 | Ar-5 | Ar-4 | Ar-5 |
| Ar-4 | Ar-5 | Ar-4 | Ar-6 |
| Ar-4 | Ar-5 | Ar-5 | Ar-4 |
| Ar-4 | Ar-5 | Ar-5 | Ar-5 |
| Ar-4 | Ar-5 | Ar-5 | Ar-6 |
| Ar-4 | Ar-5 | Ar-6 | Ar-4 |
| Ar-4 | Ar-5 | Ar-6 | Ar-5 |

TABLE 20

| R1 | R3 | R4 | R6 |
|---|---|---|---|
| Ar-4 | Ar-5 | Ar-6 | Ar-6 |
| Ar-4 | Ar-6 | Ar-1 | Ar-5 |
| Ar-4 | Ar-6 | Ar-1 | Ar-6 |
| Ar-4 | Ar-6 | Ar-2 | Ar-5 |
| Ar-4 | Ar-6 | Ar-2 | Ar-6 |
| Ar-4 | Ar-6 | Ar-3 | Ar-5 |
| Ar-4 | Ar-6 | Ar-3 | Ar-6 |
| Ar-4 | Ar-6 | Ar-4 | Ar-5 |
| Ar-4 | Ar-6 | Ar-4 | Ar-6 |
| Ar-4 | Ar-6 | Ar-5 | Ar-5 |
| Ar-4 | Ar-6 | Ar-5 | Ar-6 |
| Ar-4 | Ar-6 | Ar-6 | Ar-4 |
| Ar-4 | Ar-6 | Ar-6 | Ar-5 |
| Ar-4 | Ar-6 | Ar-6 | Ar-6 |
| Ar-5 | Ar-1 | Ar-1 | Ar-5 |
| Ar-5 | Ar-1 | Ar-1 | Ar-6 |
| Ar-5 | Ar-1 | Ar-2 | Ar-5 |
| Ar-5 | Ar-1 | Ar-2 | Ar-6 |
| Ar-5 | Ar-1 | Ar-3 | Ar-5 |
| Ar-5 | Ar-1 | Ar-3 | Ar-6 |
| Ar-5 | Ar-1 | Ar-4 | Ar-5 |
| Ar-5 | Ar-1 | Ar-4 | Ar-6 |
| Ar-5 | Ar-1 | Ar-5 | Ar-5 |
| Ar-5 | Ar-1 | Ar-5 | Ar-6 |
| Ar-5 | Ar-1 | Ar-6 | Ar-5 |
| Ar-5 | Ar-1 | Ar-6 | Ar-6 |
| Ar-5 | Ar-2 | Ar-1 | Ar-6 |
| Ar-5 | Ar-2 | Ar-2 | Ar-5 |
| Ar-5 | Ar-2 | Ar-2 | Ar-6 |
| Ar-5 | Ar-2 | Ar-3 | Ar-5 |
| Ar-5 | Ar-2 | Ar-3 | Ar-6 |

TABLE 21

| R1 | R3 | R4 | R6 |
|---|---|---|---|
| Ar-5 | Ar-2 | Ar-4 | Ar-5 |
| Ar-5 | Ar-2 | Ar-4 | Ar-6 |
| Ar-5 | Ar-2 | Ar-5 | Ar-5 |
| Ar-5 | Ar-2 | Ar-5 | Ar-6 |
| Ar-5 | Ar-2 | Ar-6 | Ar-5 |
| Ar-5 | Ar-2 | Ar-6 | Ar-6 |
| Ar-5 | Ar-3 | Ar-1 | Ar-6 |
| Ar-5 | Ar-3 | Ar-2 | Ar-6 |
| Ar-5 | Ar-3 | Ar-3 | Ar-5 |
| Ar-5 | Ar-3 | Ar-3 | Ar-6 |
| Ar-5 | Ar-3 | Ar-4 | Ar-5 |
| Ar-5 | Ar-3 | Ar-4 | Ar-6 |
| Ar-5 | Ar-3 | Ar-5 | Ar-5 |
| Ar-5 | Ar-3 | Ar-5 | Ar-6 |
| Ar-5 | Ar-3 | Ar-6 | Ar-5 |
| Ar-5 | Ar-3 | Ar-6 | Ar-6 |
| Ar-5 | Ar-4 | Ar-1 | Ar-6 |
| Ar-5 | Ar-4 | Ar-2 | Ar-6 |
| Ar-5 | Ar-4 | Ar-3 | Ar-6 |
| Ar-5 | Ar-4 | Ar-4 | Ar-5 |
| Ar-5 | Ar-4 | Ar-4 | Ar-6 |
| Ar-5 | Ar-4 | Ar-5 | Ar-5 |
| Ar-5 | Ar-4 | Ar-5 | Ar-6 |
| Ar-5 | Ar-4 | Ar-6 | Ar-5 |
| Ar-5 | Ar-4 | Ar-6 | Ar-6 |
| Ar-5 | Ar-5 | Ar-1 | Ar-6 |
| Ar-5 | Ar-5 | Ar-2 | Ar-6 |
| Ar-5 | Ar-5 | Ar-3 | Ar-6 |
| Ar-5 | Ar-5 | Ar-4 | Ar-6 |
| Ar-5 | Ar-5 | Ar-5 | Ar-5 |
| Ar-5 | Ar-5 | Ar-5 | Ar-6 |

TABLE 22

| R1 | R3 | R4 | R6 |
|---|---|---|---|
| Ar-5 | Ar-5 | Ar-6 | Ar-5 |
| Ar-5 | Ar-5 | Ar-6 | Ar-6 |
| Ar-5 | Ar-6 | Ar-1 | Ar-6 |
| Ar-5 | Ar-6 | Ar-2 | Ar-6 |
| Ar-5 | Ar-6 | Ar-3 | Ar-6 |
| Ar-5 | Ar-6 | Ar-4 | Ar-6 |
| Ar-5 | Ar-6 | Ar-5 | Ar-6 |
| Ar-5 | Ar-6 | Ar-6 | Ar-5 |
| Ar-5 | Ar-6 | Ar-6 | Ar-6 |
| Ar-6 | Ar-1 | Ar-1 | Ar-6 |
| Ar-6 | Ar-1 | Ar-2 | Ar-6 |
| Ar-6 | Ar-1 | Ar-3 | Ar-6 |
| Ar-6 | Ar-1 | Ar-4 | Ar-6 |
| Ar-6 | Ar-1 | Ar-5 | Ar-6 |
| Ar-6 | Ar-1 | Ar-6 | Ar-6 |
| Ar-6 | Ar-2 | Ar-2 | Ar-6 |
| Ar-6 | Ar-2 | Ar-3 | Ar-6 |
| Ar-6 | Ar-2 | Ar-4 | Ar-6 |
| Ar-6 | Ar-2 | Ar-5 | Ar-6 |
| Ar-6 | Ar-2 | Ar-6 | Ar-6 |
| Ar-6 | Ar-3 | Ar-3 | Ar-6 |
| Ar-6 | Ar-3 | Ar-4 | Ar-6 |
| Ar-6 | Ar-3 | Ar-5 | Ar-6 |
| Ar-6 | Ar-3 | Ar-6 | Ar-6 |
| Ar-6 | Ar-4 | Ar-4 | Ar-6 |
| Ar-6 | Ar-4 | Ar-5 | Ar-6 |
| Ar-6 | Ar-4 | Ar-6 | Ar-6 |
| Ar-6 | Ar-5 | Ar-5 | Ar-6 |
| Ar-6 | Ar-5 | Ar-6 | Ar-6 |
| Ar-6 | Ar-6 | Ar-6 | Ar-6 |

It is preferable that R² and R⁵ represent any one of a hydrogen atom, an alkyl group, a carbonyl group, an oxycarbonyl group, or an aryl group. Among these, from the viewpoint of thermal stability, a hydrogen atom or an alkyl group is preferable, and from the viewpoint that it is easy to obtain a narrow half-width in the emission spectrum, a hydrogen atom is more preferable.

It is preferable that R⁸ and R⁹ represent an alkyl group, an aryl group, a heteroaryl group, fluorine, a fluorine-containing alkyl group, a fluorine-containing heteroaryl group, or a fluorine-containing aryl group. In particular, since it is stable to the excitation light and a more excellent emission quantum yield is obtained, it is more preferable that R⁸ and R⁹ represent fluorine or a fluorine-containing aryl group. Furthermore, from the viewpoint of ease of synthesis, it is still more preferable that R⁸ and R⁹ represent fluorine.

The fluorine-containing aryl group is an aryl group containing fluorine, and examples thereof include a fluorophenyl group, a trifluoromethylphenyl group, and a pentafluorophenyl group. The fluorine-containing heteroaryl group is a heteroaryl group containing fluorine, and examples thereof include a fluoropyridyl group, a trifluoromethylpyridyl group, and a trifluoropyridyl group. The fluorine-containing alkyl group is an alkyl group containing fluorine, and examples thereof include a trifluoromethyl group and a pentafluoroethyl group.

In General Formula (1), from the viewpoint of photostability, it is preferable that X represents C-R⁷. In a case where X represents C-R⁷, the substituent R⁷ has a great influence on durability of the compound represented by General Formula (1), that is, decrease in light emission intensity of the compound over time. Specifically, in a case where R⁷ represents a hydrogen atom, since reactivity of this portion is high, moisture or oxygen in the air easily reacts with the portion. This may cause decomposition of the compound represented by General Formula (1). In addition, in a case where R⁷ represents a substituent having a high degree of freedom of molecular chain movement, such as an alkyl group, the reactivity is lowered, but the compounds aggregate with each other in the color conversion film over time, and as a result, concentration quenching may cause a decrease in light emission intensity. Therefore, it is preferable that R⁷ represents a group which is rigid, has a small degree of freedom of movement, and is unlikely to cause aggregation, and specifically, it is preferable either a substituted or unsubstituted aryl group or a substituted or unsubstituted heteroaryl group.

From the viewpoint of providing more excellent emission quantum yield, less thermal decomposition, and photostability, it is preferable that X represents C-R⁷ and R⁷ represents a substituted or unsubstituted aryl group. As the aryl group, from the viewpoint of not impairing a light emission wavelength, a phenyl group, a biphenyl group, a terphenyl group, a naphthyl group, a fluorenyl group, a phenanthryl group, or an anthracenyl group is preferable.

Further, in a case where the torsion is excessively large, in order to increase the photostability of the compound represented by General Formula (1), since the photostability decreases due to increased reactivity to the excitation light, it is preferable to moderately suppress torsion of the carbon-carbon bond between R⁷ and the pyrromethene skeleton. From the above-described viewpoint, R⁷ preferably represents a substituted or unsubstituted phenyl group, a substituted or unsubstituted biphenyl group, a substituted or unsubstituted terphenyl group, or a substituted or unsubstituted naphthyl group, and more preferably represents a substituted or unsubstituted phenyl group, a substituted or unsubstituted biphenyl group, or a substituted or unsubstituted terphenyl group. R⁷ particularly preferably represents a substituted or unsubstituted phenyl group.

In addition, R⁷ preferably represents an appropriately bulky substituent. Since R⁷ has a certain degree of bulkiness, the aggregation of molecules can be prevented, and as a result, the light emission efficiency and durability of the compound represented by General Formula (1) are further improved.

More preferred examples of the bulky substituent include a structure of R⁷ represented by General Formula (2).

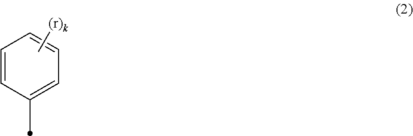

In General Formula (2), r is selected from the group consisting of a hydrogen atom, an alkyl group, a cycloalkyl group, a heterocyclic group, an alkenyl group, a cycloalkenyl group, an alkynyl group, a hydroxyl group, a thiol group, an alkoxy group, an alkylthio group, an arylether group, an arylthioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, or a phosphine oxide group. k is an integer of 1 to 3. In a case where k is 2 or more, r's may be the same or different from each other.

From the viewpoint of emission quantum yield, r preferably represents a substituted or unsubstituted aryl group. Among the above-described aryl groups, particularly preferred examples of the aryl group include a phenyl group or a naphthyl group. In a case where r represents an aryl group, k in General Formula (2) is preferably 1 or 2, and from the viewpoint of further preventing aggregation of molecules, more preferably 2. Further, in a case where k is 2 or more, it is preferable that at least one of r is substituted with an alkyl group. From the viewpoint of thermal stability, particularly preferred examples of the alkyl group include a methyl group, an ethyl group, and a tert-butyl group.

From the viewpoint of control of fluorescence wavelength and absorption wavelength, and compatibility with the solvent, r is preferably a substituted or unsubstituted alkyl group, a substituted or unsubstituted alkoxy group, or halogen, and more preferably a methyl group, an ethyl group, a tert-butyl group, or a methoxy group. From the viewpoint of dispersibility, a tert-butyl group or a methoxy group is particularly preferable. The fact that r represents a tert-butyl group or a methoxy group is also effective from the viewpoint of preventing quenching due to the aggregation of molecules.

In addition, as another aspect of the compound represented by General Formula (1), it is preferable that at least one of R¹ to R⁷ represents an electron-attracting group.

In particular, it is preferable that (1) at least one of R¹ to R⁶ represents an electron-attracting group, (2) R⁷ represents an electron-attracting group, or (3) at least one of R¹ to R⁶ represents an electron-attracting group and R⁷ represents an electron-attracting group. By introducing the electron-attracting group into the pyrromethene skeleton of the above-described compound, an electron density of the pyrromethene skeleton can be significantly reduced. Accordingly, the stability of the above-described compound with respect to oxygen is further improved, and as a result, the durability of the above-described compound can be further improved.

The electron-attracting group is also called as an electron-accepting group, and is an atomic group which attracts an electron from the substituted atomic group by an inductive effect or a resonance effect in organic electron theory. Examples of the electron-attracting group include groups having a positive value as the substituent constant (σp (para)) of Hammett's law. The substituent constant (σp (para)) of Hammett's law can be quoted from the 5th edition of the Basics of Chemistry Handbook (page 380 of II). In some cases, the phenyl group also takes a positive value as described above, but in the present disclosure, the electron-attracting group does not include the phenyl group.

Examples of the electron-attracting group include —F (σp: +0.06), —Cl (σp: +0.23), —Br (σp: +0.23),-I (σp: +0.18), —CO₂R¹² (σp: +0.45 in a case where R¹² is an ethyl group), —CONH₂ (σp: +0.38), —COR¹² (σp: +0.49 in a case where R¹² is a methyl group), —CF₃ (σp: +0.50), —SO₂R¹² (σp: +0.69 in a case where R¹² is a methyl group), and —NO₂ (σp: +0.81).

R¹²'s each independently represent a hydrogen atom, a substituted or unsubstituted aromatic hydrocarbon group having 6 to 30 ring-forming carbon atoms, a substituted or unsubstituted heterocyclic group having 5 to 30 ring-forming carbon atoms, a substituted or unsubstituted alkyl group having 1 to 30 carbon atoms, or a substituted or unsubstituted cycloalkyl group having 1 to 30 carbon atoms. Specific examples of each of these groups include the same examples as described above.

From the viewpoint of decomposability, preferred examples of the electron-attracting group include fluorine, a fluorine-containing aryl group, a fluorine-containing heteroaryl group, a fluorine-containing alkyl group, a substituted or unsubstituted acyl group, a substituted or unsubstituted ester group, a substituted or unsubstituted amide group, a substituted or unsubstituted sulfonyl group, and a cyano group.

More preferred examples of the electron-attracting group include a fluorine-containing alkyl group, a fluorine-containing aryl group, a substituted or unsubstituted acyl group, a substituted or unsubstituted ester group, and a cyano group.

According to the electron-attracting group described above, the concentration quenching can be prevented and the emission quantum yield can be improved. The electron-attracting group is particularly preferably a substituted or unsubstituted ester group.

Preferred examples of the compound represented by General Formula (1), which can be suitably used as the organic light-emitting material, include a case where all of R¹, R³, R⁴, and R⁶ each independently represent a substituted or unsubstituted alkyl group, X represents C-R⁷, and R⁷ represents the group represented by General Formula (2). In this case, it is particularly preferable that R⁷ represents the group represented by General Formula (2), in which r is a substituted or unsubstituted phenyl group.

Examples of the compound represented by General Formula (1) are shown below, but the compound is not limited thereto.

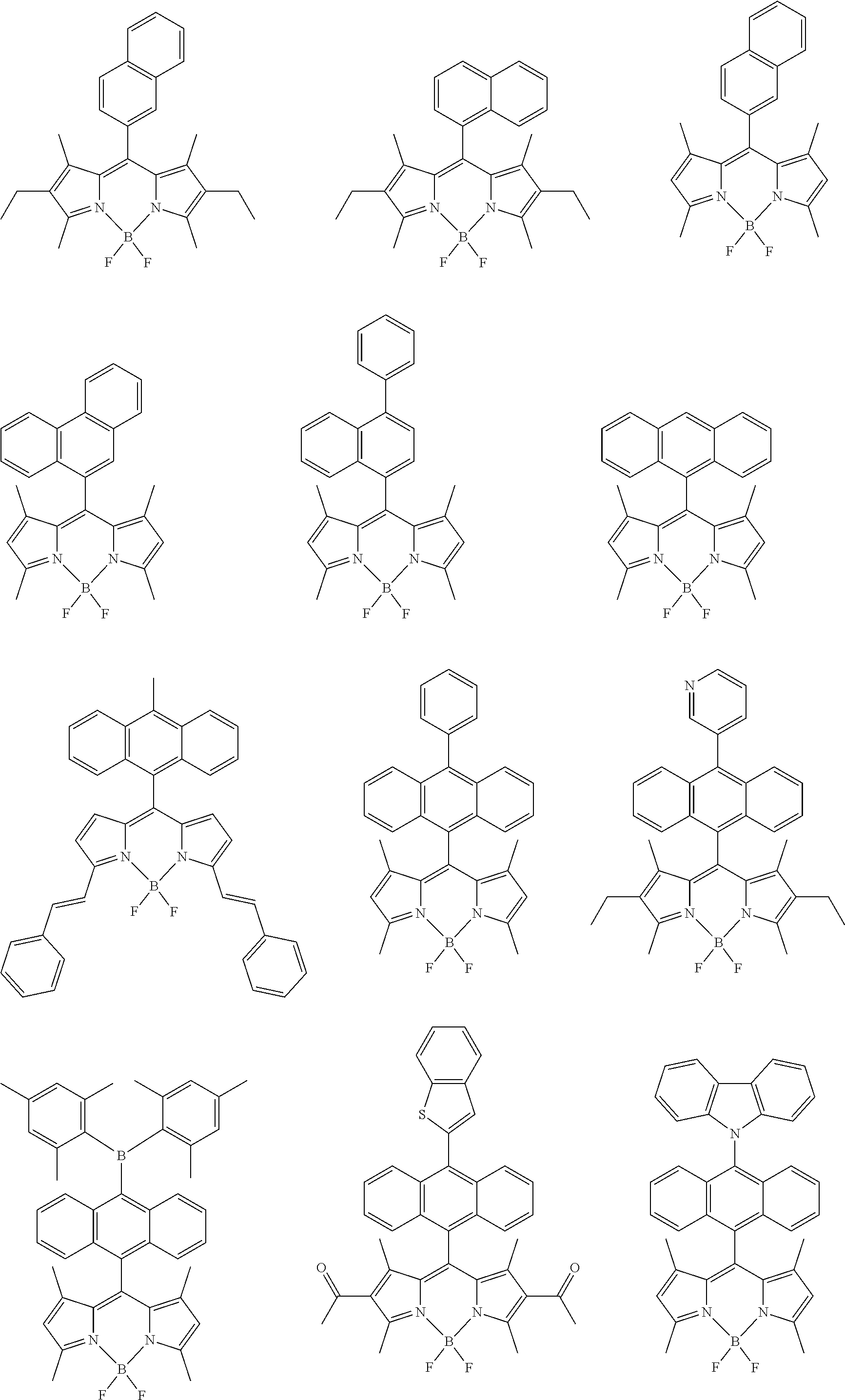

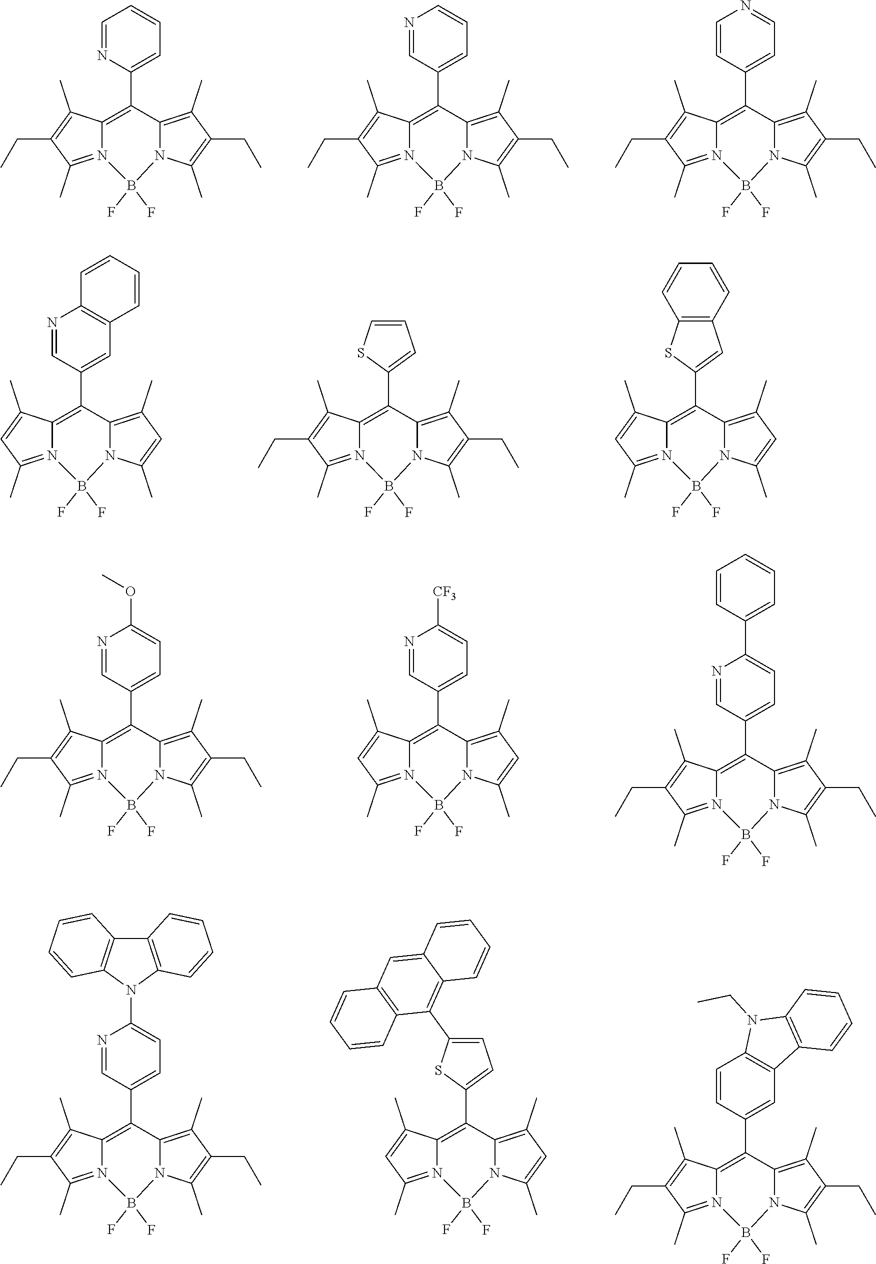

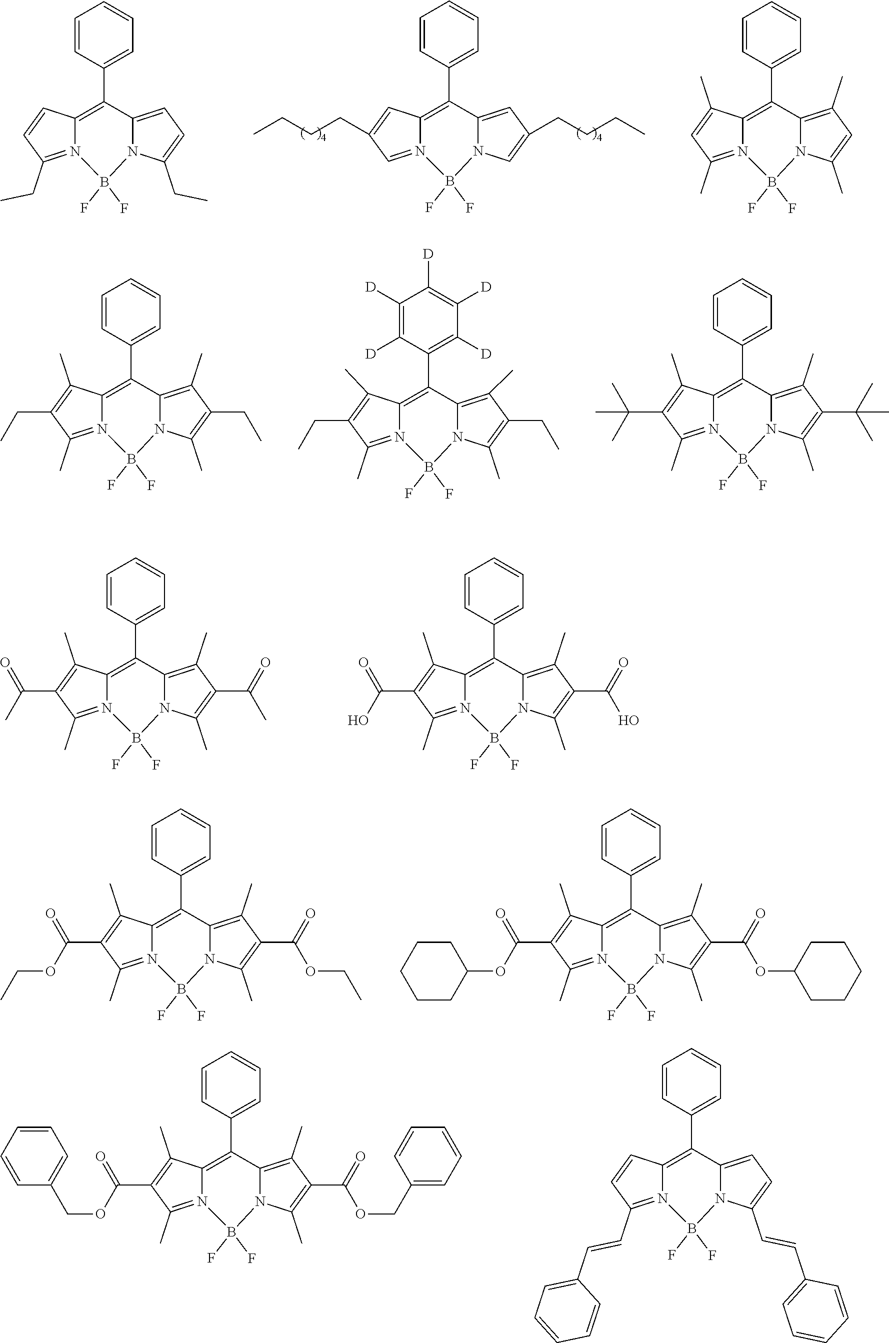

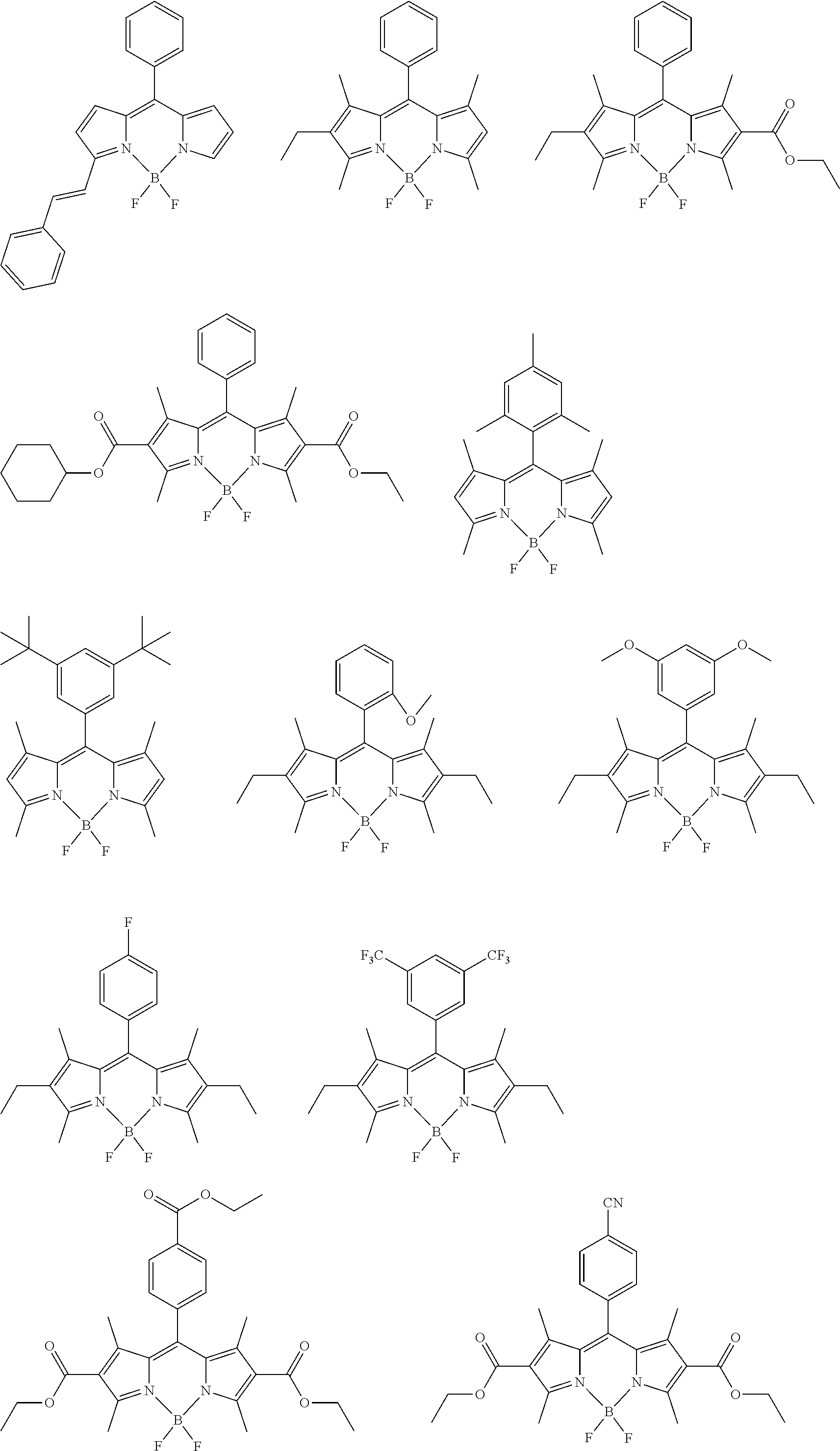

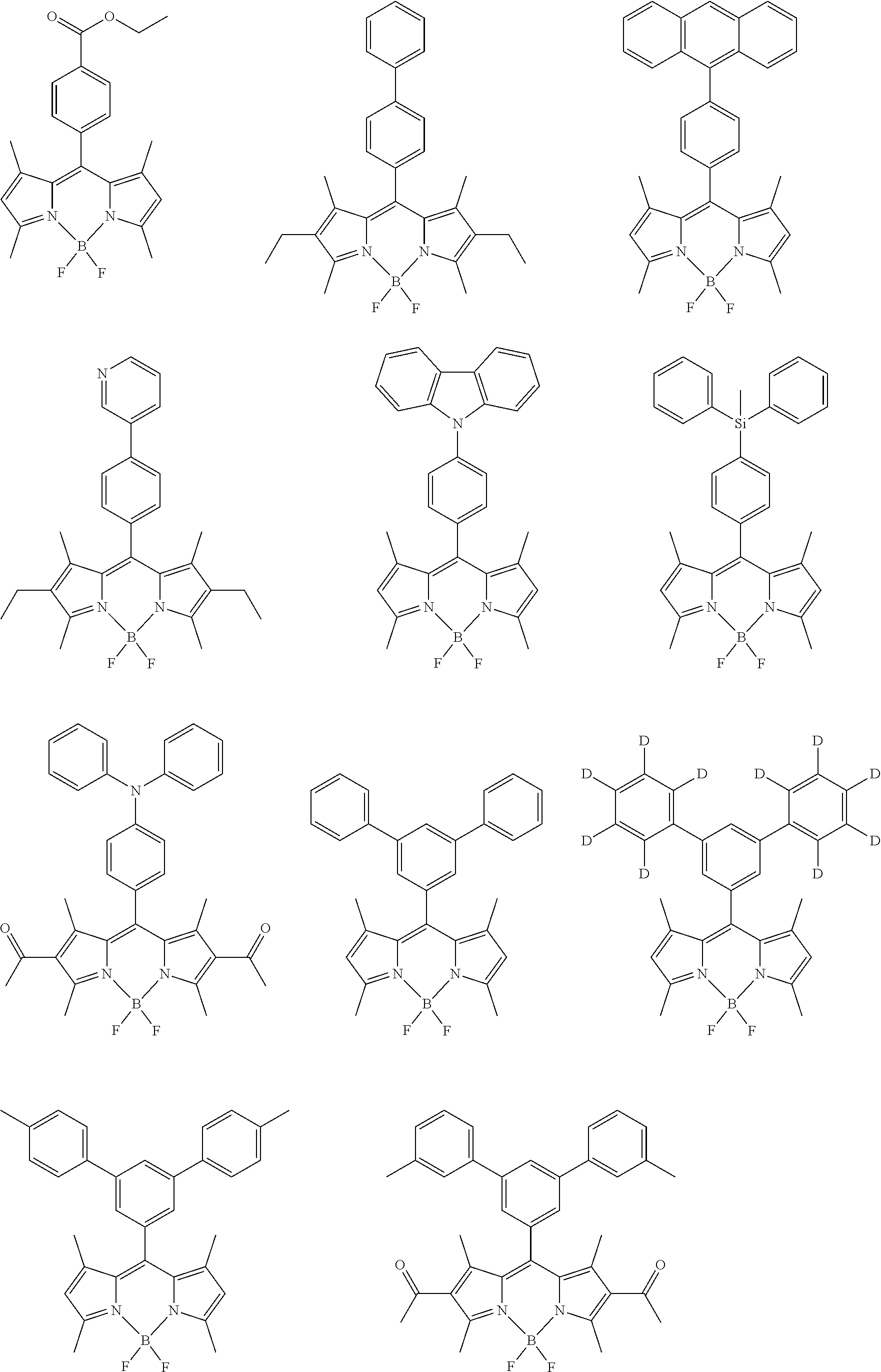

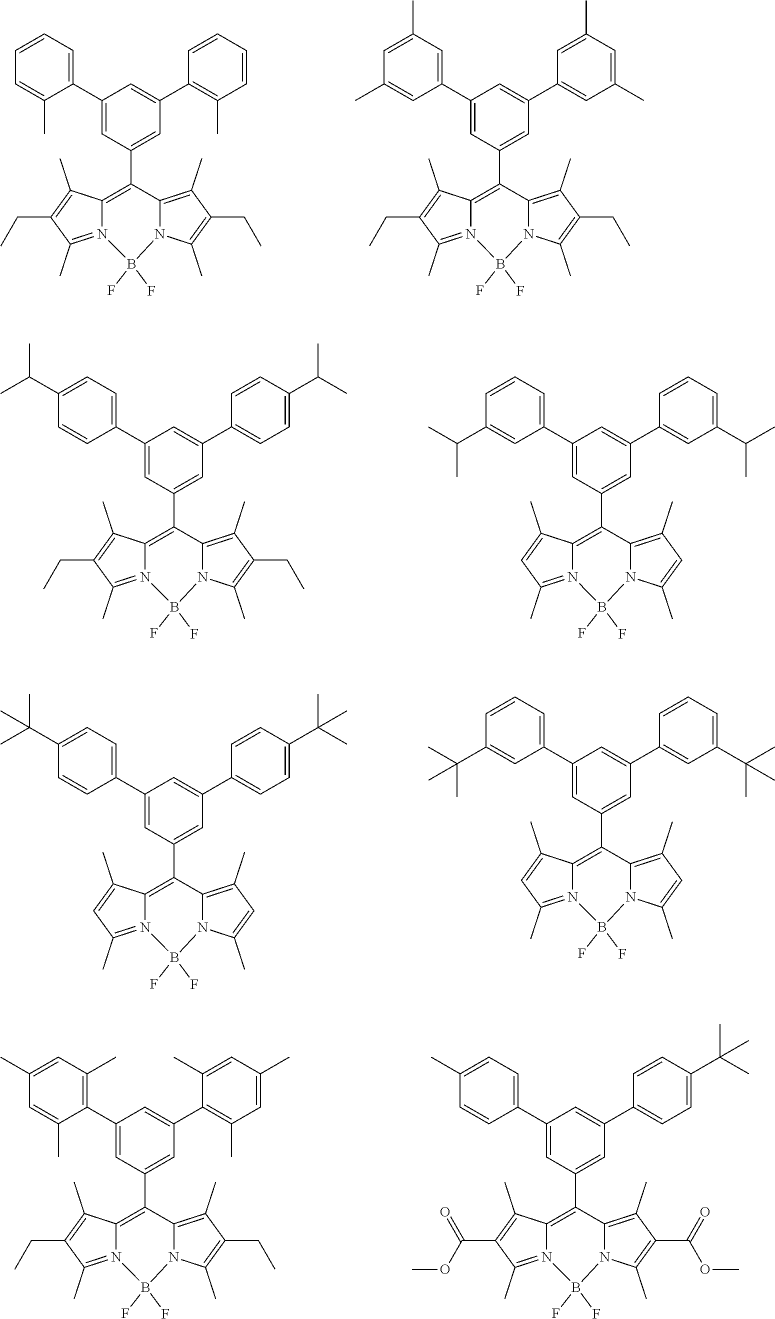

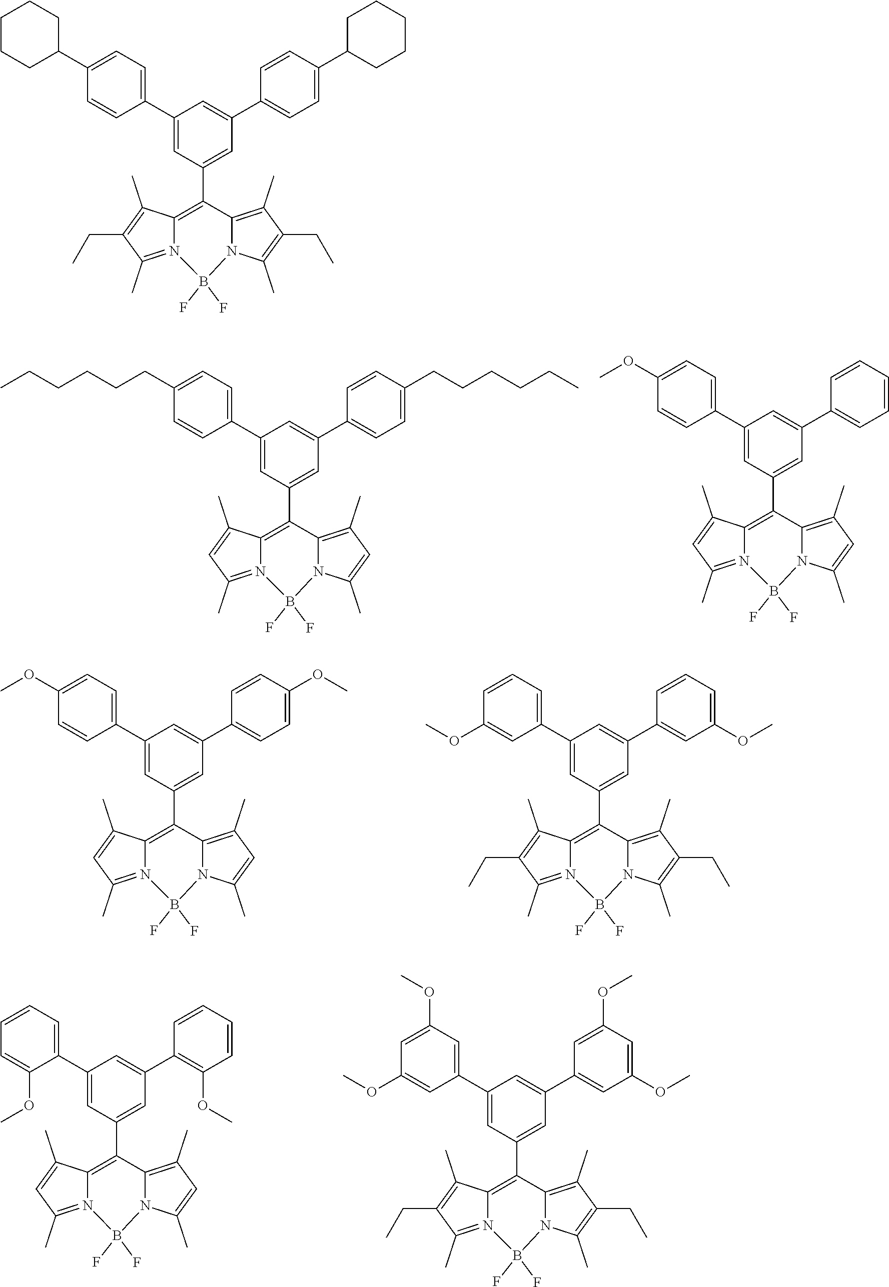

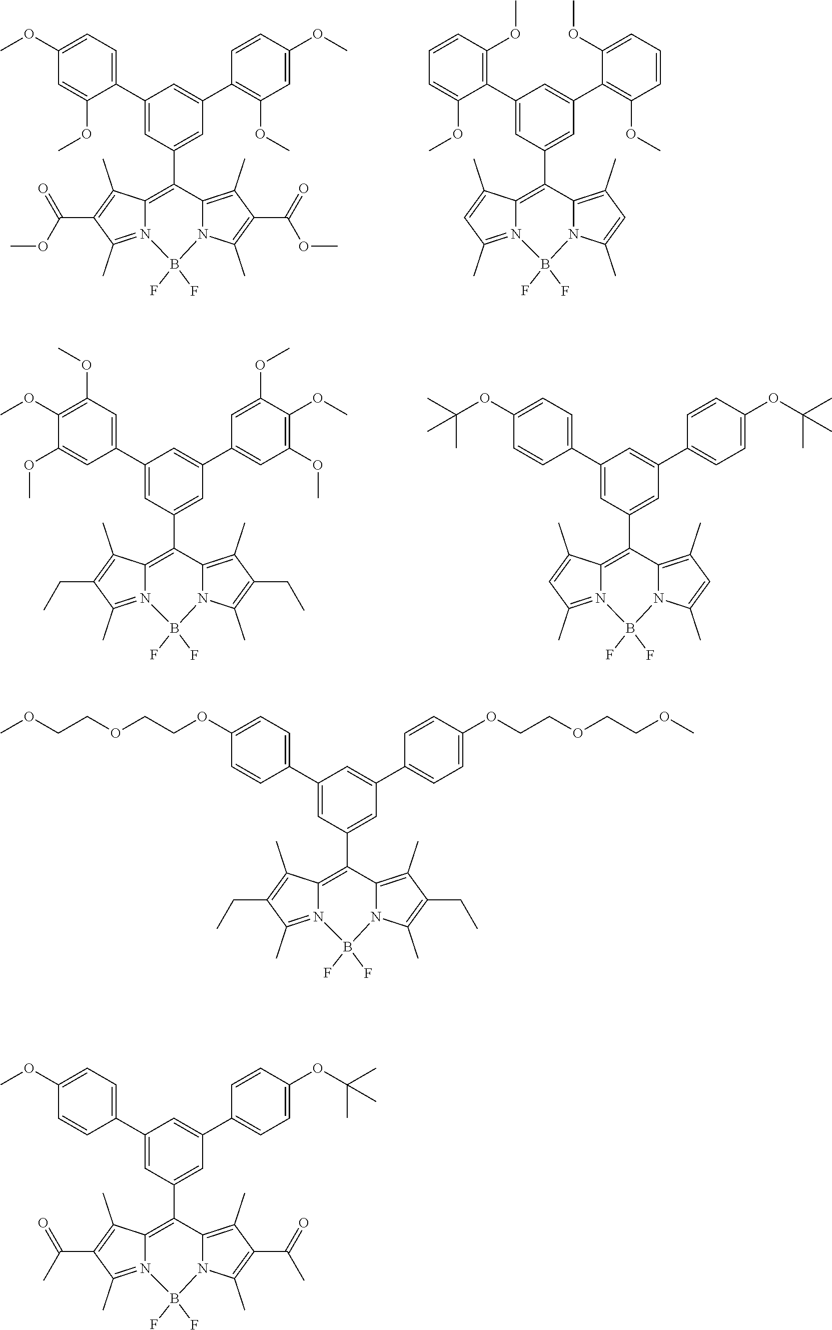

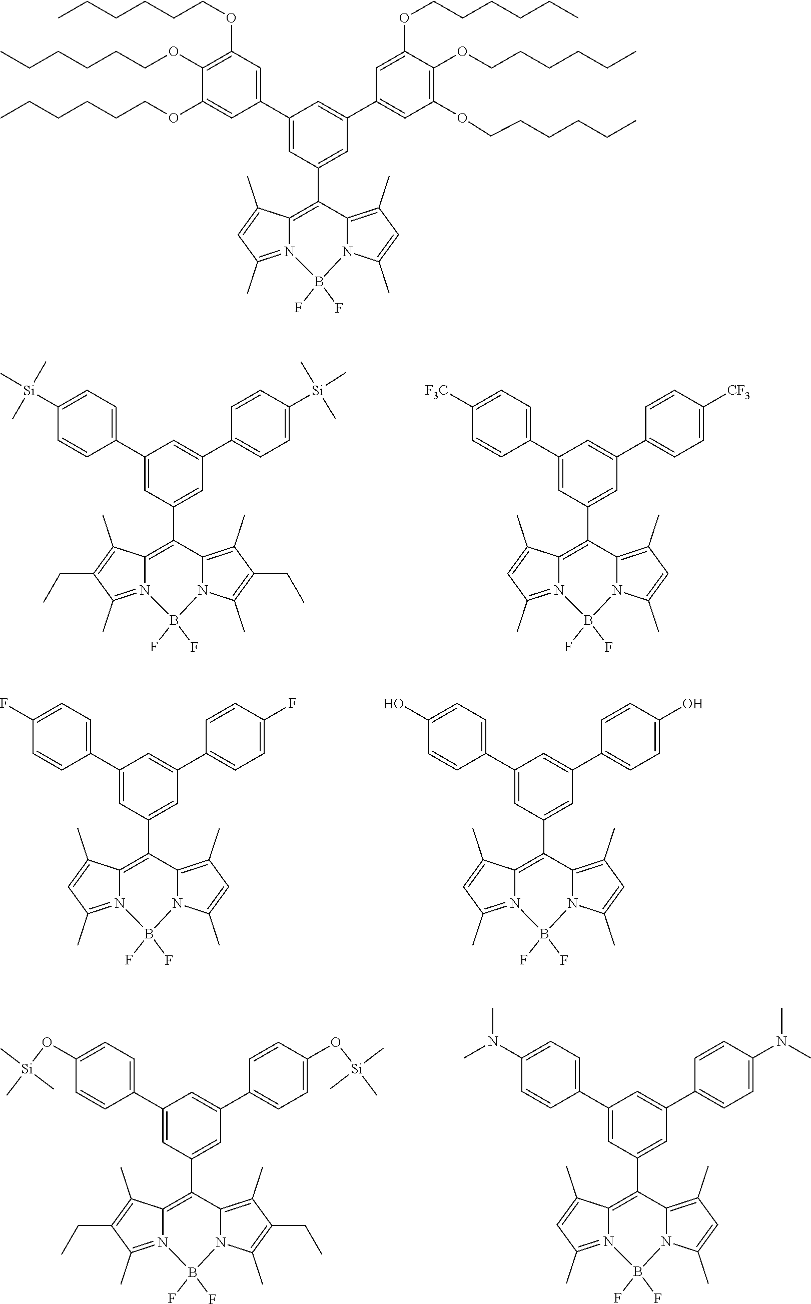

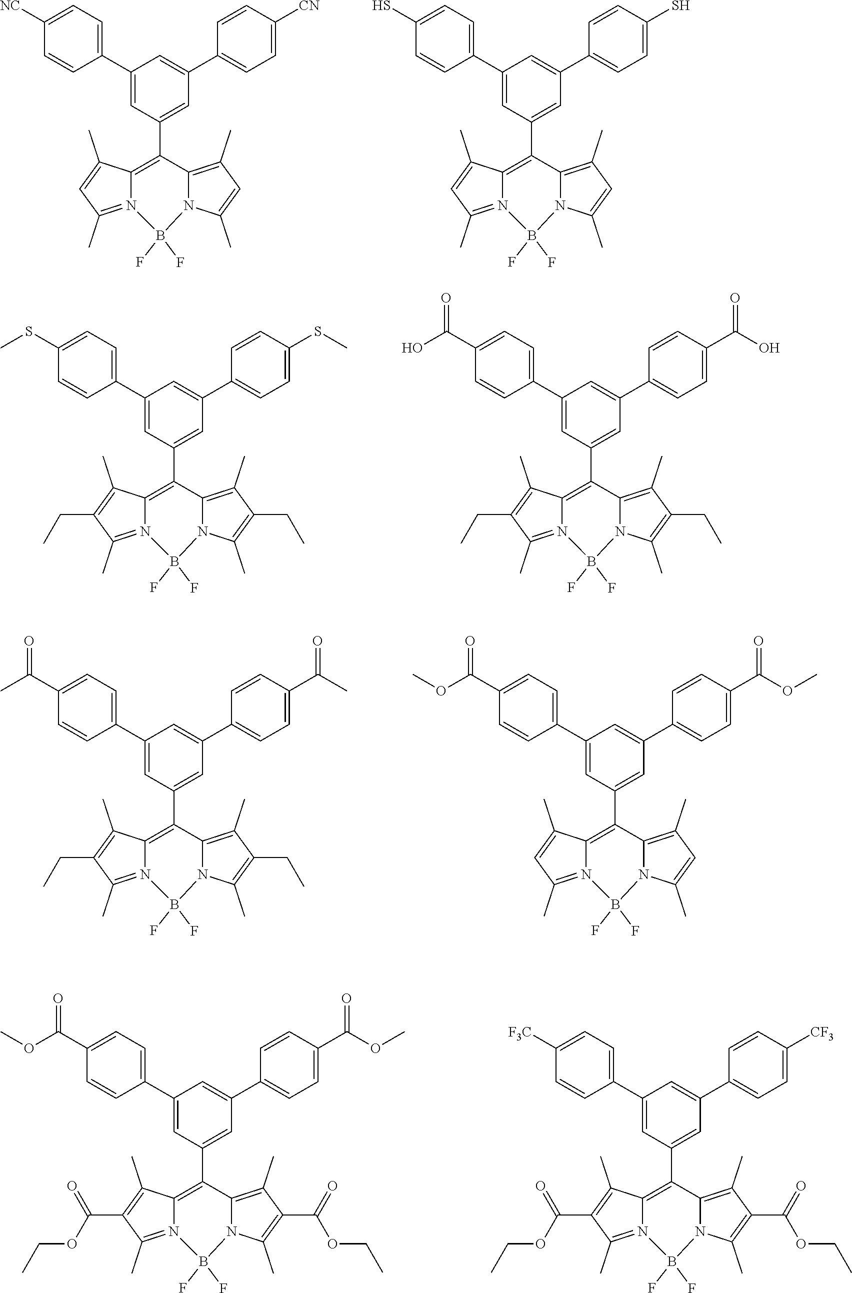

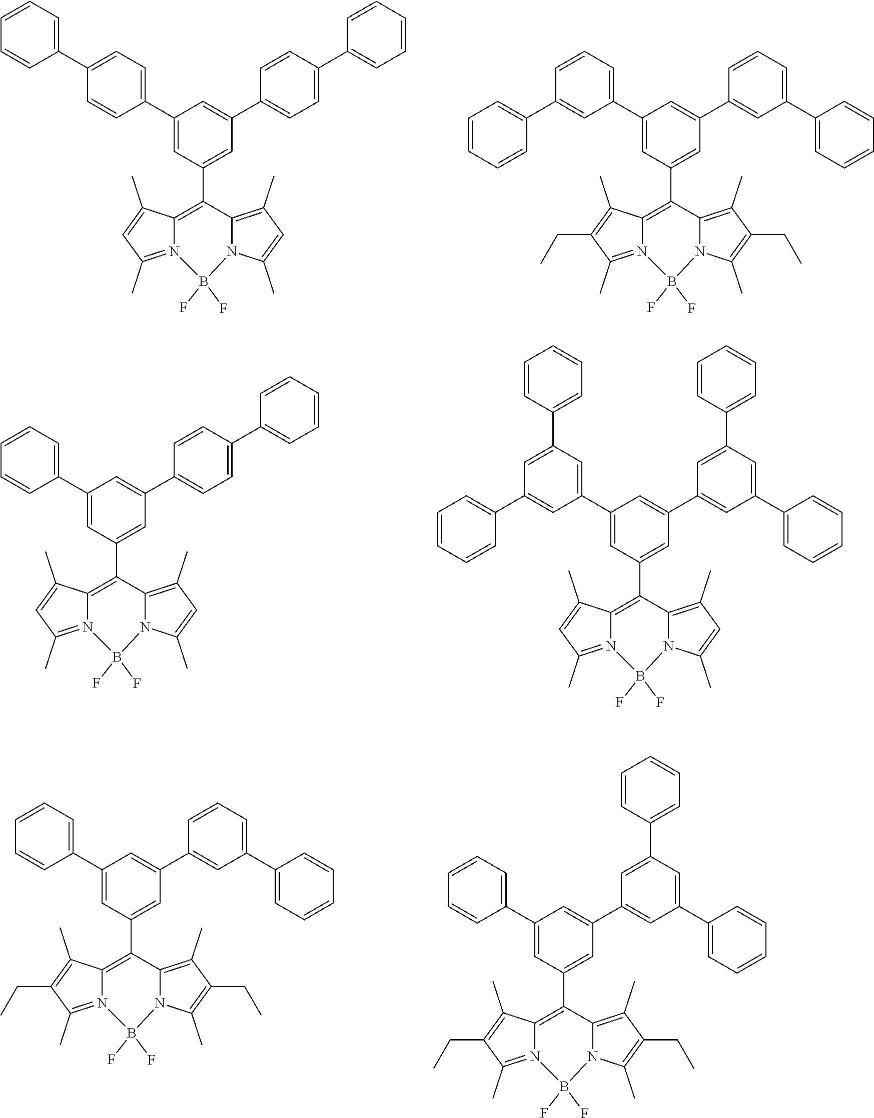

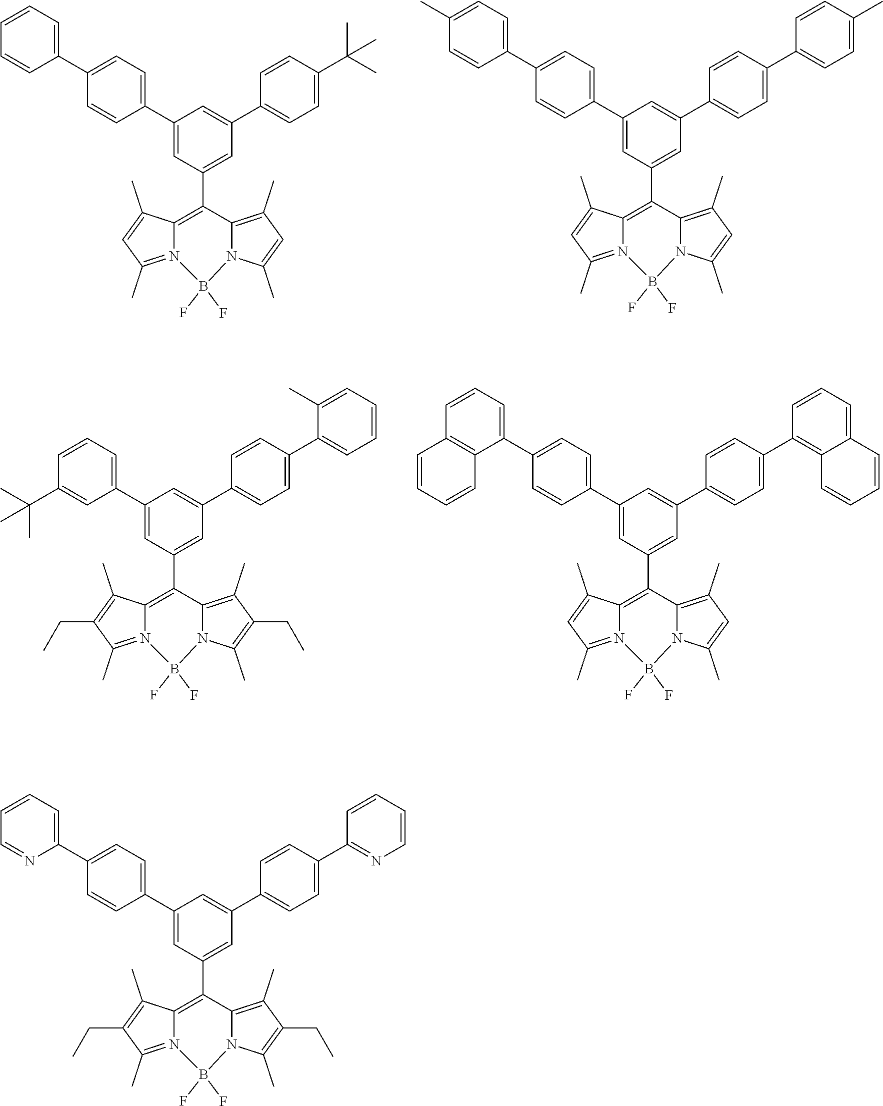

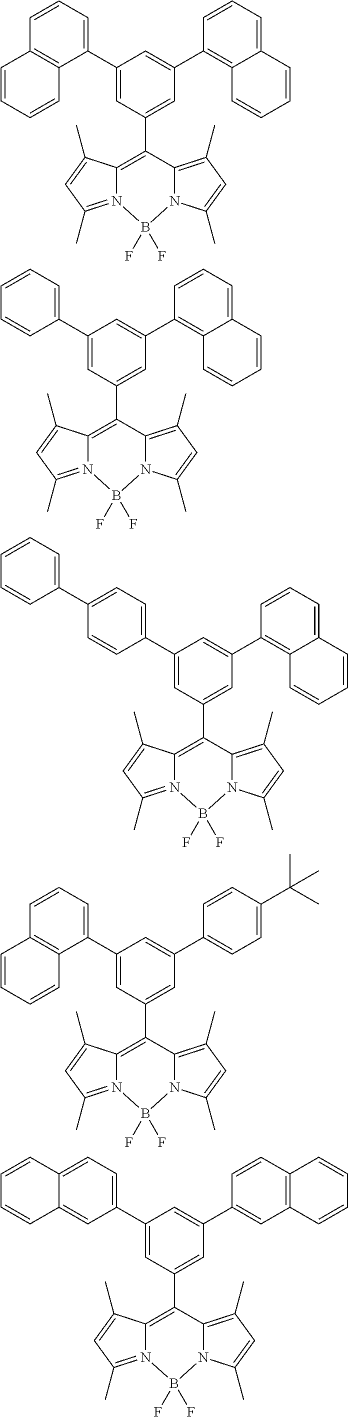

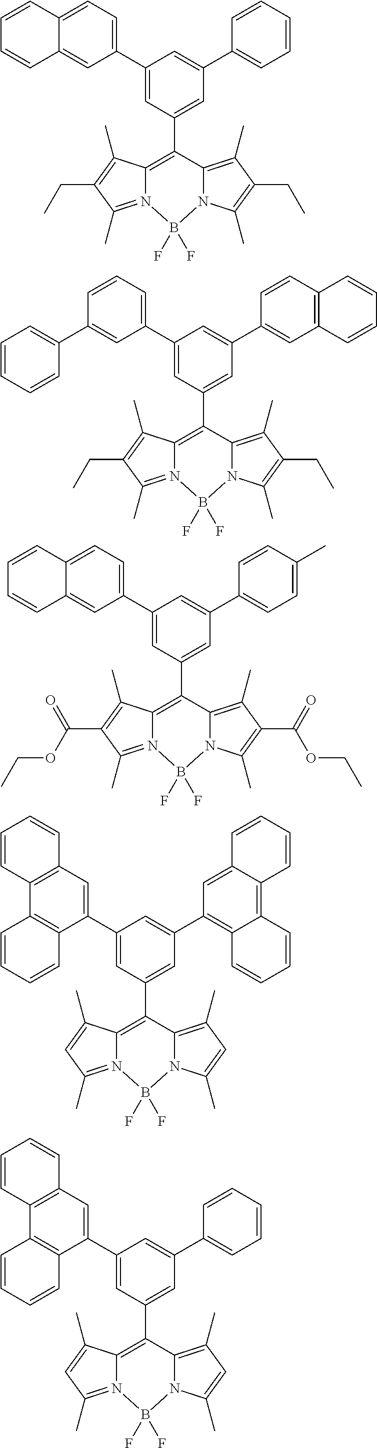

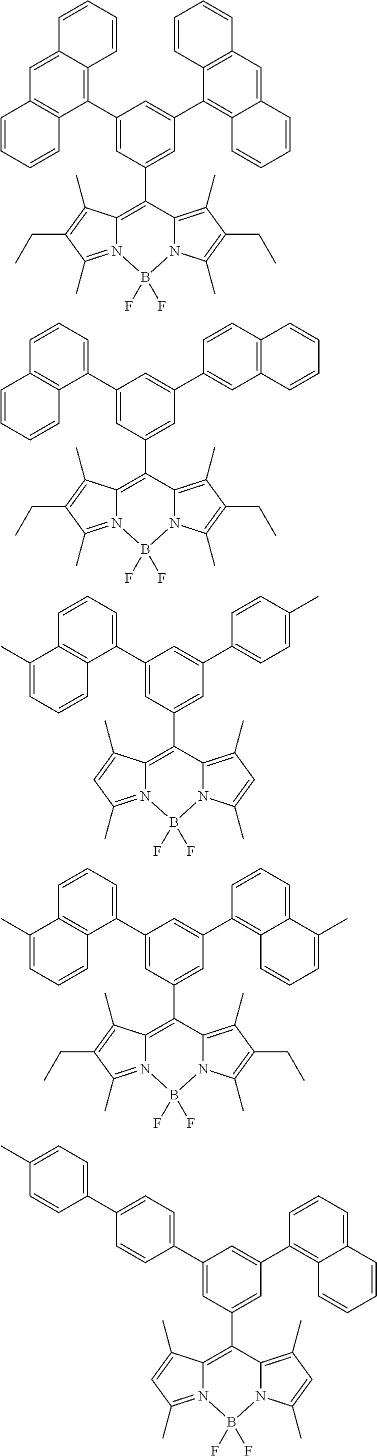

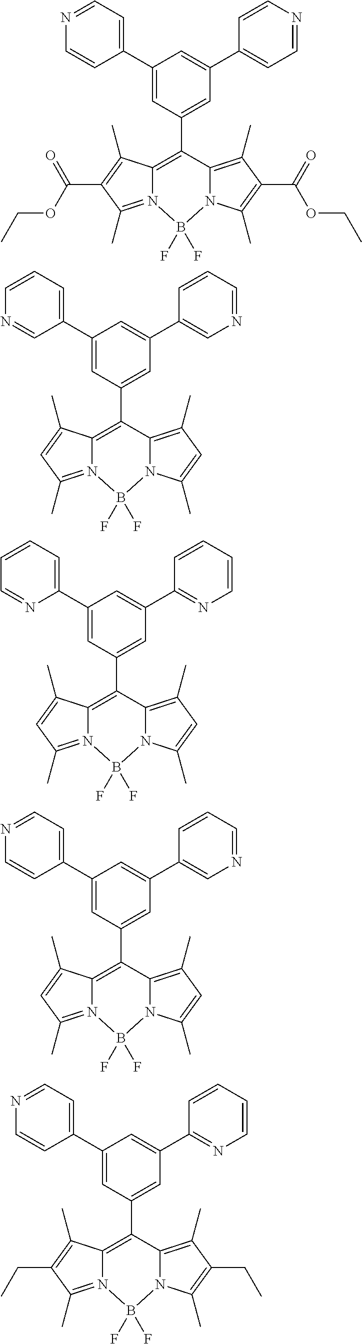

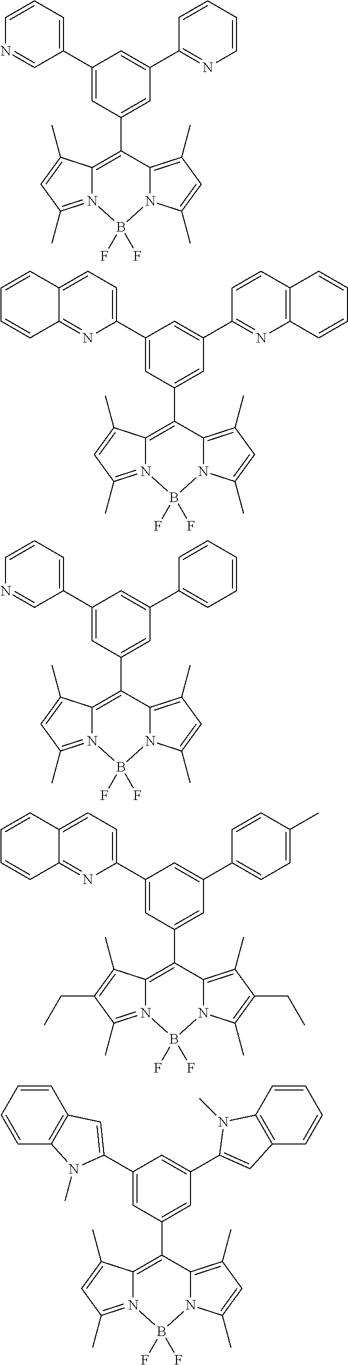

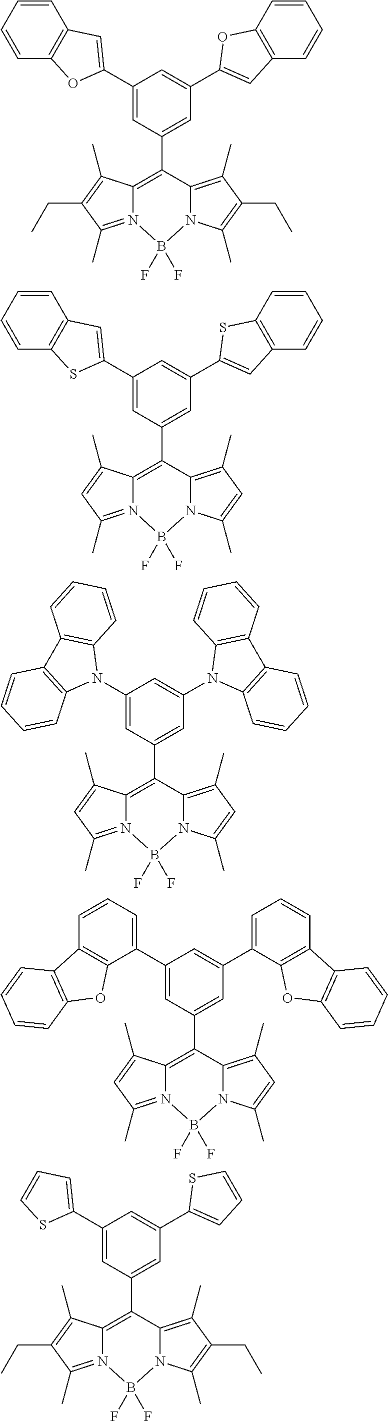

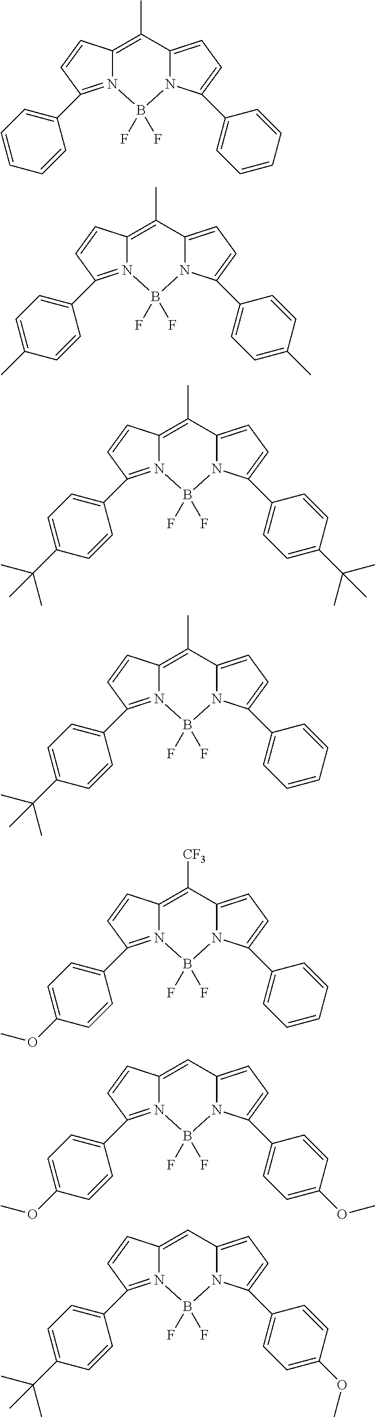

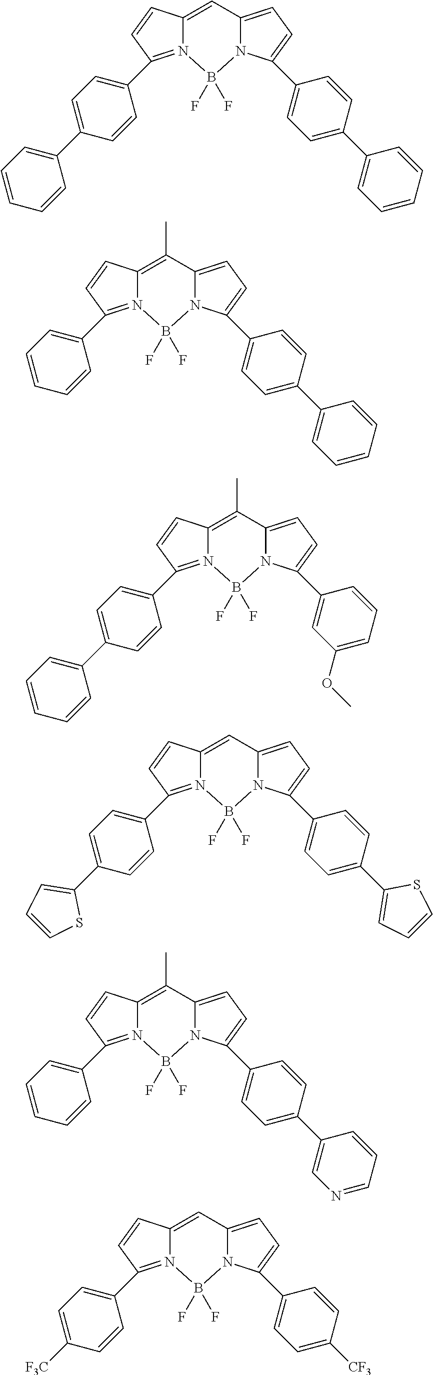

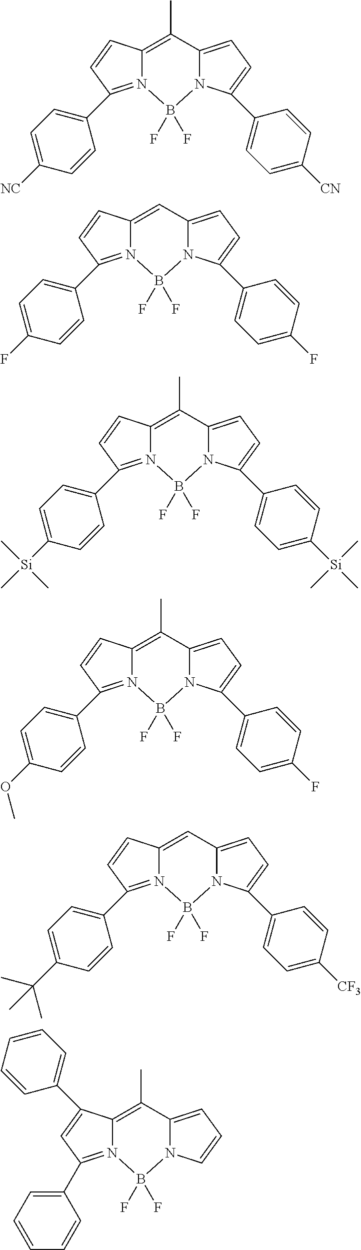

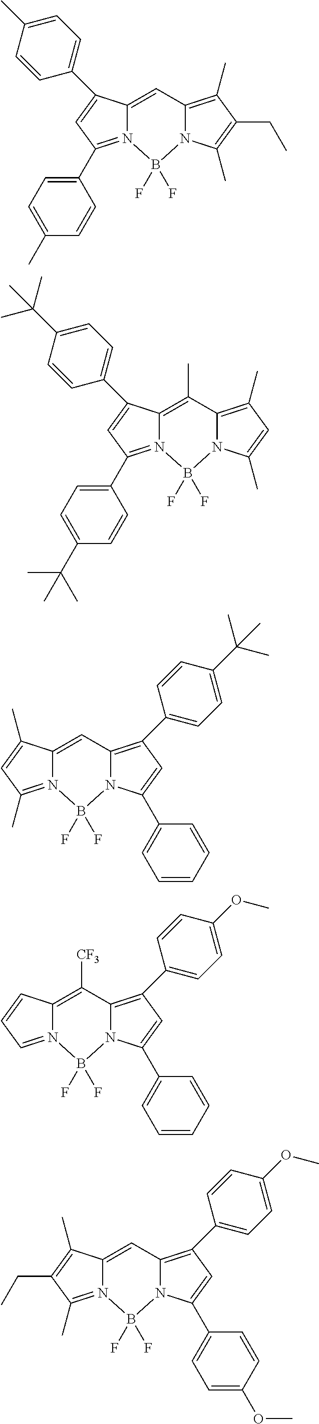

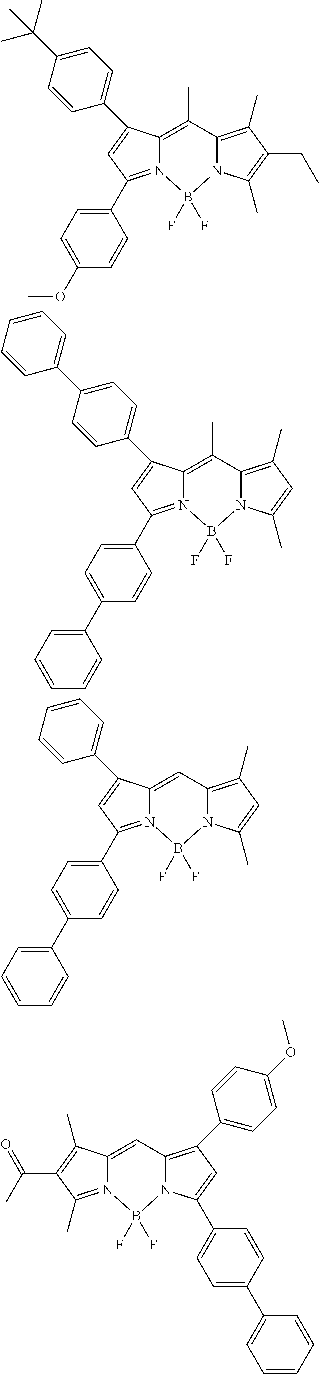

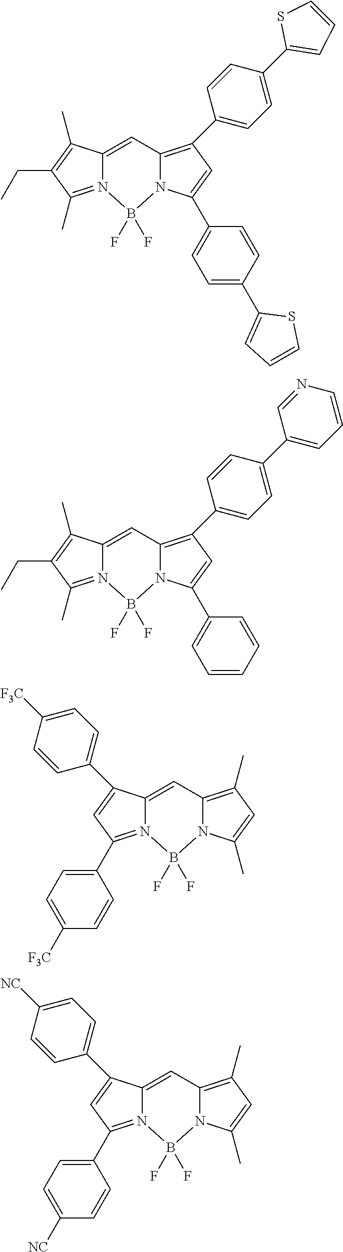

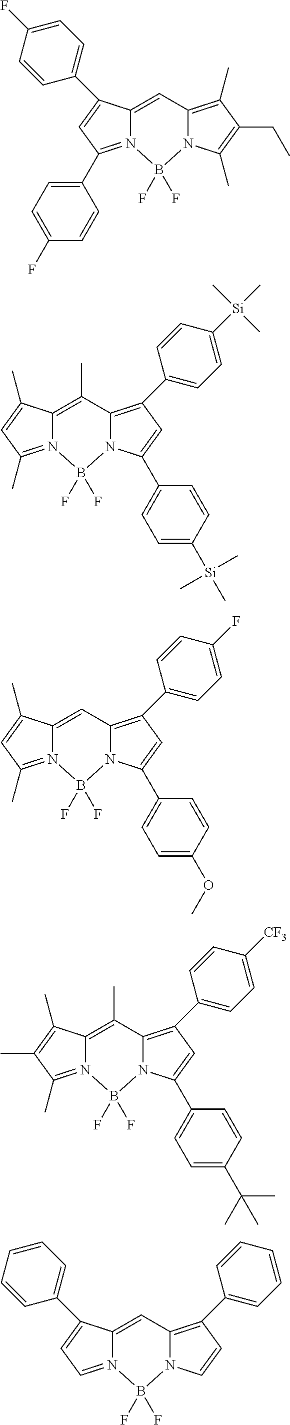

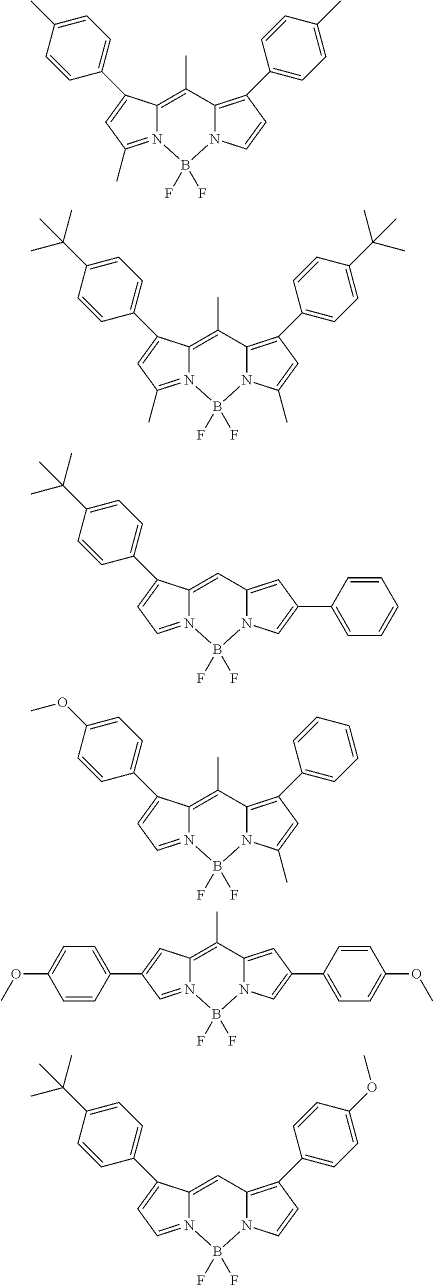

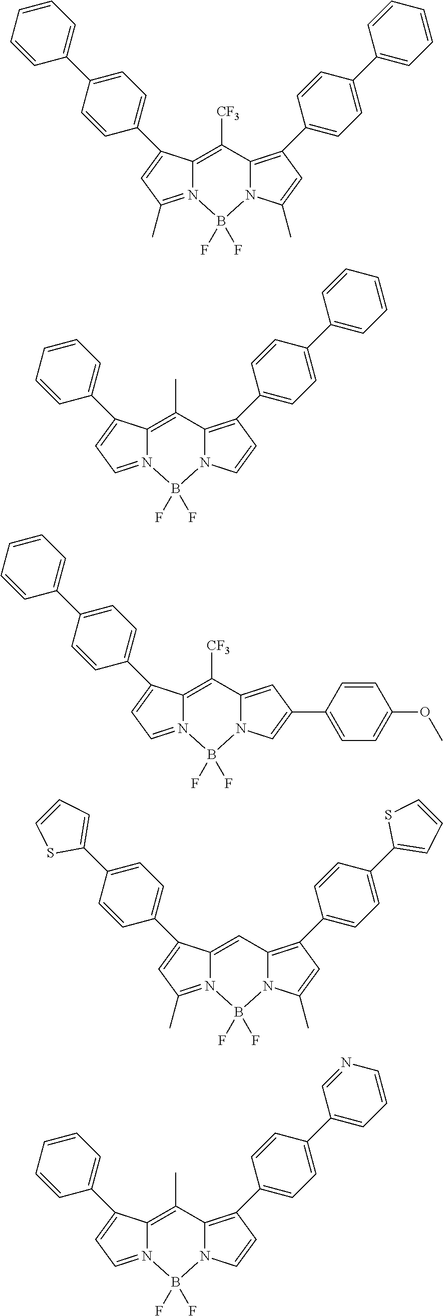

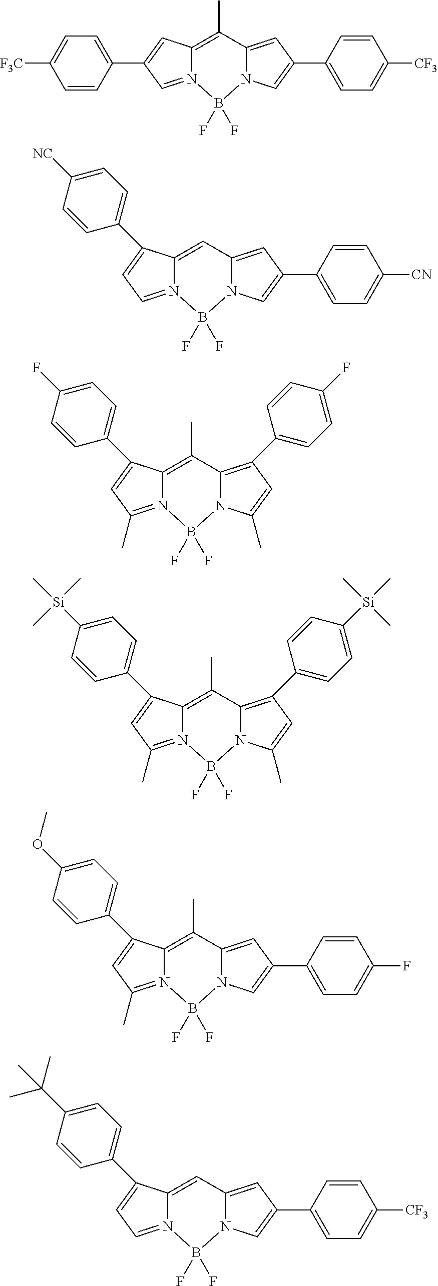

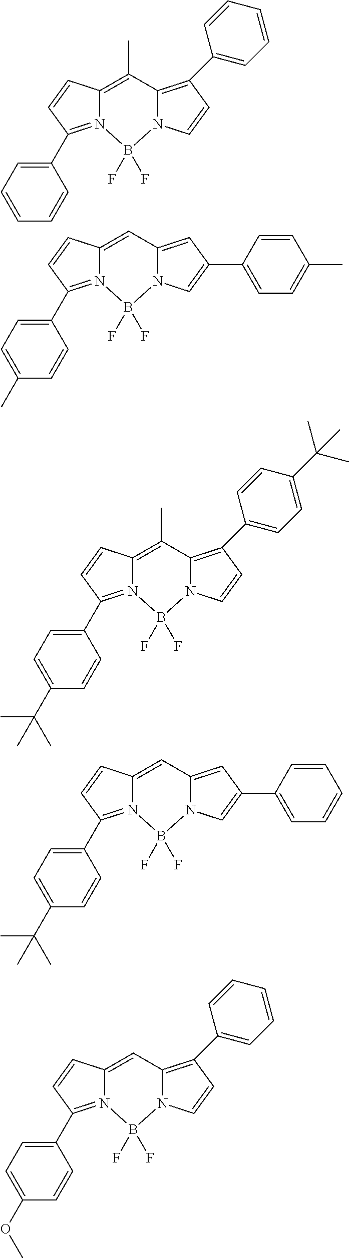

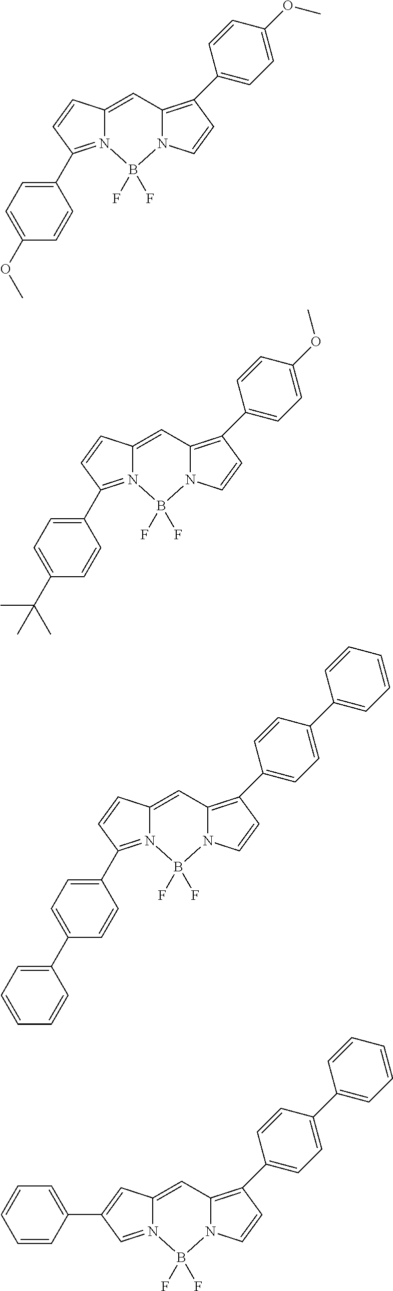

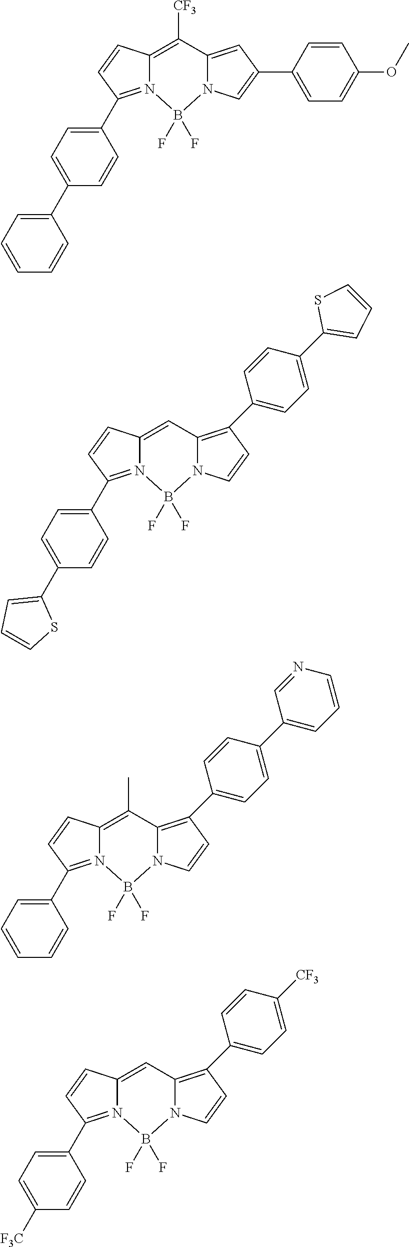

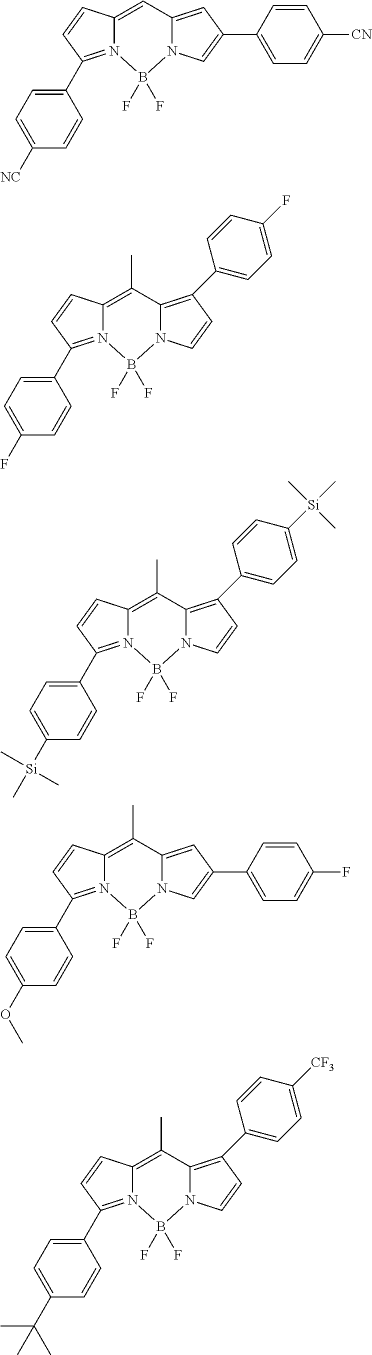

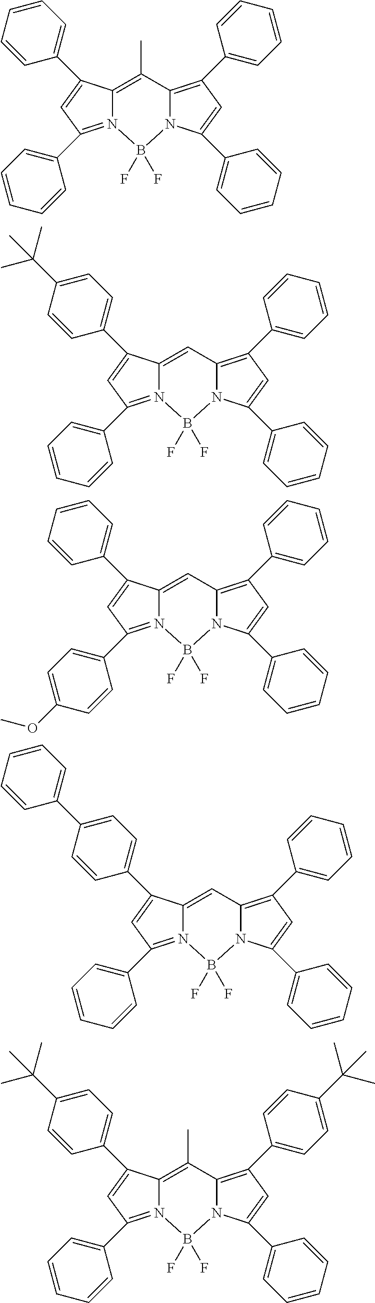

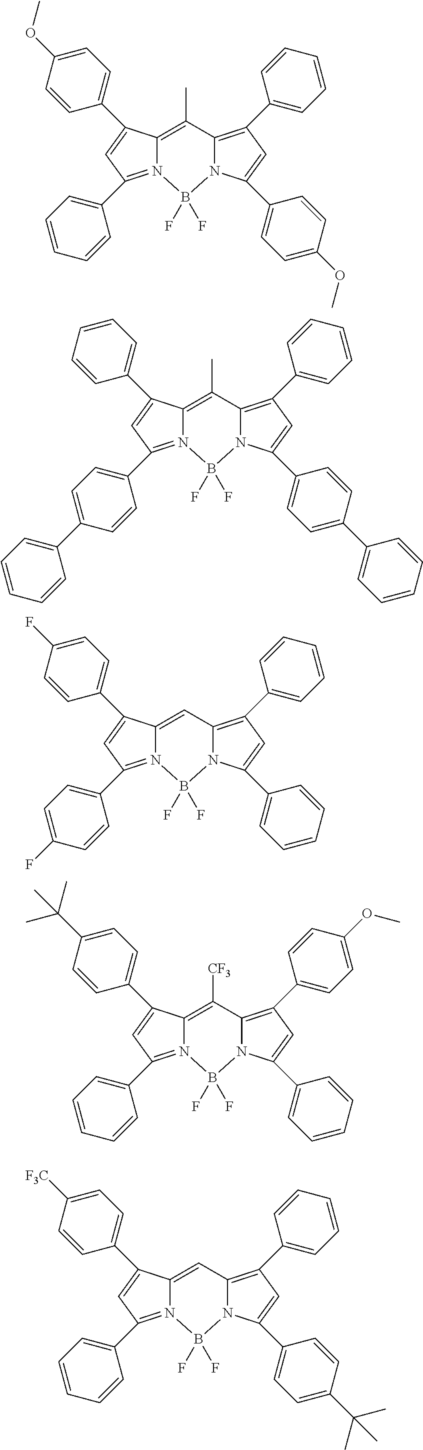

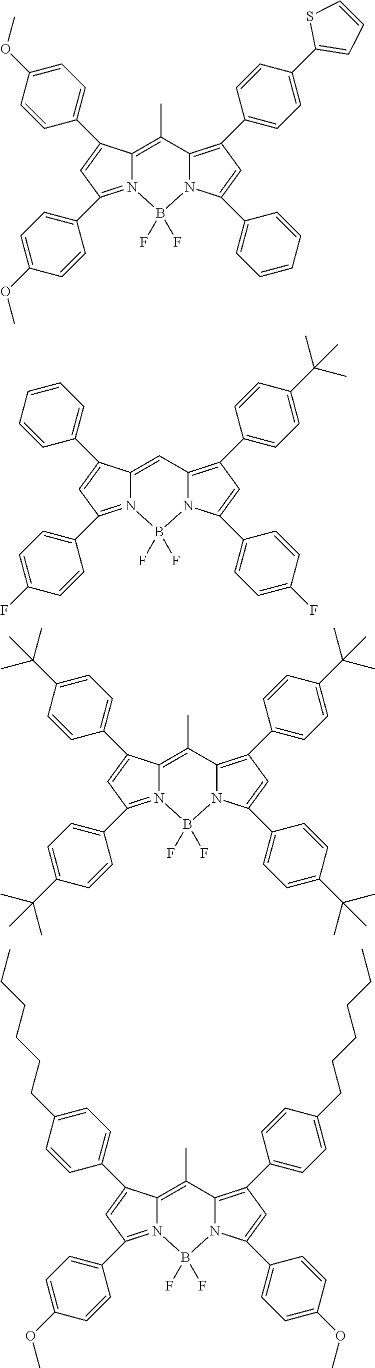

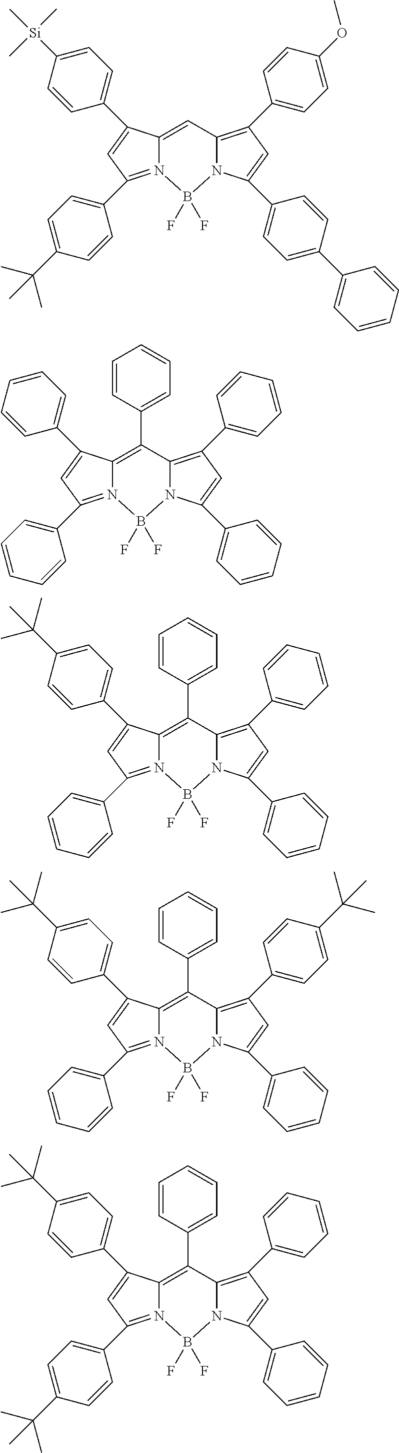

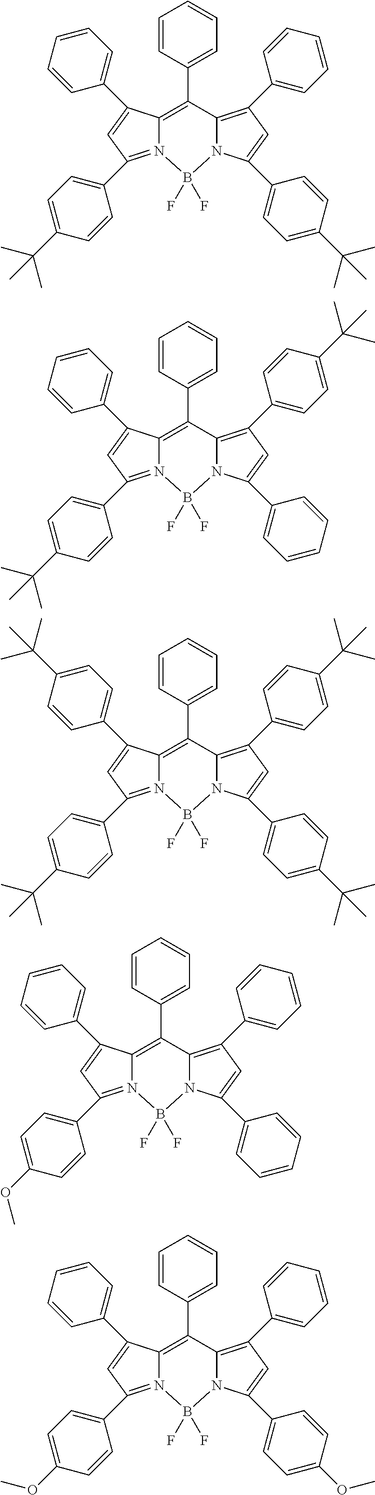

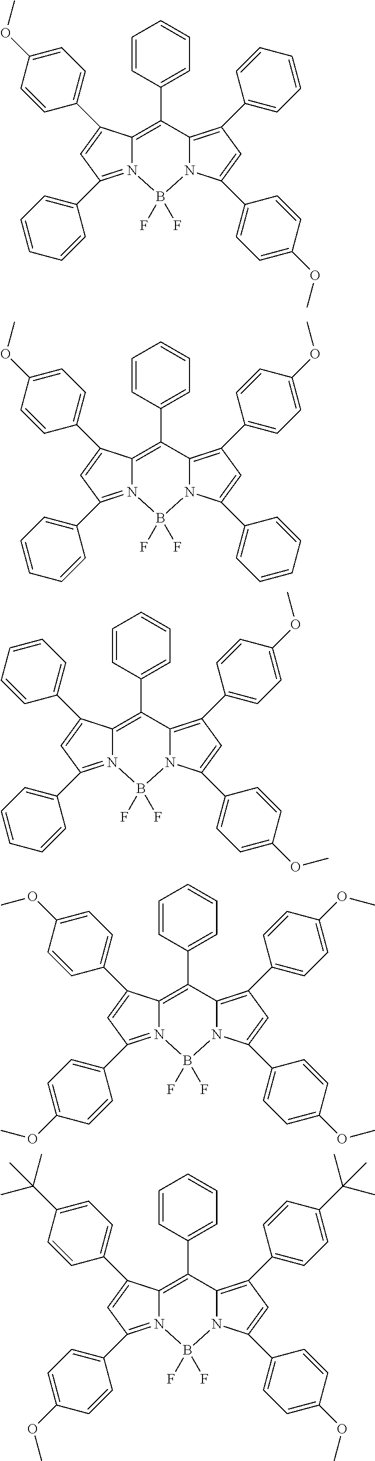

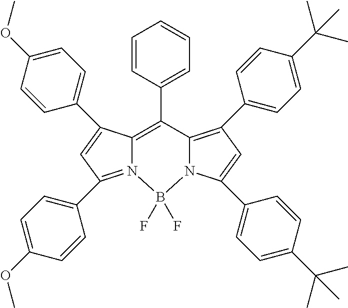

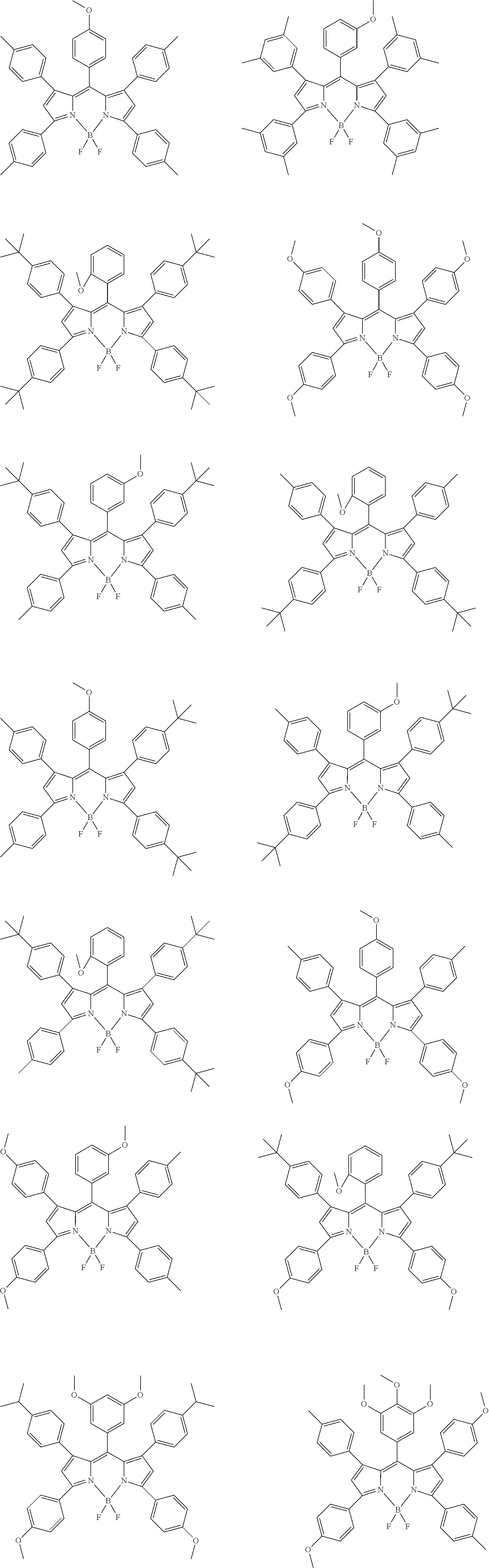

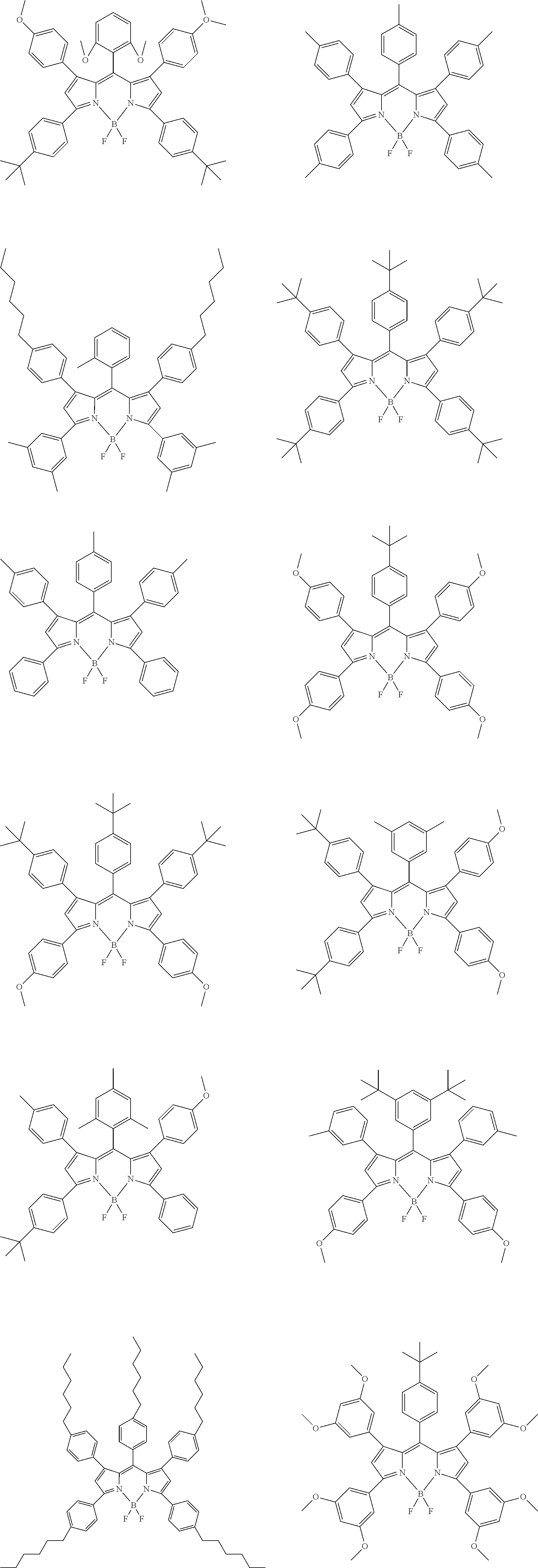

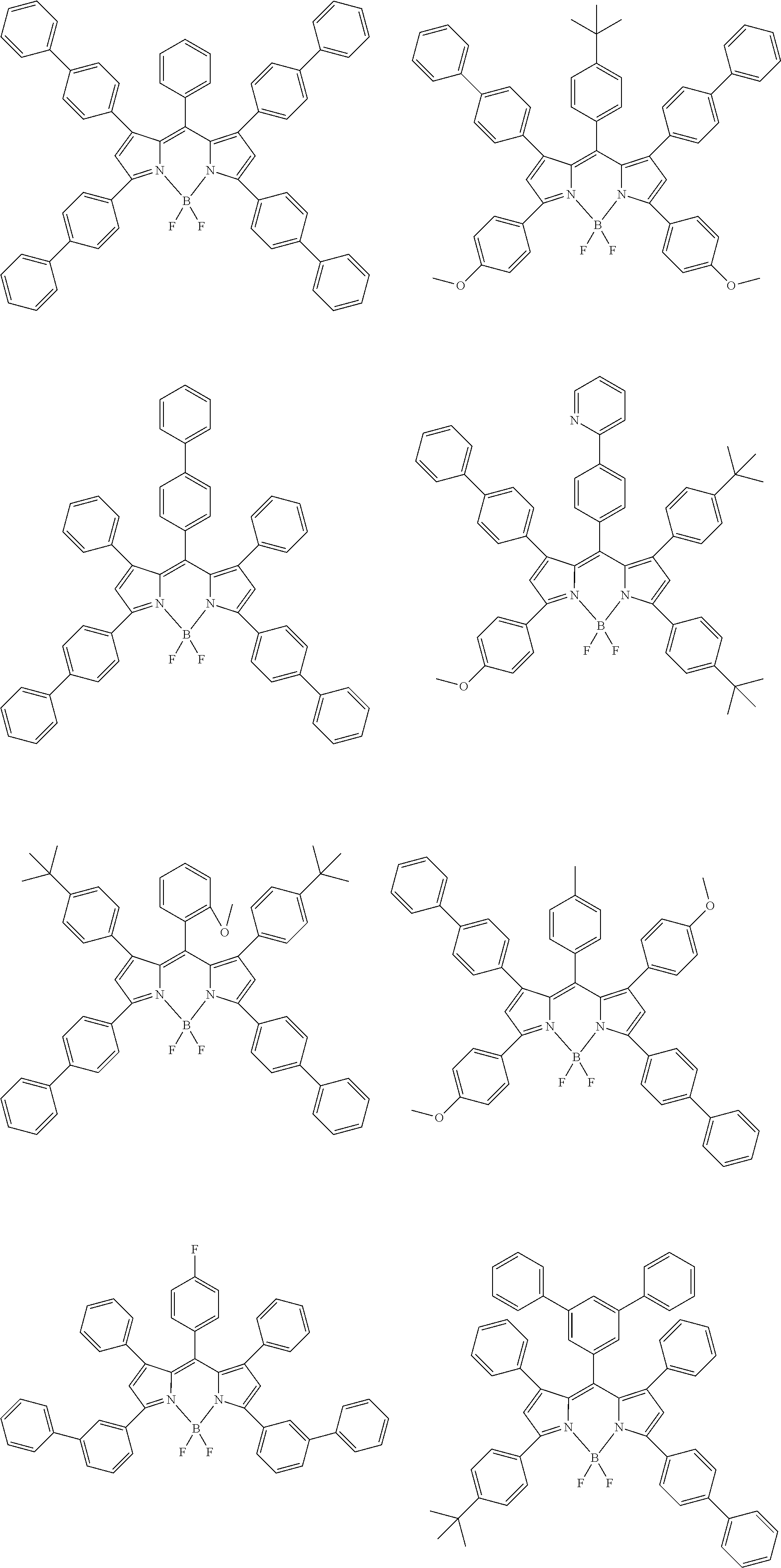

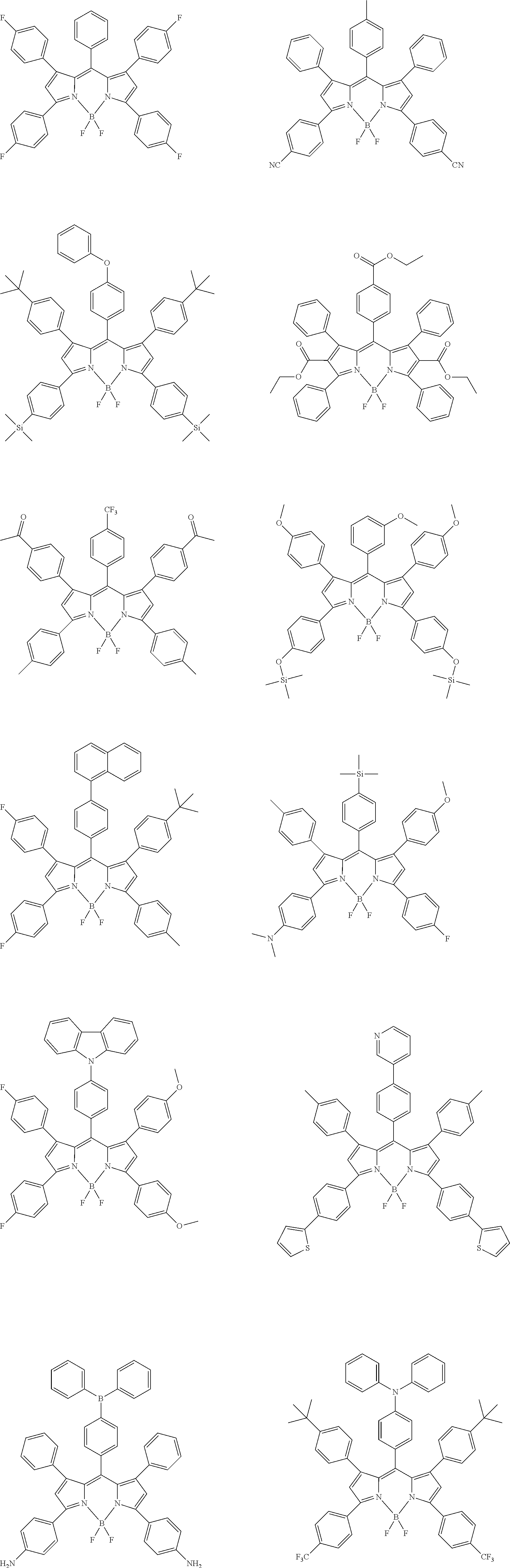

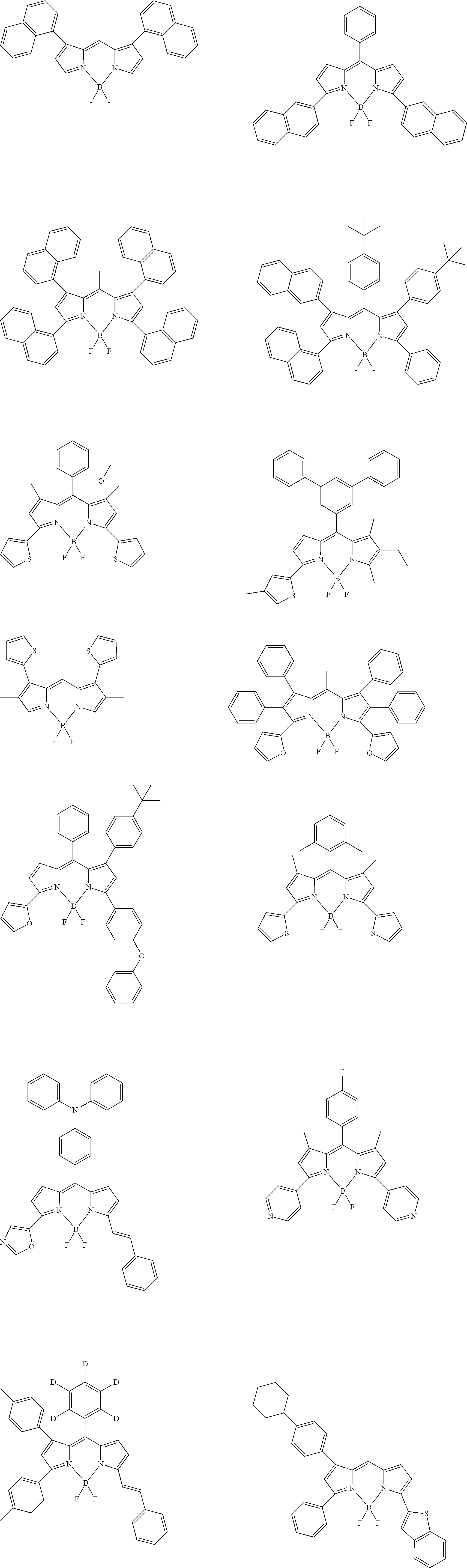

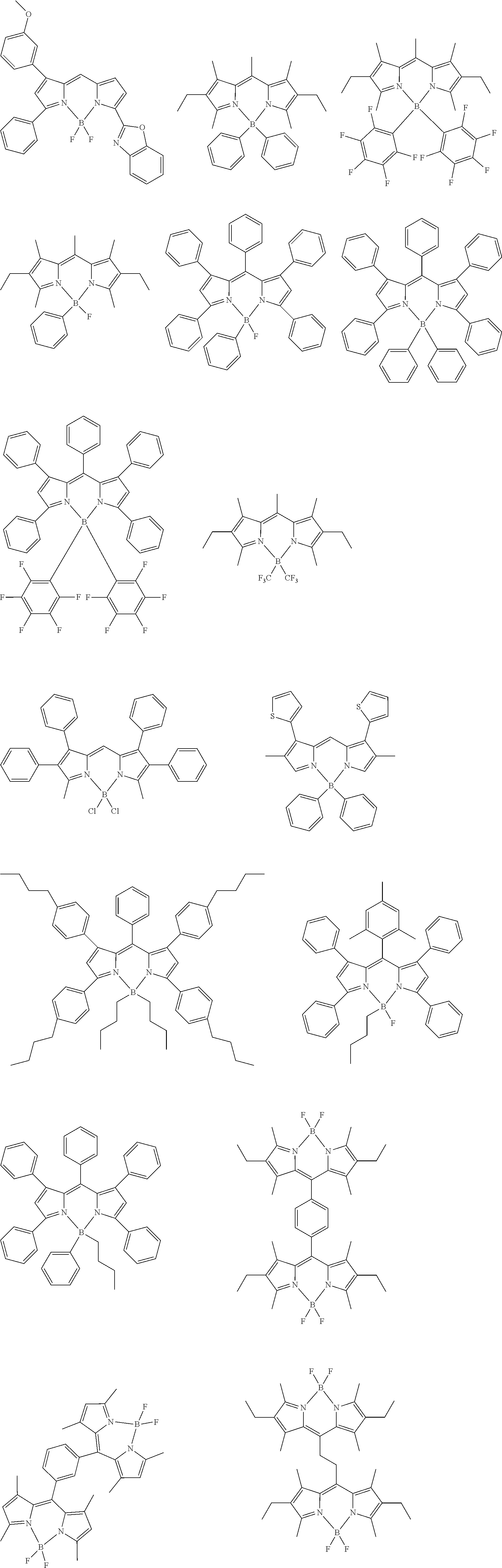

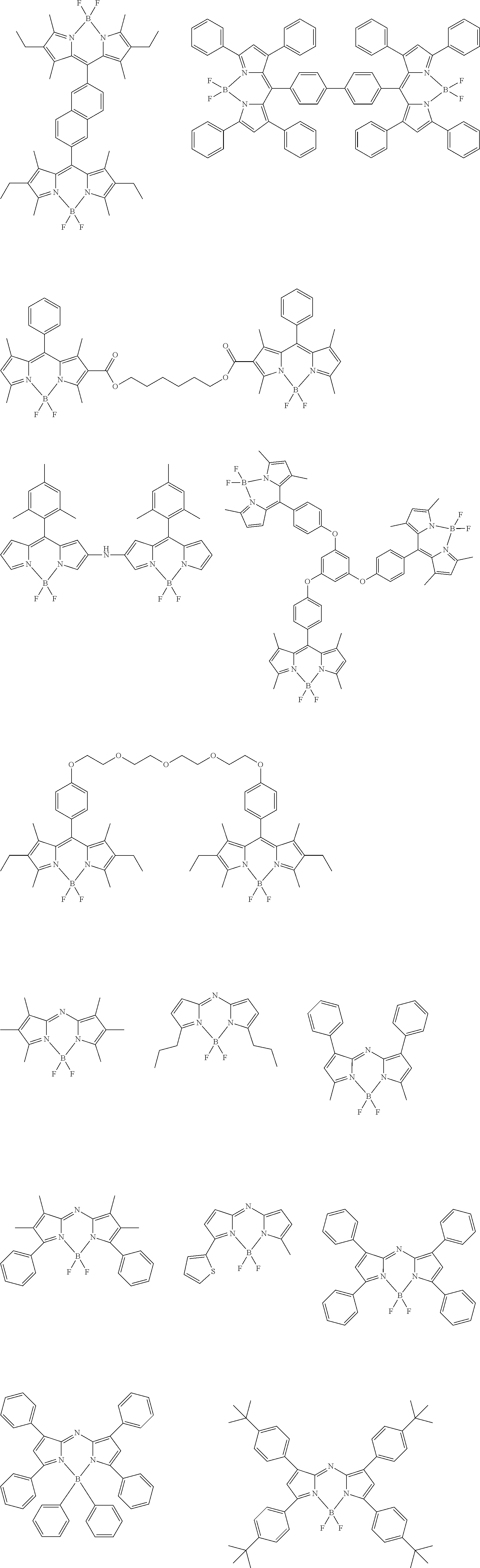

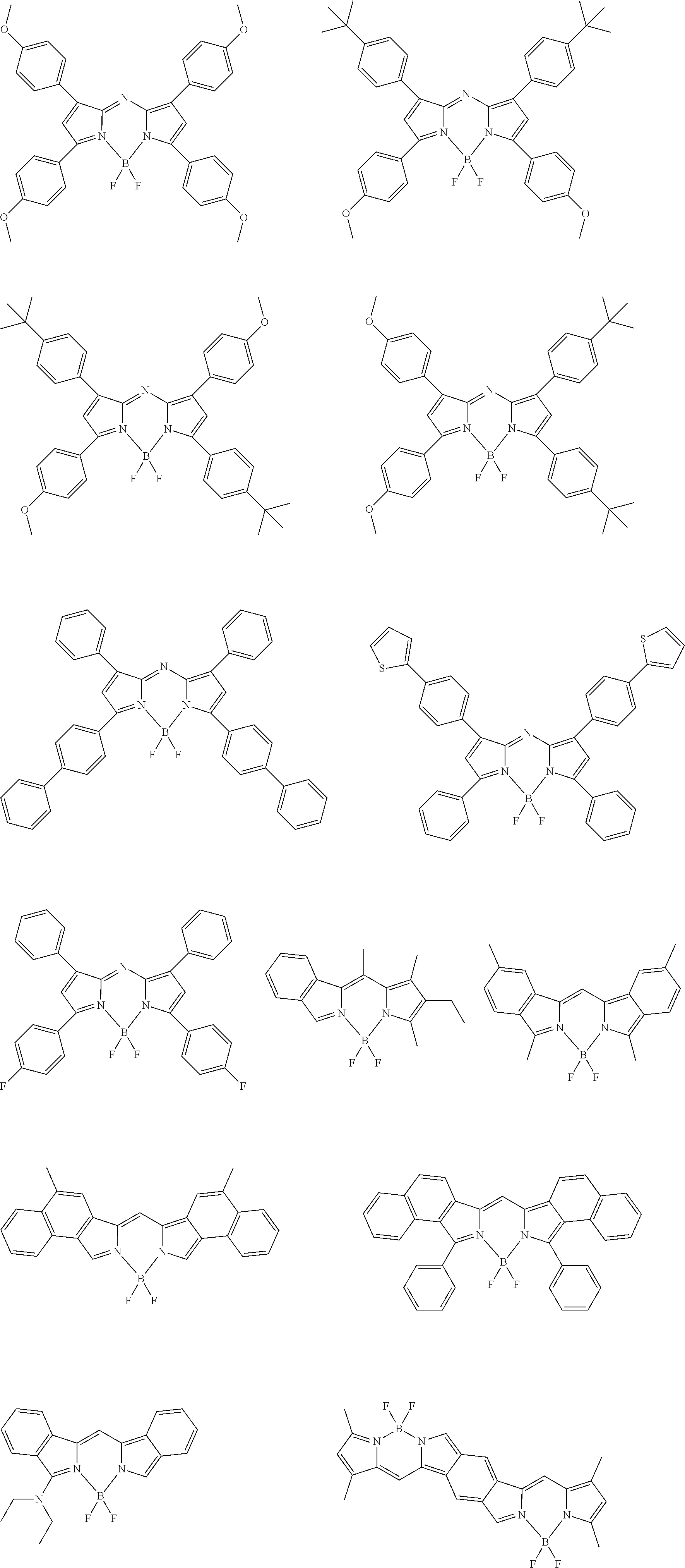

The compound represented by General Formula (1) can be synthesized, for example, by the method described in JP1996-509471A (JP-H8-509471A) and JP2000-208262A. That is, a target pyrromethene-based metal complex is obtained by reacting a pyrromethene compound with a metal salt in the presence of a base.

In addition, with regard to a synthesis of a pyrromethene-boron fluoride complex, the compound represented by General Formula (1) can be synthesized with reference to the method described in J. Org. Chem., vol. 64, No. 21, pp. 7813 to 7819 (1999); Angew. Chem., Int. Ed. Engl., vol. 36, pp. 1333 to 1335 (1997); and the like. Examples thereof include a method of obtaining the compound represented by General Formula (1) by heating a compound represented by General Formula (3) and a compound represented by General Formula (4) in the presence of phosphorus oxychloride, and then reacting with a compound represented by General Formula (5) in 1,2-dichloroethane in the presence of triethylamine. However, the present disclosure is not limited thereto. Here, R¹ to R⁹ are the same as those described above. J represents halogen.

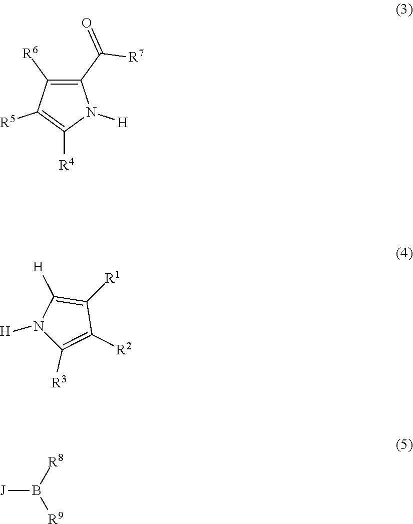

Furthermore, in a case of introducing the aryl group or the heteroaryl group, examples of the above-described method include a method of forming a carbon-carbon bond by a coupling reaction between a halogenated compound and a boronic acid or a boronic esterified compound, but the present disclosure is not limited thereto.

Similarly, in a case of introducing the amino group or the carbazolyl group, examples of the above-described method include a method forming a carbon-nitrogen bond by a coupling reaction between a halogenated compound and an amine or a carbazole compound in the presence of a metal catalyst such as palladium, but the present disclosure is not limited thereto.

The composition for a color conversion film may appropriately contain other compounds in addition to the compound represented by General Formula (1), as necessary. For example, in order to further increase energy transfer efficiency from the excitation light to the compound represented by General Formula (1), the composition for a color conversion film may contain an assist dopant such as rubrene.

In addition, in a case where it is desired to add a light-emitting color other than a light-emitting color of the compound represented by General Formula (1), a desired organic light-emitting material, such as a coumarin-based coloring agent and a rhodamine-based coloring agent, can be added. In addition to these organic light-emitting materials, it is also possible to add a combination of known light-emitting materials such as an inorganic phosphor, a fluorescent pigment, a fluorescent dye, and quantum dot.

Examples of the organic light-emitting material other than the compound represented by General Formula (1) are shown below, but the present disclosure is not particularly limited thereto.

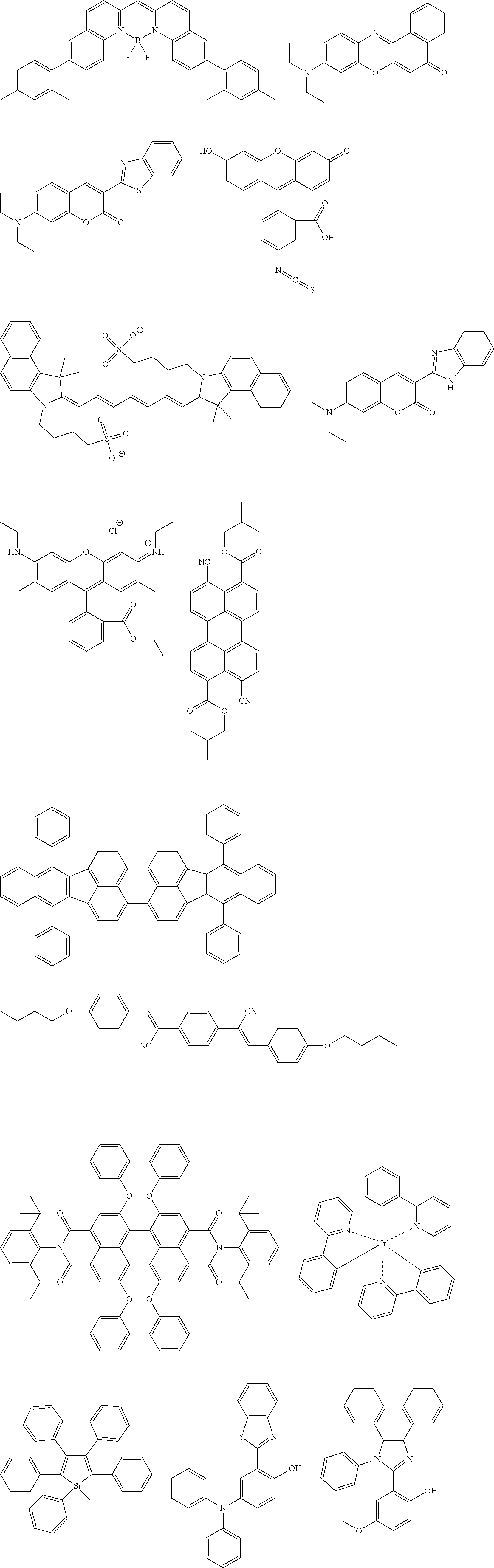

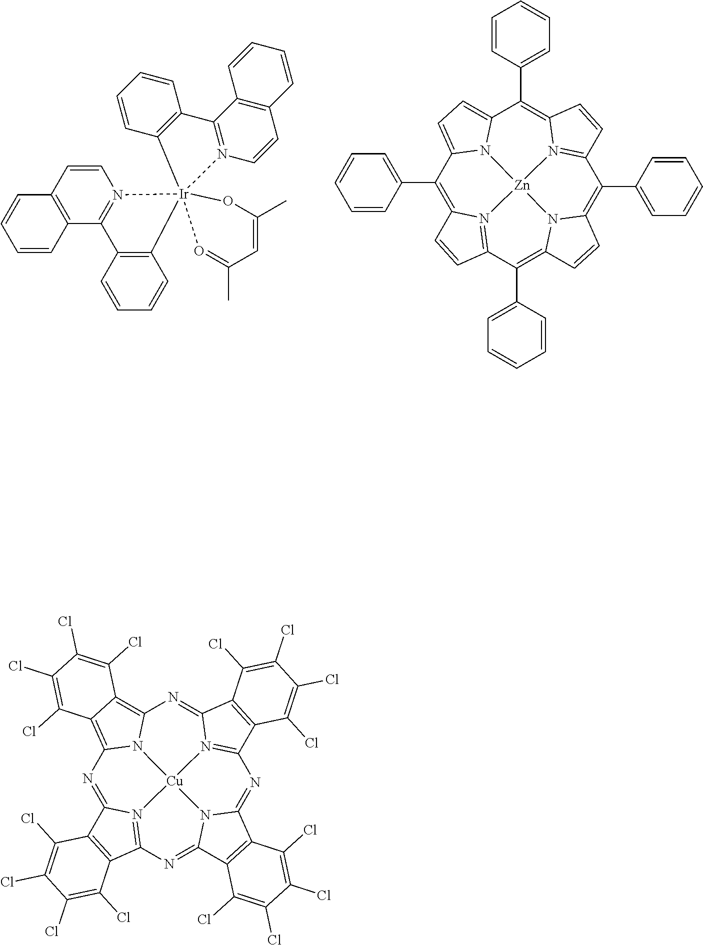

The composition for a color conversion film may contain two or more kinds of organic light-emitting materials.

From the viewpoint of wavelength conversion effect, a content of the organic light-emitting material is preferably 0.005 parts by mass to 1 part by mass to 0.5 parts by mass with respect to 100 parts by mass of the total amount of solid contents contained in the composition for a color conversion film.

(Thermocurable Compound and Photocurable Compound)

The thermocurable compound and the photocurable compound are not particularly limited, and known compounds in the related art can be appropriately selected and used.

From the viewpoint of chemical resistance and light resistance, the composition for a color conversion film preferably contains the photocurable compound.

Examples of the thermocurable compound and the photocurable compound include a compound having an ethylenically unsaturated double bond, a compound having a conjugated diene moiety, a compound having a maleimide moiety, a thiol compound cured by a thiol-ene reaction, an epoxy compound, and a compound having a group crosslinked by an action of acid.

Examples of the compound having a conjugated diene moiety include a compound in which a substituent is introduced into butadiene or isoprene to be non-volatile, polyacetylene and a derivative thereof, and polyphenylacetylene.

Examples of the compound having a maleimide moiety include a polymer compound having a maleimide group in the side chain, a compound having two or more maleimide groups in the molecule, and a compound having a (meth)acryloyl group and a maleimide group in the molecule.

Examples of the thiol compound cured by a thiol-ene reaction include compounds having an aliphatic thiol group, such as pentaerythritol tetrakisthiopropionate, pentaerythritol tetrakis(3-mercaptobutyrate), and 1,3,5-tris(3-mercaptobutyloxyethyl)-1,3,5-triazine-2,4,6-(1H,3H,5H)-trione.

Examples of the epoxy compound include an epoxy-modified compound of a novolac resin, an epoxy-modified compound of a cresol novolac resin, an epoxy-modified compound of bisphenol A, an epoxy-modified compound of ethylene oxide or propylene oxide-modified bisphenol A, an epoxy resin having a dicyclopentadiene skeleton, and an alicyclic epoxy compound.

The epoxy compound preferably has at least one or more glycidyl ether bonds and at least one or more dicyclopentadienyl groups in one molecule.

The alicyclic epoxy compound has at least one alicyclic epoxy group. The alicyclic epoxy group refers to a monovalent substituent having a condensed ring between an epoxy ring and a saturated hydrocarbon ring, and is preferably a monovalent substituent having a condensed ring between an epoxy ring and a cycloalkane ring.

Examples of a commercially available product which can be suitably used as the alicyclic epoxy compound include CELLOXIDE (registered trademark) 2000, CELLOXIDE 2021P, CELLOXIDE 3000, CELLOXIDE 8000, CYCLOMER (registered trademark) M100, EPOLEAD GT301, and EPOLEAD GT401, which are of Daicel Corporation; 4-vinylcyclohexendioxide manufactured by Sigma-Aldrich, Inc.; D-limonene oxide of NIPPON TERPENE CHEMICALS, INC.; and SANSO CIZER (registered trademark) E-PS of New Japan Chemical Co., Ltd. These can be used alone or in combination of two or more kinds thereof.

In a case of containing the epoxy compound, the composition for a color conversion film may further contain an epoxy curing agent.

Examples of the epoxy curing agent include an acid anhydride-based curing agent, a polyamine-based curing agent, a catalytic curing agent, and a polycarboxylic acid-based curing agent.

Specific examples of the acid anhydride-based curing agent include maleic acid anhydride, tetrahydrophthalic acid anhydride, hexahydrophthalic acid anhydride, methylhexahydrophthalic acid anhydride, hexahydrotrimellitic acid anhydride, phthalic acid anhydride, trimellitic acid anhydride, and a styrene-maleic acid anhydride copolymer.

Specific examples of the polyamine-based curing agent include diethylenetriamine, triethylenetetramine, tetraethylenepentamine, dicyandiamide, polyamidoamine (polyamide resin), a ketimine compound, isophoronediamine, m-xylenediamine, m-phenylenediamine, 1,3-bis(aminomethyl)cyclohexane, N-aminoethylpiperazine, 4,4′-diaminodiphenylmethane, 4,4′-diamino-3,3′-diethyldiphenylmethane, and diaminodiphenylsulfone.

Specific examples of the catalytic curing agent include a tertiary amine compound and an imidazole compound.

Specific examples of the polycarboxylic acid-based curing agent include phthalic acid anhydride, trimellitic acid anhydride, pyromellitic acid anhydride, tetrahydrophthalic acid anhydride, methyltetrahydrophthalic acid anhydride, 3,6-endomethylenetetrahydrophthalic acid anhydride, hexachlorendomethylenetetrahydrophthalic acid anhydride, and methyl-3,6-endomethylenetetrahydrophthalic acid anhydride.

A content of the epoxy curing agent in the composition for a color conversion film is preferably 0.001 parts by mass to 10 parts by mass and more preferably 0.01 parts by mass to 5 parts by mass with respect to 100 parts by mass of solid contents contained in the composition for a color conversion film.

Examples of the compound having a group crosslinked by an action of acid include amino compounds such as a melamine resin, a urea resin, a guanamine resin, a glycoluril-formaldehyde resin, a succinylamide-formaldehyde resin, and an ethylene urea-formaldehyde resin.

Among the above, a melamine resin or a urea resin is preferable, and specifically, an alkoxymethylated amino resin such as an alkoxymethylated melamine resin and an alkoxymethylated urea resin is preferable.

The alkoxymethylated amino resin can be produced, for example, by a method in which a condensate obtained by reacting melamine or urea with formalin in boiling aqueous solution is reacted with lower alcohols such as methyl alcohol, ethyl alcohol, propyl alcohol, butyl alcohol, and isopropyl alcohol to form an ether, and then the reaction solution is cooled to precipitate.

Specific examples of the alkoxymethylated amino resin include a methoxymethylated melamine resin, an ethoxymethylated melamine resin, a propoxymethylated melamine resin, a butoxymethylated melamine resin, a methoxymethylated urea resin, an ethoxymethylated urea resin, a propoxymethylated urea resin, and a butoxymethylated urea resin.

The alkoxymethylated amino resin can be used alone or in combination of two or more kinds thereof. A methoxymethylated melamine resin, an ethoxymethylated melamine resin, a propoxymethylated melamine resin, or a butoxymethylated melamine resin is suitable.

Specific examples of the melamine resin include melamine, methylol melamine, etherified methylol melamine, benzoguanamine, etherified methylol benzoguanamine, and a condensate thereof.

Among the above, etherified methylol melamine is preferable because it has good chemical resistance. A mixture of the etherified methylol melamine and a condensate thereof is commercially available as NIKALAC MW-30 (trade name) manufactured by Sanwa Chemical Co., Ltd.

From the viewpoint of curing properties, the compound having an ethylenically unsaturated double bond is preferable, and it is more preferable to include a compound having an acryloyl group in the molecule.

Examples thereof include a compound with (meth)acrylic acid added to one terminal of polyalkylene oxide, and a compound obtained by adding (meth)acrylic acid to one terminal of polyalkylene oxide and alkyl-etherifying or allyl-etherifying the other terminal.

Examples of the above-described compound having an ethylenically unsaturated double bond include phenoxyhexaethylene glycol mono(meth)acrylate, which is a (meth)acrylate of a compound in which polyethylene glycol is added to a phenyl group; 4-normal nonylphenoxyheptaethylene glycol dipropylene glycol (meth)acrylate, which is a (meth)acrylate of a compound obtained by adding polypropylene glycol with an average of 2 mol of propylene oxide added and polyethylene glycol with an average of 7 μmol of ethylene oxide added to nonylphenol; and 4-normal nonylphenoxypentaethylene glycol monopropylene glycol (meth)acrylate, which is a (meth)acrylate of a compound obtained by adding polypropylene glycol with an average of 1 μmol of propylene oxide added and polyethylene glycol with an average of 5 μmol of ethylene oxide added to nonylphenol. Examples thereof also include 4-normal nonylphenoxy octaethylene glycol (meth)acrylate (manufactured by TOAGOSEI CO., LTD., M-114), which is an acrylate of a compound obtained by adding polyethylene glycol with an average of 8 μmol of ethylene oxide added to nonylphenol.

Examples of the compound having an ethylenically unsaturated double bond include a compound having (meth)acryloyl groups at both terminals of an alkylene oxide chain and a compound (meth)acryloyl groups at both terminals of an alkylene oxide chain in which an ethylene oxide chain and a propylene oxide chain are randomly or block-bonded.

Examples of the above-described compound include tetraethylene glycol di(meth)acrylate, pentaethylene glycol di(meth)acrylate, hexaethylene glycol di(meth)acrylate, heptaethylene glycol di(meth)acrylate, octaethylene glycol di(meth)acrylate, nonaethylene glycol di(meth)acrylate meth)acrylate, decaethylene glycol di(meth)acrylate, and a compound having 12 μmol of (meth)acryloyl groups at both terminals of an ethylene oxide chain.

In addition, an alkylene oxide-modified compound of bisphenol A, which has (meth)acryloyl groups at both terminals, can be suitably used.

Examples of the alkylene oxide modification include ethylene oxide modification, propylene oxide modification, butylene oxide modification, pentylene oxide modification, and hexylene oxide modification.

As the above-described compound, an ethylene oxide-modified compound of bisphenol A, which has (meth)acryloyl groups at both terminals, is preferable. Examples of the above-described compound include 2,2-bis(4-((meth)acryloxypolyethoxy)phenyl)propanes such as 2,2-bis(4-((meth)acryloxydiethoxy)phenyl)propane (manufactured by Shin-Nakamura Chemical Co., Ltd., NK ESTER BPE-200), 2,2-bis(4-((meth)acryloxytriethoxy)phenyl)propane, 2,2-bis(4-((meth)acryloxytetraethoxy)phenyl)propane, 2,2-bis(4-((meth)acryloxypentaethoxy)phenyl)propane (manufactured by Shin-Nakamura Chemical Co., Ltd., NK ESTER BPE-500), 2,2-bis(4-((meth)acryloxyhexaethoxy)phenyl)propane, 2,2-bis(4-((meth)acryloxyheptaethoxy)phenyl)propane, 2,2-bis(4-((meth)acryloxyoctaethoxy)phenyl)propane, 2,2-bis(4-((meth)acryloxynonaethoxy)phenyl)propane, 2,2-bis(4-((meth)acryloxydecaethoxy)phenyl)propane, 2,2-bis(4-((meth)acryloxyundeca) ethoxy)phenyl)propane, 2,2-bis(4-((meth)acryloxydodecaethoxy)phenyl)propane, 2,2-bis(4-((meth)acryloxytridecaethoxy)phenyl)propane, 2,2-bis(4-((meth)acryloxytetradecaethoxy)phenyl)propane, 2,2-bis(4-((meth)acryloxypentadecaethoxy)phenyl)propane, and 2,2-bis(4-((meth)acryloxyhexadecaethoxy)phenyl)propane.

The compound having more than two (meth)acryloyl groups in one molecule is obtained from a compound, as a central skeleton, having 3 μmol or more of groups to which an alkylene oxide group can be added in the molecule, and by adding an alkylene oxide group such as an ethylene oxide group, propylene oxide and butylene oxide to the compound and then (meth)acrylate-forming the obtained alcohol.

Examples of the compound which can form the central skeleton include glycerin, trimethylolpropane, pentaerythritol, dipentaerythritol, and an isocyanurate ring.

Examples of the above-described compound include 3-mol-ethylene oxides (EO)-modified triacrylate of trimethylolpropane, 6-mol-EO-modified triacrylate of trimethylolpropane, 9-mol-EO-modified triacrylate of trimethylolpropane, and 12-mol-EO-modified triacrylate of trimethylolpropane.

Examples of the above-described compound include 3-mol-EO-modified triacrylate of glycerin (manufactured by Shin-Nakamura Chemical Co., Ltd., A-GLY-3E), 9-mol-EO-modified triacrylate of glycerin (manufactured by Shin-Nakamura Chemical Co., Ltd., A-GLY-9E), 6-mol-EO and 6-mol-propylene oxides (PO)-modified triacrylate of glycerin (manufactured by Shin-Nakamura Chemical Co., Ltd., A-GLY-0606PE), and 9-mol-EO and 9-mol-PO-modified triacrylate of glycerin (manufactured by Shin-Nakamura Chemical Co., Ltd., A-GLY-0909PE).

Examples of the above-described compound include 4EO-modified tetraacrylate of pentaerythritol (manufactured by Sartomer Japan Inc., SR-494) and 35EO-modified tetraacrylate of pentaerythritol (NK ESTER ATM-35E manufactured by Shin-Nakamura Chemical Co., Ltd.).

In addition to the above-described compounds, the following compounds can be appropriately used. Examples thereof include 1,6-hexanediol di(meth)acrylate, 1,4-cyclohexanediol di(meth)acrylate, 2-di(p-hydroxyphenyl)propane di(meth)acrylate, 2,2-bis[(4-(meth)acryloxypolypropyleneoxy)phenyl]propane, 2,2-bis[(4-(meth)acryloxypolybutyleneoxy)phenyl]propane, glycerol tri(meth)acrylate, trimethylolpropane tri(meth)acrylate, polyoxypropyltrimethylolpropane tri(meth)acrylate, dipentaerythritol penta(meth)acrylate, trimethylolpropane triglycidyl ether tri(meth)acrylate, β-hydroxypropyl-β′-(acryloyloxy)propyl phthalate, nonylphenoxypolypropylene glycol (meth)acrylate, nonylphenoxypolybutylene glycol (meth)acrylate, and polypropylene glycol mono(meth)acrylate.

Further, the following urethane compounds may be used.

Examples thereof include isocyanate compounds such as hexamethylene diisocyanate, tolylene diisocyanate, and a diisocyanate compound (for example, 2,2,4-trimethylhexamethylene diisocyanate); urethane compounds such as a compound having a hydroxyl group and a (meth)acryloyl group in one molecule (for example, 2-hydroxypropyl acrylate, oligopropylene glycol monomethacrylate, and the like).

Specific examples thereof include a reaction product of hexamethylene diisocyanate and oligopropylene glycol monomethacrylate (manufactured by NOF Corporation, Blemmer PP1000).

In addition, examples thereof also include di- or tri(meth)acrylates of isocyanurate modified with polypropylene glycol or polycaprolactone.

In addition, examples thereof also include a urethane oligomer obtained by reacting a terminal of a urethane compound obtained as a polyadduct of a diisocyanate and a polyol with a compound having an ethylenically unsaturated double bond and a hydroxyl group.

In addition, a combination of a polyvalent isocyanate and a polyol can be used as the thermocurable compound. A urethane bond is formed by a reaction between an isocyanate group and a hydroxyl group of the polyol, and a urethane polymer is synthesized.

Examples of the polyvalent isocyanate (bi- or higher functional isocyanate) include phenylene-1,3-diisocyanate, phenylene-1,4-diisocyanate, 1-methoxyphenylene-2,4-diisocyanate, 1-methylphenylene-2,4-diisocyanate, 2,4-tolylene diisocyanate, 2,6-tolylene diisocyanate, 1,3-xylylene diisocyanate, 1,4-xylylene diisocyanate, biphenylene-4,4-diisocyanate, 3,3-dimethoxybiphenylene-4,4-diisocyanate, 3,3-dimethylbiphenylene-4,4-diisocyanate, diphenylmethane-2,4-diisocyanate, diphenylmethane-4,4-diisocyanate, 3,3-dimethoxydiphenylmethane-4,4-diisocyanate, 3,3-dimethyldiphenylmethane-4,4-diisocyanate, naphthylene-1,5-diisocyanate, cyclobutylene-1,3-diisocyanate, cyclopentylene-1,3-diisocyanate, cyclohexylene-1,3-diisocyanate, cyclohexylene-1,4-diisocyanate, 1-methylcyclohexylene-2,4-diisocyanate, 1-methylcyclohexylene-2,6-diisocyanate, 1-isocyanate-3,3,5-trimethyl-5-isocyanatomethylcyclohexane, cyclohexane-1,3-bis(methylisocyanate), cyclohexane-1,4-bis(methylisocyanate), isophorone diisocyanate, dicyclohexylmethane-2,4-diisocyanate, dicyclohexylmethane-4,4-diisocyanate, ethylene diisocyanate, tetramethylene-1,4-diisocyanate, hexamethylene-1,6-diisocyanate, dodecamethylene-1,12-diisocyanate, and both terminal isocyanate prepolymers obtained by reacting a stoichiometric excess amount of these organic diisocyanates with a bifunctional active hydrogen atom-containing compound.

In addition to the above-described diisocyanates, a tri- or higher functional organic polyisocyanate, a terminal isocyanate prepolymer obtained by reacting a stoichiometric excess amount of the tri- or higher functional organic polyisocyanate with a bi- or higher functional polyfunctional active hydrogen atom-containing compound, or the like may be used in combination.

Examples of the tri- or higher functional organic polyisocyanate include phenyl-1,3,5-triisocyanate, diphenylmethane-2,4,4-triisocyanate, diphenylmethane-2,5,4-triisocyanate, triphenylmethane-2,4,4“triisocyanate, triphenylmethane-4,4,4”-triisocyanate, diphenylmethane-2,4,2,4-tetraisocyanate, diphenylmethane-2,5,2,5-tetraisocyanate, cyclohexane-1,3,5-triisocyanate, cyclohexane-1,3,5-tris(methylisocyanate), 3,5-dimethylcyclohexane-1,3,5-tris(methylisocyanate), 1,3,5-trimethylcyclohexane-1,3,5-tris(methylisocyanate), dicyclohexylmethane-2,4,2-triisocyanate, and dicyclohexylmethane-2,4,4-triisocyanate.

Examples of the polyol (compound having bi- or higher functional alcoholic hydroxyl group) include ethylene glycol, diethylene glycol, polyethylene glycol, propylene glycol, dipropylene glycol, polypropylene glycol, 1,4-butanediol, polytetramethylene glycol, glycerin, trimethylolpropane, and pentaerythritol.

In addition, in a case where the composition for a color conversion film contains, as the thermocurable compound, the combination of the polyvalent isocyanate and the polyol, it is more preferable to contain a reaction promoter which promotes the thermocurable reaction between the polyvalent isocyanate and the polyol.

By adding the reaction promoter, the reaction between the isocyanate and the hydroxyl group is promoted, and it is possible to produce a good urethane polymer even at a low temperature.

Examples of the reaction promoter preferably used include tetraalkylammonium salts, cyclic amidines such as diazabicycloundecene (DBU) and diazabicyclononene (DBN) and salts thereof, cyclic amines such as 1,4-diazabicyclo[2.2.2]octane (DABCO), pyridines, nitrogen atom-containing heteroaromatic compound of imidazoles and salts thereof, alkyltin compounds and salts thereof, alkylzinc compounds and salts thereof, zirconium compounds, titanium compounds, alkylaluminums, and boric acids.

In addition, a thermocurable resin cyclized and cured by a base, such as a polyimide precursor resin, a polyamidoimide precursor resin, and a polybenzoxazole precursor resin, can also be used.

The composition for a color conversion film may contain two or more kinds of thermocurable compounds. In addition, the composition for a color conversion film may contain two or more kinds of photocurable compounds.

From the viewpoint of solvent resistance and light resistance, the sum of contents of the thermocurable compound and the photocurable compound described above is preferably 30 parts by mass or more, more preferably 50 parts by mass or more, and still more preferably 70 parts by mass or more with respect to 100 parts by mass of the total amount of solid contents contained in the composition for a color conversion film.

In addition, the sum of the contents of the thermocurable compound and the photocurable compound described above is preferably 95 parts by mass or less with respect to 100 parts by mass of the total amount of solid contents contained in the composition for a color conversion film.

(Polymerization Initiator)

The composition for a color conversion film according to the embodiment of the present disclosure may contain one or two or more kinds of polymerization initiators. By containing the polymerization initiator in the composition for a color conversion film, it is possible to manufacture a color conversion film having more excellent solvent resistance and light resistance.

The polymerization initiator is not particularly limited, and may be a thermal polymerization initiator or a photopolymerization initiator.

The photopolymerization initiator is a compound capable of generating initiating species such as radicals and acids due to decomposition by exposure, and is a compound capable of initiating and accelerating the polymerization reaction of a polymerizable compound with this initiating species.

The form of thermal polymerization may be cationic polymerization (examples of thermal polymerization initiator: onium salt compounds) or anionic polymerization (examples of thermal polymerization initiator: imidazoles).

In a case of containing an impurity or a decomposition product including a substance having a high nucleophilicity, the thermal polymerization initiator may be adsorbed on a surface of a phosphor, weakening a reaction rate of epoxide, and at the same time, affecting light emission efficiency of the phosphor contained in a phosphor-dispersed composition. Therefore, it is preferable that the thermal polymerization initiator contains a small content of highly nucleophilic components, particularly primary amines and secondary amines.

Examples of the thermal polymerization initiator include onium salt compounds such as iodonium salt, sulfonium salt, and phosphonium salt; complex salts of a Lewis acid compound and tertiary amines or nitrogen atom-containing heteroaromatics, such as boron trifluoride, zinc halide, tin halide, aluminum halide, and iron halide; imidazole compounds; cyclic amidine compounds; and a salt of these compounds and an organic acid.

Examples of the photopolymerization initiator include quinones, aromatic ketones, acetophenones, acylphosphine oxides, benzoins, benzoin ethers, dialkylketals, thioxanthones, dialkylaminobenzoic acid esters, oxime esters, acridines, hexaarylbiimidazoles, pyrazoline compounds, N-arylamino acids and ester compounds thereof, and halogen compounds.

Examples of the quinones include compounds such as 2-ethylanthraquinone, octaethylanthraquinone, 1,2-benzanthraquinone, 2,3-benzanthraquinone, 2-phenylanthraquinone, 2,3-diphenylanthraquinone, 1-chloroanthraquinone, 2-chloroanthraquinone, 2-methylanthraquinone, 1,4-naphthoquinone, 9,10-phenanthraquinone, 2-methyl-1,4-naphthoquinone, 9,10-phenanthraquinone, 2-methyl-1, 4-naphthoquinone, 2,3-dimethylanthraquinone, and 3-chloro-2-methylanthraquinone.

Examples of the aromatic ketones include compounds such as benzophenone, Michler's ketone [4,4′-bis(dimethylamino)benzophenone], 4,4′-bis(diethylamino)benzophenone, and 4-methoxy-4′-dimethylaminobenzophenone.

Examples of the acetophenones include compounds such as 2-hydroxy-2-methyl-1-phenylpropan-1-one, 1-(4-isopropylphenyl)-2-hydroxy-2-methylpropan-1-one, 1-(4-dodecylphenyl)-2-hydroxy-2-methylpropan-1-one, 4-(2-hydroxyethoxy)-phenyl(2-hydroxy-2-propyl)ketone, 1-hydroxycyclohexylphenyl ketone, 2-benzyl-2-dimethylamino-1-(4-morpholinophenyl)-butanone-1, and 2-methyl-1-[4-(methylthio)phenyl]-2-morpholino-propanone-1. Examples of a commercially available product thereof include Irgacure (registered trademark) 907, Irgacure (registered trademark) 369, and Irgacure (registered trademark) 379, which are manufactured by BASF.

Examples of the acylphosphine oxides include compounds such as 2,4,6-trimethylbenzyldiphenylphosphine oxide, bis(2,4,6-trimethylbenzoyl)-phosphine oxide, and bis(2,6-dimethoxybenzoyl)-2,4,4-trimethyl-pentylphosphine oxide. Examples of a commercially available product thereof include Lucirin TPO manufactured by BASF and Irgacure (registered trademark) 819 μmanufactured by BASF.

Examples of the benzoins and the benzoin ethers include compounds such as benzoin, benzoin ethyl ether, benzoin phenyl ether, methylbenzoin, and ethylbenzoin.

Examples of the dialkylketals include compounds such as benzyl dimethyl ketal and benzyl diethyl ketal.

Examples of the thioxanthones include compounds such as 2,4-diethylthioxanthone, 2,4-diisopropylthioxanthone, and 2-chlorthioxanthone.

Examples of the dialkylaminobenzoic acid esters include compounds such as ethyl dimethylaminobenzoate, ethyl diethylaminobenzoate, ethyl-p-dimethylaminobenzoate, and 2-ethylhexyl-4-(dimethylamino)benzoate.

Examples of the oxime esters include compounds such as 1-phenyl-1,2-propanedione-2-O-benzoyloxime and 1-phenyl-1,2-propanedione-2-(O-ethoxycarbonyl)oxime. Examples of a commercially available product thereof include CGI-325, Irgacure (registered trademark) OXE01, and Irgacure (registered trademark) OXE02, which are manufactured by BASF.

In addition, a photocationic polymerization initiator can be used as the photopolymerization initiator. For the photocationic polymerization initiator, for example, paragraphs 0019 to 0024 of JP4675719B can be referred to.

Examples of a preferred photocationic polymerization initiator include an iodonium salt compound, a sulfonium salt compound, a pyridinium salt compound, and a phosphonium salt compound. Among the above, from the viewpoint of heat stability, an iodonium salt compound or a sulfonium salt compound is preferable.

The iodonium salt compound is a salt formed by a cationic moiety containing I+ and an anionic moiety of any structure in its structure, and a diaryliodonium salt having three or more electron-donating groups, at least one of which is an alkoxy group, is more preferable.

By introducing the alkoxy group which is the electron-donating group into the diaryliodonium salt, decomposition due to water or nucleophilic agents over time and electron migration due to heat can be suppressed, which improves stability.

Examples of a commercially available photocationic polymerization initiator include CPI-110P, CPI-101A, CPI-110P, and CPI-200K, which are manufactured by San-Apro Ltd.; WPI-113, WPI-116, WPI-124, WPI-169, and WPI-170, which are manufactured by FUJIFILM Wako Pure Chemical Corporation; PI-2074 μmanufactured by DJK Corporation; and Irgacure (registered trademark) 250, Irgacure (registered trademark) 270, and Irgacure (registered trademark) 290, which are manufactured by BASF.

In a case where the composition for a color conversion film contains a polymerization initiator, a content of the polymerization initiator in the composition for a color conversion film is preferably 0.001 parts by mass to 10 parts by mass and more preferably 0.01 parts by mass to 5 parts by mass with respect to 100 parts by mass of solid contents contained in the composition for a color conversion film.

(Surfactant)

The composition for a color conversion film according to the embodiment of the present disclosure may contain a surfactant.

Examples of the surfactant include surfactants described in paragraph [0017] of JP4502784B and paragraphs [0060] to [0071] of JP2009-237362A.

As the surfactant, a fluorine-based surfactant, a nonionic surfactant, or a silicone-based surfactant is preferable.

Examples of a commercially available product of the fluorine-based surfactant include MEGAFACE (registered trademark) F-171, F-172, F-173, F-176, F-177, F-141, F-142, F-143, F-144, F-437, F-475, F-477, F-479, F-482, F-511, F-552, F-554, F-555-A, F-556, F-557, F-558, F-559, F-560, F-561, F-565, F-563, F-568, F-575, F-780, EXP, MFS-330, MFS-578, MFS-579, MFS-586, MFS-587, R-41, R-41-LM, R-01, R-40, R-40-LM, RS-43, TF-1956, RS-90, R-94, RS-72-K, and DS-21 (all of which are manufactured by DIC Corporation); FLUORAD FC430, FC431, and FC171 (all of which are manufactured by Sumitomo 3M Ltd.); SURFLON (registered trademark)S-382, SC-101, SC-103, SC-104, SC-105, SC-1068, SC-381, SC-383, S-393, and KH-40 (all of which are manufactured by Asahi Glass Co., Ltd.); and POLYFOX PF636, PF656, PF6320, PF6520, and PF7002 (all of which are manufactured by OMNOVA Solutions Inc.); FTERGENT (registered trademark) 710FL, 710FM, 610FM, 601AD, 601ADH2, 602A, 215M, 245F, 251, 212M, 250, 209F, 222F, 208G, 710LA, 710FS, 730LM, 650AC, 681, and 683 (all of which are manufactured by NEOS COMPANY LIMITED).

In addition, as the fluorine-based surfactant, a (meth)acrylic compound which has a molecular structure having a functional group containing a fluorine atom and in which the functional group containing a fluorine atom is broken to volatilize a fluorine atom by applying heat to the molecular structure can also be suitably used.

Examples of such a fluorine-based surfactant include MEGAFACE (registered trademark) DS series manufactured by DIC Corporation (The Chemical Daily (Feb. 22, 2016) and Nikkei Business Daily (Feb. 23, 2016)) (for example, MEGAFACE (registered trademark) DS-21).

In addition, as the fluorine-based surfactant, a polymer of a fluorine atom-containing vinyl ether compound having a fluorinated alkyl group or a fluorinated alkylene ether group, and a hydrophilic vinyl ether compound can also be preferably used.

In addition, a block polymer can also be used as the fluorine-based surfactant.

As the fluorine-based surfactant, a fluorine-containing polymer compound including a constitutional unit derived from a (meth)acrylate compound having a fluorine atom and a constitutional unit derived from a (meth)acrylate compound having 2 or more (preferably 5 or more) alkyleneoxy groups (preferably ethyleneoxy groups or propyleneoxy groups) can also be preferably used.

In addition, as the fluorine-based surfactant, a fluorine-containing polymer having an ethylenically unsaturated bond-containing group at a side chain can also be used.

Specific examples thereof include MEGAFACE (registered trademark) RS-101, RS-102, RS-718K, and RS-72-K (all of which are manufactured by DIC Corporation).

As the fluorine-based surfactant, from the viewpoint of improving environmental suitability, a surfactant derived from a substitute material for a compound having a linear perfluoroalkyl group having 7 or more carbon atoms, such as perfluorooctanoic acid (PFOA) and perfluorooctanesulfonic acid (PFOS), is preferable.

Examples of the nonionic surfactant include glycerol, trimethylolpropane, trimethylolethane, and ethoxylate and propoxylate thereof (for example, glycerol propoxylate, glycerol ethoxylate, and the like), polyoxyethylene lauryl ether, polyoxyethylene stearyl ether, polyoxyethylene oleyl ether, polyoxyethylene octyl phenyl ether, polyoxyethylene nonyl phenyl ether, polyethylene glycol dilaurate, polyethylene glycol distearate, and sorbitan fatty acid ester.

Examples of a commercially available product thereof include PLURONIC (registered trademark) L10, L31, L61, L62, 10R5, 17R2, and 25R2 (all of which are manufactured by BASF); TETRONIC (registered trademark) 304, 701, 704, 901, 904, and 150R1 (all of which are manufactured by BASF); Solsperse 20000 (manufactured by Nippon Lubrizol Corporation); NCW-101, NCW-1001, and NCW-1002 (all of which are manufactured by FUJIFILM Wako Pure Chemical Corporation); Pionin D-6112, D-6112-W, and D-6315 (all of which are manufactured by TAKEMOTO OIL & FAT Co., Ltd.); and OLFINE (registered trademark) E1010, SURFYNOL (registered trademark) 104, 400, and 440 (all of which are manufactured by Nissin Chemical Co., Ltd.).

Examples of the silicone-based surfactant include a linear polymer having a siloxane bond and a modified siloxane polymer with an organic group introduced in the side chain or the terminal.

Specific examples of the silicone-based surfactant include DOWSIL (registered trademark) 8032 ADDITIVE, TORAY SILICONE DC3PA, TORAY SILICONE SH7PA, TORAY SILICONE DC11PA, TORAY SILICONE SH21PA, TORAY SILICONE SH28PA, TORAY SILICONE SH29PA, TORAY SILICONE SH30PA, and TORAY SILICONE SH8400 (all of which are manufactured by Dow Corning Toray Co., Ltd.), X-22-4952, X-22-4272, X-22-6266, KF-351A, K354L, KF-355A, KF-945, KF-640, KF-642, KF-643, X-22-6191, X-22-4515, KF-6004, KP-341, KF-6001, and KF-6002 (all of which are manufactured by Shin-Etsu Silicone Co., Ltd.), F-4440, TSF-4300, TSF-4445, TSF-4460, and TSF-4452 (all of which are manufactured by Momentive Performance Materials Co., Ltd.), and BYK307, BYK323, and BYK330 (all of which are manufactured by BYK Chemie).

The surfactant may be used alone or in combination of two or more kinds thereof.

In a case where the composition for a color conversion film contains a surfactant, a content of the surfactant is preferably 0.01 parts by mass to 3 parts by mass, more preferably 0.02 parts by mass to 1 part by mass, and still more preferably 0.05 parts by mass to 0.80 parts by mass with respect to 100 parts by mass of solid contents contained in the composition for a color conversion film.

(Binder Resin)

The composition for a color conversion film may contain one or two or more kinds of binder resins other than the thermocurable compound and the photocurable compound.

The binder resin is not particularly limited, and examples thereof include an epoxy resin, a silicone resin (including organopolysiloxane cured products (crosslinked products) such as silicone rubber and silicone gel), a polyester resin, a (meth)acrylic resin, a vinyl resin, a polyamide resin, a polyimide resin, a polycarbonate resin, a cellulose resin, a polyolefin resin, a urea resin, a melamine resin, a phenol resin, a polyvinyl alcohol resin, a polyvinyl butyral resin, and a fluororesin.

(Additive)

In addition, the composition for a color conversion film may contain an additive other than the organic light-emitting material, the polymerization initiator, and the binder resin described above. Examples of the additive include a viscosity adjuster, an antioxidant, a heat stabilizer, a plasticizer, a leveling agent, an antistatic agent, a crosslinking agent, a curing agent, a silane coupling agent, inorganic particles, and organic particles.

(Organic Solvent)

The composition for a color conversion film may contain one or two or more kinds of organic solvents.

The type of the organic solvent is not particularly limited, and a known organic solvent in the related art can be used.

An amount of the organic solvent contained in the composition for a color conversion film is not particularly limited, but from the viewpoint dispersibility of the organic light-emitting material and the like, ease of applying a coating liquid onto a support, and ease of drying, a content of the organic solvent is preferably 50 parts by mass to 500 parts by mass with respect to 100 parts by mass of the total amount of solid contents contained in the composition for a color conversion film.

(Color Conversion Film)

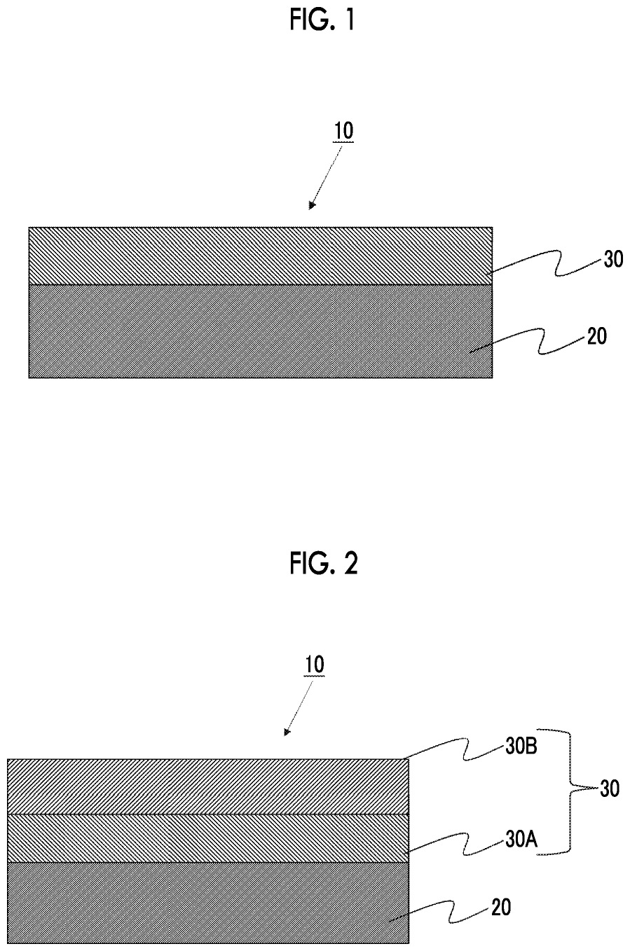

As shown in FIG. 1, a color conversion film 10 according to the embodiment of the present disclosure includes a support 20 and a color conversion layer 30. The color conversion layer 30 contains the organic light-emitting material which emits, by excitation light, light having a longer wavelength than the excitation light and at least one of a thermocured compound or a photocured compound.

The above-described color conversion layer 30 may have a multilayer structure, and for example, as shown in FIG. 2, a first color conversion layer 30A and a second color conversion layer 30B are provided in this order from the support side.

(Support)

The support is not particularly limited, and a known support in the related art can be used. Examples of the support include a resin film, glass, ceramic, paper, a metal plate, and a foil.

Examples of a resin material contained in the above-described resin film include polyester such as polyethylene terephthalate (PET), a cellulose resin such as cellulose acetate, a polyolefin resin such as polyethylene and polypropylene, a polyamide resin, a polyimide resin, a polystyrene resin, a polycarbonate resin, a vinyl resin, a silicone resin, a fluororesin, a thermocurable resin, and a photocurable resin.

The above-described resin film may be surface-treated, and for example, a resin film subjected to chemical matting treatment may be used as the support. By using the resin film which is subjected to the chemical matting treatment, it is possible to impart a function of light diffusion layer to the support.

From the viewpoint that it has flexibility, does not undergo significant deformation, shrinkage, or elongation under pressure or under pressure and heat, has excellent transparency, and has excellent smoothness, the above-described resin film is preferably a polyester film and particularly preferably a polyethylene terephthalate film.

The polyester film is preferably a biaxially stretching film.

In addition, a thickness of the polyester film is preferably 20 μm to 250 μm.

Examples of a commercially available product of the polyester film include LUMIRROR (registered trademark) #38-U48, LUMIRROR (registered trademark) #50-U48, LUMIRROR (registered trademark) #75-U48, LUMIRROR (registered trademark) #50-U40, and LUMIRROR (registered trademark) #75-U40 (all of which are manufactured by Toray Industries, Inc.); and COSMOSHINE (registered trademark) A4100 (film thickness: 50 μm, 75 μm, 100 μm, 125 μm, and 188 μm), COSMOSHINE (registered trademark) A4300 (film thickness: 38 μm, 50 μm, 75 μm, 100 μm, 125 μm, 188 μm, and 250 μm), and COSMOSHINE (registered trademark) A8300 (film thickness: 100 μm) (all of which are manufactured by TOYOBO Co., Ltd.).

The support may be manufactured by a known method in the related art, or a commercially available support may be used. Examples of the above-described resin film subjected to the chemical matting treatment include Chemical Matte 125PW manufactured by KIMOTO. Examples of the chemical matting treatment include treating a surface of the film with a chemical agent to form an uneven structure.

A thickness of the support is not particularly limited, but from the viewpoint of strength of the color conversion film and retention of the color conversion layer, it is preferably 20 μm or more, and more preferably 30 μm or more.

In addition, from the viewpoint of downsizing of a backlight unit or the like, the thickness of the support is preferably 1000 μm or less.

(Color Conversion Layer)

The color conversion layer contains the organic light-emitting material which emits, by excitation light, light having a longer wavelength than the excitation light and at least one of the thermocured compound or the photocured compound.

The color conversion layer may contain two or more kinds of organic light-emitting materials.

As the organic light-emitting material contained in the color conversion layer, it is also possible to use an organic light-emitting material in which a peak wavelength of light emitted by the excitation light is 500 nm or more and less than 580 nm (hereinafter, also referred to as a specific organic light-emitting material A).

As the organic light-emitting material contained in the color conversion layer, it is also possible to use an organic light-emitting material in which a peak wavelength of light emitted by the excitation light is 580 nm or more and less than 780 nm (hereinafter, also referred to as a specific organic light-emitting material B).

The organic light-emitting material, the specific organic light-emitting material A, and the specific organic light-emitting material B have been described above, and thus the description thereof will be omitted here.

The color conversion layer may have a multilayer structure, and for example, the first color conversion layer and the second color conversion layer can be provided in this order from the support side.

As a preferred configuration of the color conversion film, the first color conversion layer and the second color conversion layer are provided in this order from the support side, and an organic light-emitting material contained in the first color conversion layer is the specific organic light-emitting material A and an organic light-emitting material contained in the second color conversion layer is the specific organic light-emitting material B.

As another preferred configuration of the color conversion film, the first color conversion layer and the second color conversion layer are provided in this order from the support side, and an organic light-emitting material contained in the first color conversion layer is the specific organic light-emitting material B and an organic light-emitting material contained in the second color conversion layer is the specific organic light-emitting material A.

From the viewpoint of wavelength conversion effect, a content of the organic light-emitting material is preferably 0.005 parts by mass to 1 part by mass, more preferably 0.007 parts by mass to 0.7 parts by mass, and still more preferably 0.01 parts by mass to 0.5 parts by mass with respect to 100 parts by mass of the total amount of solid contents contained in the color conversion layer.

In a case where the color conversion layer has a multilayer structure, the numerical range of the above-described content is applied for each layer.

The color conversion layer contains at least one of the thermocured compound or the photocured compound. The thermocured compound and the photocured compound are compounds obtained by the thermocurable compound and the photocurable compound described above, and description thereof will be omitted here.

From the viewpoint of solvent resistance and light resistance, the sum of contents of the thermocured compound and the photocured compound described above is preferably 30 parts by mass or more, more preferably 50 parts by mass or more, and still more preferably 70 parts by mass or more with respect to 100 parts by mass of the total amount of solid contents contained in the color conversion layer.

In addition, the sum of the contents of the thermocured compound and the photocured compound described above is preferably 95 parts by mass or less with respect to 100 parts by mass of the total amount of solid contents contained in the color conversion layer.

In a case where the color conversion layer has a multilayer structure, the numerical range of the above-described content is applied for each layer.

The color conversion layer may contain one or two or more kinds of polymerization initiators. Since the polymerization initiator has been described above, the description thereof will be omitted here.

A content of the polymerization initiator in the color conversion layer is preferably 0.001 parts by mass to 10 parts by mass, and more preferably 0.01 parts by mass to 5 parts by mass with respect to 100 parts by mass of solid contents contained in the color conversion layer.

In a case where the color conversion layer has a multilayer structure, the numerical range of the above-described content is applied for each layer.

The color conversion layer may contain the binder resin, the additive, and the like described above.

From the viewpoint of wavelength conversion effect, a thickness of the color conversion layer is preferably 1.0 μm or more, more preferably 5.0 μm or more, and still more preferably 10 m or more.

In addition, from the viewpoint of downsizing of a backlight unit or the like, the thickness of the first color conversion layer is preferably 50 μm or less.

In a case where the color conversion layer has a multilayer structure, the numerical range of the above-described thickness is applied for each layer.

(Protective Layer)

The color conversion film may be provided with a protective layer on a surface of the color conversion layer opposite to a surface on which the support is provided.

As the protective layer, the same material as the support described above can be used. Since the specific materials have been described above, the description thereof will be omitted here.

From the viewpoint of strength of the color conversion film, a thickness of the protective layer is preferably 20 μm or more, and more preferably 30 μm or more.

In addition, from the viewpoint of downsizing of a backlight unit or the like, the thickness of the protective layer is preferably 1000 μm or less.

(Formation of Other Layers)

In the color conversion film, other layers may be formed on the support, the color conversion layer, or the protective layer.

Examples of the other layers include an oxygen barrier layer, a water vapor barrier layer, an antireflection layer, an antistatic layer, and an antifouling later.

(Method for Manufacturing Color Conversion Film)

A method for manufacturing a color conversion film includes forming a color conversion layer on a support by curing a composition for a color conversion film, that contains an organic light-emitting material which emits, by excitation light, light having a longer wavelength than the excitation light, and at least one of a thermocurable compound or a photocurable compound.

As the composition for a color conversion film, the above-described composition can be used, and the details thereof will be omitted here.

(Formation of Color Conversion Layer)

The formation of the color conversion layer is performed by curing the composition for a color conversion film on the support.

The curing of the composition for a color conversion film can be performed, for example, by applying and drying the composition for a color conversion film on the support.

In addition, depending on composition of the composition for a color conversion film, the curing of the composition for a color conversion film can be performed by irradiating the composition for a color conversion film with an actinic ray such as ultraviolet rays and an electron beam after the drying.

By forming the color conversion layer by applying, drying, and irradiation with an actinic ray, it is possible to manufacture a color conversion film having excellent chemical resistance and light resistance.

An applying method of the composition for a color conversion film is not particularly limited, and the composition can be applied by a known method in the related art. Examples of the applying method include a curtain coating method, a dip coating method, a spin coating method, a printing coating method, a spray coating method, a slot coating method, a roll coating method, a slide coating method, a blade coating method, a gravure coating method, and a wire bar method.

A drying method is not particularly limited, and the drying can be performed by a known method in the related art, such as using warm air.

A drying temperature is preferably changed as appropriate depending on composition of a coating liquid for forming the first color conversion layer, but is preferably 50° C. to 200° C. and more preferably 70° C. to 150° C.

As a light source for the light irradiation, a known light source in the related art can be used, and for example, an air-cooled metal halide lamp can be used.

In a case where ultraviolet rays are used in the light irradiation, an output density is not particularly limited, but is preferably 30 W/cm to 100 W/cm. In addition, an irradiation amount is not particularly limited, but is preferably 300 mJ/cm² to 2000 mJ/cm².

In a preferred aspect of the method for manufacturing the color conversion film, the forming of the color conversion layer includes forming the first color conversion layer on the support by curing a composition for a color conversion film, that contains the specific organic light-emitting material A and at least one of the thermocurable compound or the photocurable compound, and forming the second color conversion layer on the first color conversion layer by curing a composition for a color conversion film, that contains the specific organic light-emitting material B and at least one of the thermocurable compound or the photocurable compound.

In another preferred aspect of the method for manufacturing the color conversion film, the forming of the color conversion layer includes forming the first color conversion layer on the support by curing a composition for a color conversion film, that contains the specific organic light-emitting material B and at least one of the thermocurable compound or the photocurable compound, and forming the second color conversion layer on the first color conversion layer by curing a composition for a color conversion film, that contains the specific organic light-emitting material A and at least one of the thermocurable compound or the photocurable compound.

In a case where the color conversion layer includes the first color conversion layer and the second color conversion layer as described above, the forming of the color conversion layer can be performed by forming the first color conversion layer on the support by applying and drying (irradiating with light as necessary) a composition for a color conversion film; and then forming the second color conversion layer on the first color conversion layer by applying and drying (irradiating with light as necessary) another composition for a color conversion film.

(Formation of Protective Layer)

The method for manufacturing a color conversion film may include forming a protective layer on the color conversion layer.

The protective layer can be formed by heating and pressure-bonding the resin film or the like described above onto the color conversion layer.

In another aspect, the protective layer can be formed by applying and drying a coating liquid containing the resin material on the color conversion layer.

(Formation of Other Layers)

In the method for manufacturing a color conversion film of the first aspect, other layers may be formed on a layer such as the color conversion layer. Since the specific examples of the other layers have been described above, the description thereof will be omitted here.

(Backlight Unit)

The backlight unit according to the embodiment of the present disclosure includes a light source and the above-described color conversion film.

In a case where the color conversion layer included in the color conversion film includes the first color conversion layer and the second color conversion layer in this order from the support side, and the first color conversion layer contains the specific organic light-emitting material A and the second color conversion layer contains the specific organic light-emitting material B (hereinafter, also referred to as a first configuration), the color conversion film may be disposed with a surface on which the support is provided, facing the light source side, or may be disposed with a surface opposite to the surface on which the support is provided (surface on which the second color conversion layer is provided), facing the light source side.

In a case where the color conversion layer included in the color conversion film includes the first color conversion layer and the second color conversion layer in this order from the support side, and the first color conversion layer contains the specific organic light-emitting material B and the second color conversion layer contains the specific organic light-emitting material A (hereinafter, also referred to as a second configuration), the color conversion film may be disposed with a surface opposite to a surface on which the support is provided (surface on which the second color conversion layer is provided), facing the light source side, or may be disposed with the surface on which the support is provided, facing the light source side.

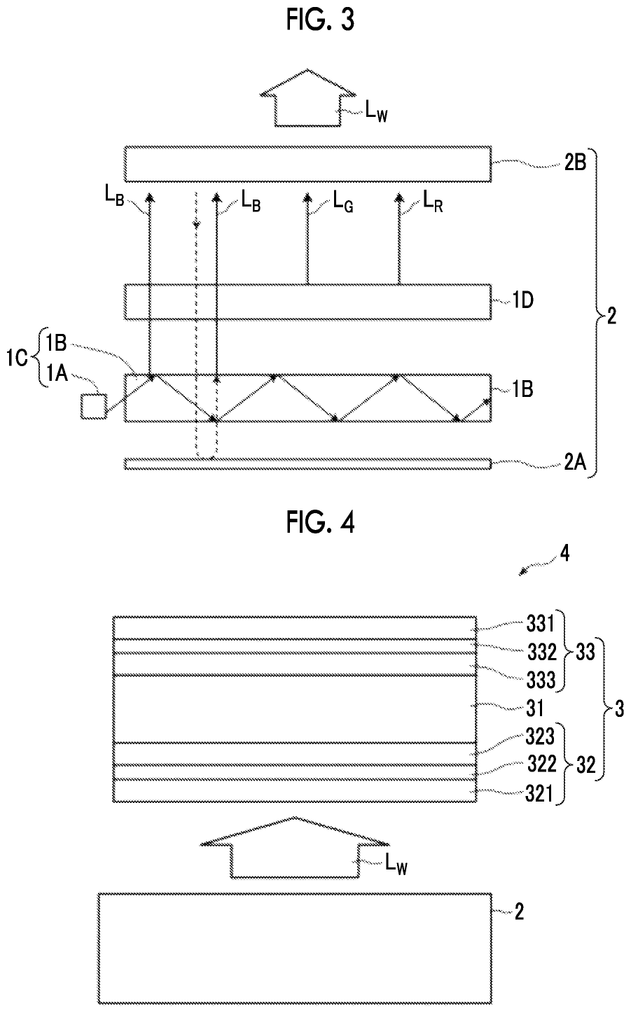

FIG. 3 is a schematic configuration cross-sectional diagram showing an embodiment of the backlight unit, and the backlight unit will be described below with reference to FIG. 3.

As shown in FIG. 3, a backlight unit 2 includes a planar light source 1C including a light source 1A which emits excitation light (blue light L_{B}) having a wavelength of 400 nm or more and less than 500 nm and a light guide plate 1B which guides and emits the excitation light emitted from the light source 1A, a color conversion film 1D provided on the planar light source 1C, a retroreflective member 2B disposed to face the planar light source 1C with the color conversion film 1D interposed therebetween, and a reflecting plate 2A disposed to face the color conversion film 1D with the planar light source 1C interposed therebetween.

In a case where the color conversion film has the first configuration, the organic light-emitting material contained in the first color conversion layer emits, by the excitation light emitted from the planar light source 1C, light (green light L_{G}) observed in a region having a peak wavelength of 500 nm or more and less than 580 nm.

In addition, the specific organic light-emitting material B contained in the second color conversion layer emits, by at least one of the excitation light which has passed through the first color conversion layer or the light emitted from the organic light-emitting material, light (red light L_{R}) observed in a region having a peak wavelength of 580 nm or more and 750 nm or less.

White light L_{W} is emitted from a surface of the retroreflective member 2B by the excitation light (blue light L_{B}) which has been passed through the color conversion film, the light (green light L_{G}) which has been passed through the second color conversion layer and is observed in the region having a peak wavelength of 500 nm or more and less than 580 nm, and the light (red light L_{R}) which is observed in the region having a peak wavelength of 580 nm or more and 750 nm or less.

In a case where the color conversion film has the second configuration, the organic light-emitting material contained in the second color conversion layer emits, by the excitation light emitted from the planar light source 1C, light (green light L_{G}) observed in a region having a peak wavelength of 500 nm or more and less than 580 nm.

In addition, the specific organic light-emitting material B contained in the first color conversion layer emits, by at least one of the excitation light which has passed through the second color conversion layer or the light emitted from the organic light-emitting material, light (red light L_{R}) observed in a region having a peak wavelength of 580 nm or more and 750 nm or less.

White light L_{W} is emitted from a surface of the retroreflective member 2B by the excitation light (blue light L_{B}) which has been passed through the color conversion film, the light (green light L_{G}) which has been passed through the first color conversion layer and is observed in the region having a peak wavelength of 500 nm or more and less than 580 nm, and the light (red light L_{R}) which is observed in the region having a peak wavelength of 580 nm or more and 750 nm or less.

In FIG. 3, the blue light L_{B}, the green light L_{G}, and the red light L_{R} emitted from the color conversion film 1D are incident on the retroreflective member 2B, and each incident light is repeatedly reflected between the retroreflective member 2B and the reflecting plate 2A and passes through the color conversion film 1D multiple times.

As a result, in the color conversion film 1D, a sufficient amount of the excitation light (blue light L_{B}) is absorbed by the specific organic light-emitting material B which emits the red light L_{R} and the organic light-emitting material which emits the green light L_{G}, a required amount of fluorescence (the green light L_{G} and the red light L_{R}) is emitted, and the white light L_{W} is emitted from the retroreflective member 2B as the sum of the blue light L_{B}, the green light L_{G}, and the red light L_{R}.

From the viewpoint of improving brightness and color reproducibility, half-widths of each light emission intensity of the blue light, the green light, and the red light emitted by the backlight unit are all preferably 80 nm or less, more preferably 50 nm or less, still more preferably 40 nm or less, and even more preferably 30 nm or less. In addition, it is particularly preferable that the half-width of the light emission intensity of the blue light is 25 nm or less.

As the light source 1A, a light-emitting diode, a laser light source, or the like can be used.

As shown in FIG. 3, the planar light source 1C may be a light source (edge light mode light source) including the light source 1A and the light guide plate 1B which guides and emits primary light emitted from the light source 1A, or may be a light source (direct backlight mode light source) in which the light source 1A is disposed in a plane parallel to the color conversion film 1D and a diffusion plate is provided in place of the light guide plate 1B. As the configuration of the backlight unit, although the edge light mode light source including the light guide plate, the reflecting plate, and the like as constituent members has been described in FIG. 3, the backlight unit may be the direct backlight mode light source.

As the light guide plate, a known light guide plate can be used without any limitation. In the present embodiment, the case where the planar light source is used as the light source has been described as an example, but a light source other than the planar light source can also be used as the light source.

In addition, the reflecting plate is not particularly limited, and a known reflecting plate can be used. For example, reflecting plates described in each publication such as JP3416302B, JP3363565B, JP4091978B, and JP3448626B can be used. The contents of these publications are incorporated herein by reference.

The retroreflective member may be configured of a known diffusion plate, diffusion sheet, prism sheet (for example, BEF series manufactured by Sumitomo 3M), a reflective type polarizing film (for example, DBEF series manufactured by Sumitomo 3M), or the like.

The configuration of the retroreflective member is described in each publication such as JP3416302B, JP3363565B, JP4091978B, and JP3448626B, the contents of which are incorporated herein by reference.

(Liquid Crystal Display Device)

The liquid crystal display device according to the embodiment of the present disclosure includes the above-described backlight unit and a liquid crystal cell unit.

FIG. 4 shows a schematic configuration cross-sectional diagram showing an embodiment of the liquid crystal display device according to the present disclosure. As shown in FIG. 4, a liquid crystal display device 4 includes the backlight unit 2 shown in FIG. 3 and a liquid crystal cell unit 3 disposed to face the retroreflective member 2B side of the backlight unit 2.

The liquid crystal cell unit 3 has a configuration in which a liquid crystal cell 31 is sandwiched between a polarizing plate 32 and a polarizing plate 33. In addition, each of the polarizing plate 32 and the polarizing plate 33 has a configuration in which both main surfaces of a polarizer 322 and a polarizer 332 are protected by polarizing plate protective films 321, 323, 331, and 333.

The liquid crystal cell and the polarizing plate constituting the liquid crystal display device are not particularly limited, and those manufactured by a known method or commercially available products can be used. In addition, a known interlayer such as an adhesive layer may be provided between the layers.

A drive mode of the liquid crystal cell is not particularly limited, and various modes such as twisted nematic (TN), super twisted nematic (STN), vertical alignment (VA), in-plane switching (IPS), and optically compensated bend cell (OCB) can be used.

Examples of a configuration of the liquid crystal display device in the VA mode include a configuration shown in FIG. 2 of JP2008-262161A. However, the specific configuration of the liquid crystal display device is not particularly limited, and a known configuration can be adopted.

The liquid crystal display device may include a functional layer such as an optical compensation member which performs optical compensation and an adhesive layer.

In addition, the liquid crystal display device 4 may include a color filter substrate, a thin-layer transistor substrate, a lens film, a diffusion sheet, a hard coat layer, an antireflection layer, a low reflection layer, an antiglare layer, or the like.

Further, the liquid crystal display device may include a forward scattering layer, a primer layer, an antistatic layer, an undercoat layer, or the like.

The polarizing plate on the backlight unit side may include a phase difference film as the polarizing plate protective film on the liquid crystal cell side. As such a phase difference film, a known phase difference film such as a cellulose acylate film can be used.

### EXAMPLES

Hereinafter, the present disclosure will be described in more detail using Examples. However, the present disclosure is not limited to the following examples as long as it does not exceed the gist of the present invention.

(Preparation of Compositions A-1 and B-1 for Color Conversion Film) The following components were mixed to prepare a composition A-1 for a color conversion film.

The composition A-1 for a color conversion film was dissolved in toluene so that the concentration was 50% by weight to obtain a solution A-1. Using a spectrofluoro-photometer (manufactured by Hitachi, Ltd., F-2500 spectrofluoro-photometer), an emission spectrum exhibited by irradiating the solution with excitation light having a wavelength of 460 nm was obtained, and it was confirmed that a peak wavelength was 500 nm or more and less than 580 nm.

(Composition A-1 for color conversion film)

| | | |
|---|---|---|
| Organic light-emitting material a | 0.25 | parts by mass |
| Photocurable compound a | 18.6 | parts by mass |
| (tricyclodecanediacrylate, | | |
| manufactured by Shin-Nakamura | | |
| Chemical Co., Ltd., A-DCP) | | |
| Curable compound b (urethane | 12.7 | parts by mass |
| acrylate, manufactured by | | |
| Taisei Fine Chemical Co., | | |
| Ltd., 8UX-015A) | | |
| Compound A (acid value: 95 | 55 | parts by mass |
| mgKOH/g) | | |
| Photopolymerization initiator | 0.64 | parts by mass |
| a (manufactured by BASF, Irgacure | | |
| (registered trademark) OXE02) | | |
| Isocyanate a (manufactured by | 13 | parts by mass |
| Asahi Kasei Corporation, | | |
| DURANATE (registered trademark) | | |
| X3071.04) | | |
| Surfactant (manufactured by DIC | 0.06 | parts by mass |
| Corporation, MEGAFACE | | |
| (registered trademark) F511) | | |
| 1-methoxy-2-propyl acetate | 100 | parts by mass |
| (MMPGAC) | | |
| Methyl ethyl ketone (MEK) | 93 | parts by mass |

The organic light-emitting material a is represented by the following chemical formula.

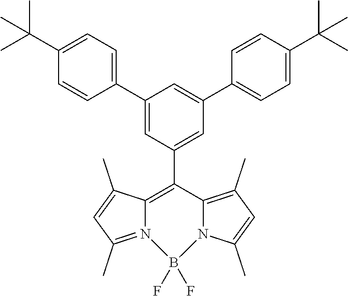

The compound A is represented by the following chemical formula. The unit of the numerical value in the lower right of the parentheses of each constitutional unit is mol %. Weight-average molecular weight (Mw) is 27,000.

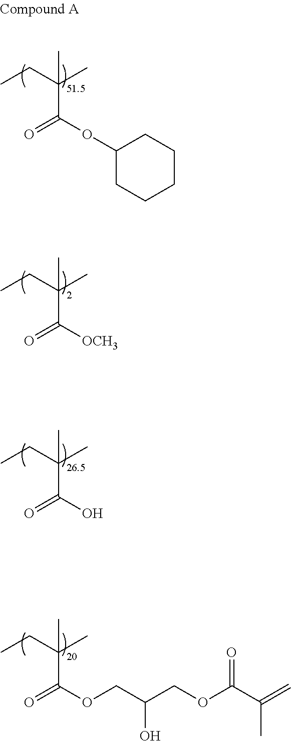

(Composition B-1 for Color Conversion Film)

A composition B-1 for a color conversion film was prepared in the same manner as described above, except that the organic light-emitting material a was changed to an organic light-emitting material b represented by the following chemical formula. It was confirmed that a peak wavelength measured in the same manner as described above was 580 nm or more and 750 nm or less.

Organic Light-Emitting Material b: Compound Represented by the Following Chemical Formula

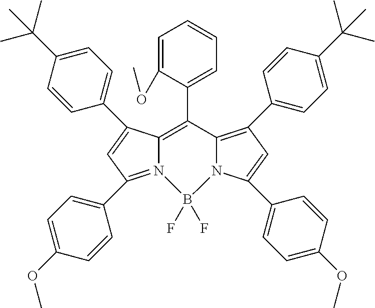

(Preparation of Compositions A-2 and B-2 for Color Conversion Film)

The following components were mixed to prepare a composition A-2 for a color conversion film. A peak wavelength measured in the same manner as described above was 500 nm or more and less than 580 nm.

(Composition A-2 for color conversion film)

| | | |
|---|---|---|
| Organic light-emitting material a | 0.25 | parts by mass |
| Curable compound c (alicyclic | 98.5 | parts by mass |
| epoxy compound, DAICEL-ALLNEX LTD., | | |
| CELLOXIDE (registered trademark) | | |
| 2021P) | | |
| Photopolymerization initiator b | 1.5 | parts by mass |
| (manufactured by BASF, Irgacure | | |
| (registered trademark) 819) | | |

(Composition B-2 for color conversion film)

A composition B-2 for a color conversion film was prepared in the same manner as described above, except that the organic light-emitting material a was changed to the organic light-emitting material b. A peak wavelength measured in the same manner as described above was 630 nm.

(Preparation of compositions A-3 and B-3 for color conversion film)

The following components were mixed to prepare a two-solution curing type composition A-3 for a color conversion film. A peak wavelength measured in the same manner as described above was 500 nm or more and less than 580 nm.

(Composition A-3 for color conversion film)

| | | |
|---|---|---|
| (A solution) | | |
| Organic light-emitting material a | 0.25 | parts by mass |
| Isocyanate b (1,6-hexamethylene diisocyanate, | 25 | parts by mass |
| manufactured by Mitsui Chemicals Inc., | | |
| TAKENATE (registered trademark) 700, | | |
| thermocurable compound) | | |
| (B solution) | | |
| Polyol a (polypropylene oxide triol, manufactured | 40.5 | parts by mass |
| by Mitsui Chemicals Inc., MN-300, | | |
| thermocurable compound) | | |
| Polyol b (polyethylene glycol, manufactured by | 40.5 | parts by mass |
| Lion Specialty Chemicals Co., Ltd., PEG#200, | | |
| thermocurable compound) | | |
| Reaction promoter (manufactured by San-Apro | 0.5 | parts by mass |
| Ltd., U-CAT102) | | |

(Composition B-3 for color conversion film)

A two-solution curing type composition B-3 for a color conversion film was prepared in the same manner as described above, except that the organic light-emitting material a was changed to the organic light-emitting material b. It was confirmed that a peak wavelength measured in the same manner as described above was 580 nm or more and 750 nm or less.

(Preparation of composition B-4 for color conversion film)

The following components were mixed to prepare a composition B-4 for a color conversion film. It was confirmed that a peak wavelength measured in the same manner as described above was 580 nm or more and 750 nm or less.

(Composition B-4 for color conversion film)

| | | |
|---|---|---|
| Organic light-emitting material b | 0.25 | parts by mass |
| Curable compound b | 48.95 | parts by mass |
| Photopolymerization initiator c | 0.64 | parts by mass |
| (manufactured by BASF, Irgacure | | |
| (registered trademark) OXE01) | | |
| Dipropylene glycol diacrylate | 50 | parts by mass |
| (manufactured by Sartomer Japan | | |
| Inc., SR-508) | | |
| Phenothiazine | 0.05 | parts by mass |

(Preparation of Compositions a-1 and b-1 for Color Conversion Film)

The following components were mixed to prepare a composition a-1 for a color conversion film. A peak wavelength measured in the same manner as described above was 500 nm or more and less than 580 nm.

(Composition a-1 for color conversion film)

| | | |
|---|---|---|
| Organic light-emitting material a | 0.25 | parts by mass |
| Methyl methacrylate resin (weight-average | 100 | parts by mass |
| molecular weight (Mw): 30,000) | | |
| MEK | 100 | parts by mass |

(Composition b-1 for Color Conversion Film)

A composition b-1 for a color conversion film was prepared in the same manner as described above, except that the organic light-emitting material a was changed to the organic light-emitting material b. A peak wavelength measured in the same manner as described above was 580 nm or more and 750 nm or less.

### (Example 1)

As a support, a polyethylene terephthalate (PET) film (thickness: 50 μm, manufactured by TOYOBO Co., Ltd., COSMOSHINE (registered trademark) A4300) was prepared.

The composition A-1 for a color conversion film was applied onto one surface of the PET film using a die coater, and dried at 100° C. for 5 μminutes. After the drying, the composition was cured by irradiating the composition with ultraviolet rays using an air-cooled metal halide lamp (manufactured by Eye Graphics Co., Ltd.) to form a first color conversion layer having a thickness of 20 μm after drying on the support.

In the ultraviolet irradiation, an output density was 60 W/cm, and an irradiation amount was 1000 mJ/cm².

The composition b-1 for a color conversion film was applied onto the first color conversion layer using a die coater, and dried at 100° C. for 20 μminutes to form a second color conversion layer having a thickness of 15 μm.

Next, a chemical mat-treated film having a thickness of 138 μm (manufactured by KIMOTO, Chemical Matte 125PW) as a protective layer was heated and pressure-bonded to the second color conversion layer to manufacture a color conversion film.

The color conversion film was disposed on a planar light-emitting device equipped with a blue LED element having an emission peak wavelength of 447 nm such that a support surface was in contact with the planar light-emitting device, and a prism sheet was placed on the color conversion film.

In a case where a current of 30 μmA was passed through the planar light-emitting device to turn on the blue LED element and light having an emission peak wavelength of 447 nm was radiated from the support side, white light including blue light, green light, and red light was observed.

Using a spectral emission brightness meter (CS-1000 μmanufactured by Konica Minolta Inc.), an emission spectrum of the above-described white light was obtained.

In a case where a peak wavelength of the green light was determined from the obtained emission spectrum, it was 530 nm. In addition, in a case where a peak wavelength of the red light was determined in the same manner, it was 630 nm.

The same measurement was performed for Examples below, and the results are summarized in Table 1. In Examples 2 to 7, the color conversion film was disposed on the planar light-emitting device such that a protective layer surface was in contact with the planar light-emitting device.

### (Example 2)

As a support, a polyethylene terephthalate (PET) film (thickness: 50 μm, manufactured by TOYOBO Co., Ltd., COSMOSHINE (registered trademark) A4300) was prepared.

The composition B-1 for a color conversion film was applied onto one surface of the PET film using a die coater, and dried at 100° C. for 5 μminutes. After the drying, the composition was cured by irradiating the composition with ultraviolet rays using an air-cooled metal halide lamp (manufactured by Eye Graphics Co., Ltd.) to form a first color conversion layer having a thickness of 15 μm after drying on the support.

In the ultraviolet irradiation, an output density was 60 W/cm, and an irradiation amount was 1000 mJ/cm².

The composition a-1 for a color conversion film was applied onto the first color conversion layer using a die coater, and dried at 100° C. for 20 μminutes to form a second color conversion layer having a thickness of 15 μm.

Next, a chemical mat-treated film having a thickness of 138 μm (manufactured by KIMOTO, Chemical Matte 125PW) as a protective layer was heated and pressure-bonded to the second color conversion layer to manufacture a color conversion film.

### (Example 3)

As a support, a PET film (thickness: 50 μm, manufactured by TOYOBO Co., Ltd., COSMOSHINE (registered trademark) A4300) was prepared.

The composition A-2 for a color conversion film was applied onto one surface of the PET film using a die coater, and dried at 100° C. for 20 μminutes. After the drying, the composition was cured by irradiating the composition with ultraviolet rays using an air-cooled metal halide lamp (manufactured by Eye Graphics Co., Ltd.) to form a first color conversion layer having a thickness of 15 μm after drying on the support.

In the ultraviolet irradiation, an output density was 60 W/cm, and an irradiation amount was 1000 mJ/cm².

The composition B-1 for a color conversion film was applied onto the first color conversion layer using a die coater, and dried at 100° C. for 5 μminutes. After the drying, the composition was cured by irradiating the composition with ultraviolet rays using an air-cooled metal halide lamp (manufactured by Eye Graphics Co., Ltd.) to form a second color conversion layer having a thickness of 13 μm after drying on the support.

In the ultraviolet irradiation, an output density was 60 W/cm, and an irradiation amount was 1000 mJ/cm².

Next, a chemical mat-treated film having a thickness of 138 μm (manufactured by KIMOTO, Chemical Matte 125PW) as a protective layer was heated and pressure-bonded to the second color conversion layer to manufacture a color conversion film.

### (Example 4)

As a support, a PET film (thickness: 50 μm, manufactured by TOYOBO Co., Ltd., COSMOSHINE (registered trademark) A4300) was prepared.

The composition A-2 for a color conversion film was applied onto one surface of the PET film using a die coater, and dried at 100° C. for 20 μminutes. After the drying, the composition was cured by irradiating the composition with ultraviolet rays using an air-cooled metal halide lamp (manufactured by Eye Graphics Co., Ltd.) to form a first color conversion layer having a thickness of 13 μm after drying on the support.

In the ultraviolet irradiation, an output density was 60 W/cm, and an irradiation amount was 1000 mJ/cm².

The composition B-3 for a color conversion film was applied onto the first color conversion layer using a die coater, and dried at 80° C. for 5 μminutes to form a second color conversion layer having a thickness of 30 μm.

More specifically, a tank storing the A solution constituting the composition B-3 for a color conversion film and a tank storing the B solution were connected to a closed type automatic constant liquid feeding device (manufactured by Naka Liquid Control Co., Ltd., Posiratio), and the A solution and the B solution were supplied to a die coater while being mixed with an in-line mixer so that the mass ratio of the A solution and the B solution was 35:65 for the applying.

Next, a chemical mat-treated film having a thickness of 138 μm (manufactured by KIMOTO, Chemical Matte 125PW) as a protective layer was heated and pressure-bonded to the second color conversion layer to manufacture a color conversion film.

### (Example 5)

As a support, a PET film (thickness: 50 μm, manufactured by TOYOBO Co., Ltd., COSMOSHINE (registered trademark) A4300) was prepared.

The composition A-2 for a color conversion film was applied onto one surface of the PET film using a die coater, and dried at 100° C. for 20 μminutes. After the drying, the composition was cured by irradiating the composition with ultraviolet rays using an air-cooled metal halide lamp (manufactured by Eye Graphics Co., Ltd.) to form a first color conversion layer having a thickness of 15 μm after drying on the support.

In the ultraviolet irradiation, an output density was 60 W/cm, and an irradiation amount was 1000 mJ/cm².

The composition B-2 for a color conversion film was applied onto the first color conversion layer using a die coater, and dried at 100° C. for 20 μminutes. After the drying, the composition was cured by irradiating the composition with ultraviolet rays using an air-cooled metal halide lamp (manufactured by Eye Graphics Co., Ltd.) to form a second color conversion layer having a thickness of 15 μm after drying on the support.

In the ultraviolet irradiation, an output density was 60 W/cm, and an irradiation amount was 1000 mJ/cm².

Next, a chemical mat-treated film having a thickness of 138 μm (manufactured by KIMOTO, Chemical Matte 125PW) as a protective layer was heated and pressure-bonded to the second color conversion layer to manufacture a color conversion film.

### (Example 6)

As a support, a PET film (thickness: 50 μm, manufactured by TOYOBO Co., Ltd., COSMOSHINE (registered trademark) A4300) was prepared.

The composition A-3 for a color conversion film was applied onto one surface of the PET film using a die coater, and dried at 80° C. for 5 μminutes to form a second color conversion layer having a thickness of 30 μm.

More specifically, a tank storing the A solution constituting the composition A-3 for a color conversion film and a tank storing the B solution were connected to a closed type automatic constant liquid feeding device (manufactured by Naka Liquid Control Co., Ltd., Posiratio), and the A solution and the B solution were supplied to a die coater while being mixed with an in-line mixer so that the mass ratio of the A solution and the B solution was 35:65 for the applying.

The composition B-1 for a color conversion film was applied onto the first color conversion layer using a die coater, and dried at 100° C. for 5 μminutes. After the drying, the composition was cured by irradiating the composition with ultraviolet rays using an air-cooled metal halide lamp (manufactured by Eye Graphics Co., Ltd.) to form a second color conversion layer having a thickness of 15 μm after drying on the support.

In the ultraviolet irradiation, an output density was 60 W/cm, and an irradiation amount was 1000 mJ/cm².

Next, a chemical mat-treated film having a thickness of 138 μm (manufactured by KIMOTO, Chemical Matte 125PW) as a protective layer was heated and pressure-bonded to the second color conversion layer to manufacture a color conversion film.

### (Example 7)

As a support, a PET film (thickness: 50 μm, manufactured by TOYOBO Co., Ltd., COSMOSHINE (registered trademark) A4300) was prepared.

The composition B-4 for a color conversion film was applied onto one surface of the PET film using a die coater, and dried at 80° C. for 5 μminutes. After the drying, the composition was cured by irradiating the composition with ultraviolet rays using an air-cooled metal halide lamp (manufactured by Eye Graphics Co., Ltd.) to form a first color conversion layer having a thickness of 15 μm after drying on the support.

In the ultraviolet irradiation, an output density was 60 W/cm, and an irradiation amount was 1000 mJ/cm².

The composition A-1 for a color conversion film was applied onto the first color conversion layer using a die coater, and dried at 100° C. for 5 μminutes. After the drying, the composition was cured by irradiating the composition with ultraviolet rays using an air-cooled metal halide lamp (manufactured by Eye Graphics Co., Ltd.) to form a second color conversion layer having a thickness of 20 μm after drying on the first color conversion layer.

In the ultraviolet irradiation, an output density was 60 W/cm, and an irradiation amount was 1000 mJ/cm².

Next, a chemical mat-treated film having a thickness of 138 μm (manufactured by KIMOTO, Chemical Matte 125PW) as a protective layer was heated and pressure-bonded to the second color conversion layer to manufacture a color conversion film.

### (Comparative Example 1)

As a support, a PET film (thickness: 50 μm, manufactured by TOYOBO Co., Ltd., COSMOSHINE (registered trademark) A4300) was prepared.

The composition a-1 for a color conversion film was applied onto one surface of the PET film using a die coater, and dried at 100° C. for 20 μminutes to form a first color conversion layer having a thickness of 15 μm.

The composition b-1 for a color conversion film was applied onto the first color conversion layer using a die coater, and dried at 100° C. for 20 μminutes to form a second color conversion layer having a thickness of 15 μm.

Next, a PET film (thickness: 50 μm, manufactured by TOYOBO Co., Ltd., COSMOSHINE (registered trademark) A4300) as a protective layer was heated and pressure-bonded to the second color conversion layer to manufacture a color conversion film.

<<Evaluation of Solvent Resistance>>

A commercially available tablet terminal (Kindle (registered trademark) FireHDX 7” manufactured by Amazon) was disassembled, and a backlight unit was taken out.

The color conversion films obtained in Examples and Comparative Examples described above were cut out in a rectangular shape (500 μmm×500 μmm), and were placed on a light guide plate of the backlight unit taken out.

The color conversion film was disposed such that the support side was in contact with the light guide plate.

Two prism sheets in which directions of surface unevenness patterns were orthogonal to each other were superposed on the color conversion film.

A blue light source included in the backlight unit was turned on, and brightness of light transmitted through the color conversion film and the two prism sheets was measured using a brightness meter (manufactured TOPCON TECHNOHOUSE CORPORATION, SR3) installed at a position of 740 μmm in the direction perpendicular to the surface of the light guide plate.

The brightness of the light was measured at a position 5 μmm inward from four corners of the color conversion film, and was regarded as an average value (Y0) of the measured values at the four corners.

The color conversion film was immersed in N-methylpyrrolidone for 60 seconds, and a brightness (Y1) of the light was measured in the same manner as described above.

Y0 and Y1 were substituted into the following expression, and evaluated based on the following evaluation standard. The evaluation results are shown in Table 23.

ΔY=[(Y0−Y1)/Y0]×100

(Evaluation Standard)
A: ΔY was less than 20.
B: ΔY was 20 or more and less than 30.
C: ΔY was 30 or more.

<<Evaluation of Light Resistance>>

The color conversion films obtained in Examples and Comparative Examples described above were cut out into squares of 3 cm square.

The cut-out color conversion film was placed on a commercially available blue light source (manufactured by OPTEX FA CO., LTD., OPSM-H 150X142B), the color conversion film was irradiated with blue light having a wavelength of 465 nm, and brightness of light passing through the color conversion film was measured with a brightness meter (manufactured by TOPCON TECHNOHOUSE CORPORATION, SR3).

In an environment of 25° C. and a relative humidity of 60%, the cut-out color conversion film was placed on the above-described blue light source, and the color conversion film was continuously irradiated with the blue light having a wavelength of 465 nm.

The color conversion film was disposed such that the support side was in contact with the blue light source.

The brightness of the light was measured every 10 hours in the same manner as described above, and a time for which the brightness decreased by 2% (hereinafter, referred to as a brightness decrease time) was obtained and evaluated based on the following evaluation standard. The evaluation results are shown in Table 24.

(Evaluation Standard)
A: brightness decrease time was 100 hours or more.
B: brightness decrease time was 30 hours or more and less than 100 hours.
C: brightness decrease time was less than 30 hours.

TABLE 23

| | Composition | | | | Composition | | | | | |
|---|---|---|---|---|---|---|---|---|---|---|
| | used in | Thickness of | | | used in | Thickness of | | | | |
| | formation of | first color | | With or | formation of | second color | | With or | | |
| | first color | conversion | | without | second color | conversion | | without | Evaluation | Evaluation |
| | conversion | layer | Heating | ultraviolet | conversion | layer | Heating | ultraviolet | of solvent | of light |
| | layer | (μm) | condition | irradiation | layer | (μm) | condition | irradiation | resistance | resistance |
| Example 1 | A-1 | 20 | 100° C. for | Y | b-1 | 15 | 100° C. for | N | B | A |
| | | | 5 minutes | | | | 20 minutes | | | |
| Example 2 | B-1 | 15 | 100° C. for | Y | a-1 | 15 | 100° C. for | N | B | A |
| | | | 5 minutes | | | | 20 minutes | | | |
| Example 3 | A-2 | 15 | 100° C. for | Y | B-1 | 13 | 100° C. for | Y | A | A |
| | | | 20 minutes | | | | 5 minutes | | | |
| Example 4 | A-2 | 13 | 100° C. for | Y | B-3 | 30 | 80° C. for | N | A | A |
| | | | 20 minutes | | | | 5 minutes | | | |
| Example 5 | A-2 | 15 | 100° C. for | Y | B-2 | 15 | 100° C. for | Y | A | A |
| | | | 20 minutes | | | | 20 minutes | | | |
| Example 6 | A-3 | 30 | 80° C. for | N | B-1 | 15 | 100° C. for | Y | A | A |
| | | | 5 minutes | | | | 5 minutes | | | |
| Example 7 | B-4 | 15 | 80° C. for | Y | A-1 | 20 | 100° C. for | Y | A | A |
| | | | 5 minutes | | | | 5 minutes | | | |
| Comparative | a-1 | 15 | 100° C. for | N | b-1 | 15 | 100° C. for | N | C | C |
| Example 1 | | | 20 minutes | | | | 20 minutes | | | |

From the results of Examples described above, it was found that, with the composition for a color conversion film according to the embodiment of the present disclosure, a color conversion film having excellent solvent resistance and light resistance can be manufactured.

The disclosure of JP2020-210833 filed on Dec. 18, 2020 is incorporated in the present specification by reference. All documents, patent applications, and technical standards described in the present specification are herein incorporated by reference to the same extent that each individual document, patent application, or technical standard was specifically and individually indicated to be incorporated by reference.

What is claimed is:

1. A color conversion film comprising:
a support; and
a color conversion layer containing an organic light-emitting material which emits, by an excitation light, light having a longer wavelength than the excitation light, and at least one of a thermocured compound or a photocured compound.

2. The color conversion film according to claim 1,
wherein the organic light-emitting material is represented by General Formula (1), 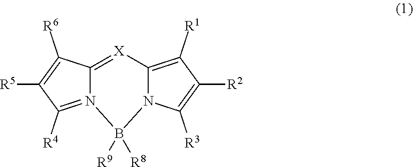
in General Formula (1), X represents C-R⁷ or N, and R¹ to R⁹ are each independently selected from a hydrogen atom, an alkyl group, a cycloalkyl group, a heterocyclic group, an alkenyl group, a cycloalkenyl group, an alkynyl group, a hydroxyl group, a thiol group, an alkoxy group, an alkylthio group, an arylether group, an arylthioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, or a phosphine oxide group, where adjacent groups of R¹ to R⁹ may form a fused ring.

3. The color conversion film according to claim 1,
wherein a peak wavelength of the light emitted from the organic light-emitting material by the excitation light is 500 nm or more and less than 580 nm.

4. The color conversion film according to claim 1,
wherein a peak wavelength of the light emitted from the organic light-emitting material by the excitation light is 580 nm or more and 750 nm or less.

5. The color conversion film according to claim 1,
wherein the color conversion layer includes a first color conversion layer and a second color conversion layer in this order from a side of the support,
a peak wavelength of light emitted from an organic light-emitting material contained in the first color conversion layer by an excitation light is 500 nm or more and less than 580 nm, and
a peak wavelength of light emitted from an organic light-emitting material contained in the second color conversion layer by an excitation light is 580 nm or more and 780 nm or less.

6. The color conversion film according to claim 5,
wherein the organic light-emitting material is represented by General Formula (1), 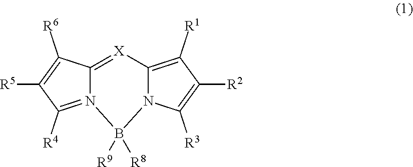
in General Formula (1), X represents C-R⁷ or N, and R¹ to R⁹ are each independently selected from a hydrogen atom, an alkyl group, a cycloalkyl group, a heterocyclic group, an alkenyl group, a cycloalkenyl group, an alkynyl group, a hydroxyl group, a thiol group, an alkoxy group, an alkylthio group, an arylether group, an arylthioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, or a phosphine oxide group, where adjacent groups of R¹ to R⁹ may form a fused ring.

7. The color conversion film according to claim 1,
wherein the color conversion layer includes a first color conversion layer and a second color conversion layer in this order from a side of the support,
a peak wavelength of light emitted from an organic light-emitting material contained in the first color conversion layer by an excitation light is 580 nm or more and 780 nm or less, and
a peak wavelength of light emitted from an organic light-emitting material contained in the second color conversion layer by an excitation light is 500 nm or more and less than 580 nm.

8. The color conversion film according to claim 7,
wherein the organic light-emitting material is represented by General Formula (1), 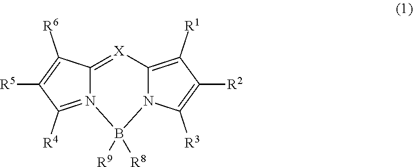
in General Formula (1), X represents C-R⁷ or N, and R¹ to R⁹ are each independently selected from a hydrogen atom, an alkyl group, a cycloalkyl group, a heterocyclic group, an alkenyl group, a cycloalkenyl group, an alkynyl group, a hydroxyl group, a thiol group, an alkoxy group, an alkylthio group, an arylether group, an arylthioether group, an aryl group, a heteroaryl group, halogen, a cyano group, an aldehyde group, a carbonyl group, a carboxyl group, an oxycarbonyl group, a carbamoyl group, an amino group, a nitro group, a silyl group, a siloxanyl group, a boryl group, or a phosphine oxide group, where adjacent groups of R¹ to R⁹ may form a fused ring.

9. A backlight unit comprising:
a light source; and
the color conversion film according to claim 1.

10. A liquid crystal display device comprising:
the backlight unit according to claim 9; and
a liquid crystal cell unit.
